(19) United States
(12) Patent Application Publication
(10) Pub. No.: US 2004/0122735 A1
(43) Pub. Date: Jun. 24, 2004

(54) System, method and apparatus for an integrated marketing vehicle platform

(75) Inventor: Alexander B. Meshkin, Columbia, MD (US)

Correspondence Address: ARENT FOX KINTNER PLOTKIN & KAHN, 1050 CONNECTICUT AVENUE, N.W., SUITE 400, WASHINGTON, DC, 20036, US

(73) Assignee: Bang Technologies, LLC

(21) Appl. No.: 10/681,331

(22) Filed: Oct. 9, 2003

Related U.S. Application Data
(60) Provisional application No. 60/416,905, filed on Oct. 9, 2002.

(51) Int. Cl. G06F 17/60

(52) U.S. Cl. 705/14; 705/10

(57) ABSTRACT

A system, method and computer program product for an integrated multiple vehicle platform (IMVP) permits advertisers, ad agencies, broadcasters, sponsors, and any other entities desiring to manage and modify consumer behavior. These brand entities are enabled to properly gather and use consumer information, using demographics, psychographics, previous purchasing habits, and based on the desires of brand entities. Consumer demands are gauged and cross promotion is performed on a variety of push and pull platforms, including marketing traditional fronts, technologies, networks, protocols, and interest groups. Real-time consumer responses and interests are elicited in a way that is measurable, dynamic, and interactive. Consumer participation and experience is enhanced, to effect long term product sales, through loyalty, redemption and incentive programs.

### RELATED APPLICATIONS

THIS APPLICATION CLAIMS PRIORITY FROM U.S. PROVISIONAL APPLICATION NO. 60/416,905, FILED OCT. 9, 2002, ENTITILED “SYSTEM, METHOD AND APPARATUS FOR GENERATING AND DISTRIBUTING MARKETING MESSAGES TO LISTENERS.”

### BACKGROUND OF THE INVENTION

Portions of the disclosure of this patent document may contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### FIELD OF THE INVENTION

The present invention relates generally to the field of marketing, and more particularly, to a system and method for targeted and interactive marketing across multiple platforms in online, wireline, and wireless environments.

### RELATED ART

For many years, companies have tried to brand their products, satisfy existing consumers, and reach potential new consumers through traditional means. The evolution has been linear when less creative, and sometimes non-linear, when more creative, as advertising has gone from print forms like newspapers, magazines, brochures, newsletters, press releases and billboards, to event-related activities, like sponsorships, seminars, point-of-sale and promotional programs, to broadcast media, like radio, television, cable and recently satellite cable.

The last decade has seen the rise of advertising that is more targeted and tailored to individual consumers, with new forms of previously so-called direct advertising. New endeavors have sought to interact directly with consumers through pull campaigns and push campaigns, and make advertising more measurable to bring advertisers specific consumer data mining bearing on consumer buying habits, trending and predicting future habits. Advances in technology outlets combined with marketing ingenuity have expanded the old direct mail marketing campaigns into new branches, including telemarketing, point-of-sale campaigns, computer platforms, and most recently distribution and measurement through telecommunications networks.

With respect to the latter, perhaps the greatest platform for the new world of marketing has been the same as the greatest platform for information exchange in the last decade, namely the Internet. Through such avenues as branded websites, banner ads, pop-up ads, targeted e-mails, portal sponsorships, to name a few examples, advertisers have been able to hone in on target audiences. Through defined metrics and innovative semantics, like served impressions, click-through rate (CTR), cost per action (CPA), cost per click (CPC), cost per sale (CPS), and cost per thousand (CPM), to name a few, advertisers have been able to measure the results of targeted ads and objectively set fees for performance results obtained. Along with these new advances, and because of the increasingly cosmopolitan nature of business, geopolitics, and integrated telecommunications networks, so too has advertising become increasingly global in nature.

Unfortunately, advertisers have been unable to properly gather and use consumer information, to provide for cross promotion across various platforms, to elicit accurate consumer data and engage consumers, or to make the consumer's experience interactive and dynamic, to benefit both advertiser and consumer in a meaningful and measurable manner.

### SUMMARY OF THE INVENTION

In a number of embodiments, the present invention discloses a system, method and computer program product for an integrated multiple vehicle platform (IMVP). The present invention includes system, method and computer program product implementations of IMVP that can be used in a node-node environment, a machine instructions environment, a computer hardware environment, a client-server environment, Internet and World Wide Web environment, and any other environments known to skilled persons.

In one or more embodiments, the present invention permits advertisers, ad agencies, broadcasters, sponsors, and any other entities desiring to manage and modify consumer behavior, called “brand entities” herein, to (i) properly gather and use consumer information, from demographics, to psychographics, to previous purchasing habits, and based on the desires of brand entities, and gage consumer demands, on everything from current buying habits to affiliations with hobbies and athletic activities; (ii) to cross promote their products and trademarks across various types of platforms, including technologies, networks, protocols, interest groups, to name a few; (iii) to elicit real-time consumer responses and interest in a way that is measurable, dynamic, and interactive; and (iv) to enhance consumer participation and experience, and effect long term product sales, through loyalty, redemption and incentive programs.

In one or more embodiments, the IMVP of the present invention provides a dynamically accessible and programmable marketing tool, capable of collecting and assessing user data from existing and potential consumers in real-time, across multiple platforms. Brand entities can use the tool to promote short term sales, promote long term behavior, establish rapport and brand recognition with their consumer base and promote consumer branding affiliations. In one or more embodiments, the platform enables brand entities to engage, retain and increase consumers through innovative cross platform promotions.

Exemplary environments, among the numerous environments in which the present invention can be used, include broadcasters desiring to supplement and promote branding for their own advertiser customers, and corporate sponsors of the National Association for Stock Car Auto Racing (NASCAR) desiring to integrate and cross-promote their traditional racing vehicle sponsorships with real-time wireless and online promotions.

In one or more embodiments, brand entities are enabled to access rapidly expanded consumer intelligence in different marketing endeavors. The platform permits brand entities to measure, modify and manage their marketing messages, and enables them to measure and estimate future consumer behavior.

The present invention enables brands to operate in real-time to achieve business objectives during the promotion lifecycle. It enables brand research, product launches, and loyalty and retention programs for consumers, to name a few programs.

In one or more embodiments, the present invention enables sponsors to interact with their consumers through interactive promotions, creating real-time consumer intelligence to increase marketing opportunities and maximize the brand entities' rate of investment. In one or more embodiments, it enables and enhances brand integration between traditional and online marketing campaigns.

In one or more embodiments, the present invention permits a virtually unlimited number of measurable advertising campaigns using multiple protocols over multiple media, over multiple consumer platforms.

The multiple platform processing technology of the present invention permits brand entities to prompt specific consumer behaviors and gather valuable consumer intelligence, leading to increased product sales and better understanding of consumer behavior.

The integration processing technology of the present invention permits brand entities to tie in their products to the needs and desires of consumers, (through sports or any desired activities of consumers) to leverage consumer information gathered over one platform to benefit knowledge assessment in other platforms, and modify consumer behavior through numerous consumer incentives.

In one or more embodiments, knowledge management is incorporated with brand entity expertise, and consumer behavior determination to generate targeted push and pull marketing programs. Exemplary targeted programs include assessment and targeting of existing and potential consumers through demographics, psychographics, previous consumer responses, and brand entity specific metrics.

Exemplary consumer participation and redemption programs enabled include promotions, loyalty, incentive programs, proprietary auctions, strategic games, barter programs, sophisticated drawings, and any other type of consumer interaction, as skilled persons will recognize. In one or more embodiments, the platform aligns a brand entity's business objectives with consumer motivations, to provide incentives for specific consumer behaviors without impinging upon the privacy of consumers, fans, and other targeted groups.

Further features and advantages of the invention, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements. The left most digits in the corresponding reference number indicate the drawing in which an element first appears.

FIG. 1 illustrates an exemplary computer and telecommunications network environment;

FIG. 2 illustrates an exemplary computer system environment;

FIG. 3 illustrates an exemplary client-server environment;

FIG. 4 illustrates a detailed exemplary client-server environment;

FIG. 5 illustrates en exemplary modular structure for application servers and database servers used in implementing the presenting invention;

FIG. 6 illustrates a second system level embodiment of the present invention;

FIG. 7 illustrates a third system level embodiment of the present invention;

FIG. 8 is a flow chart showing the functionality of an advertisement module;

FIG. 9 illustrates a screen shot of the basic brand entity user interface;

FIG. 10 illustrates a screen shot of an advanced search;

FIG. 11 illustrates a screen shot of information displayed from a database after performing a basic search;

FIG. 12 illustrates a screen shot of detailed advertiser information;

FIG. 13 illustrates a screen shot of an advertiser profile page;

FIG. 14 illustrates a screen shot to add an external user page;

FIG. 15 illustrates a screen shot of the function to edit an external user;

FIG. 16 illustrates a screen shot of an exemplary advertiser history pop-up;

FIG. 17 illustrates a flow chart showing the functionality of campaign manager module;

FIGS. 18 and 19 illustrate screen shots for selecting a target view and receiving a summary of all targets selected;

FIG. 20 illustrates a screen shot for expanding targets;

FIG. 21 illustrates a screen shot for a hierarchical view of a parent broadcaster, its children cities and station types;

FIGS. 22, 23, 24 and 25 illustrate screen shots for the expansion and selection of targets for broadcasters into cities;

FIGS. 26, 27 and 28 illustrate screen shots for the expansion and selection of targets for broadcasters into station format.

FIG. 30 illustrates a screen shot of demographic targets;

FIG. 31 illustrates a screen shot of demographic targets expanded;

FIG. 32 illustrates a screen shot of demographics on age, gender and income;

FIG. 33 illustrates a screen shot of demographic targets on location;

FIG. 34 illustrates a screen shot of demographic targets on location and region;

FIG. 35 illustrates a screen shot of demographic targets selection on location and region;

FIG. 36 illustrates a screen shot of demographic targets on location and state;

FIG. 37 illustrates a screen shot of demographic targets selection on location and state;

FIG. 38 illustrates a screen shot of psychographic targets;

FIG. 39 illustrates a screen shot of psychographic targets on favorite sports;

FIG. 40 illustrates a screen shot of psychographic targets selection on favorite sports;

FIG. 41 illustrates a screen shot of psychographic targets pricing summary;

FIG. 42 illustrates a screen shot of previous response targets;

FIG. 43 illustrates a screen shot of advanced searching on previous response targets;

FIG. 44 illustrates a screen shot of advanced searching criteria for previous response targets;

FIG. 45 illustrates a screen shot of search results for previous response targets;

FIG. 46 illustrates a screen shot of campaign selection on previous response targets;

FIG. 47 illustrates a screen shot of message selection on previous response targets;

FIG. 48 illustrates a screen shot of response selection on previous response targets;

FIG. 49 illustrates a screen shot of a summary of the different targeting types;

FIG. 50 illustrates a screen shot of how saved targets (target templates) can be searched, in accordance with query types;

FIG. 51 illustrates a screen shot of search results pertaining to a search for saved targets (target templates);

FIG. 52 illustrates a screen shot of selection of a saved target;

FIG. 53 illustrates a screen shot of how a target template is viewed.

FIG. 54 illustrates a screen shot of adding of keywords and naming a target template;

FIG. 55 illustrates a screen shot of a basic commerce campaign;

FIG. 56 illustrates a screen shot for an SMS commerce campaign;

FIG. 57 illustrates a screen shot showing commerce campaign fields in detail;

FIG. 58 illustrates a screen shot for how an item or merchandise is added in a commerce campaign;

FIG. 59 illustrates a screen shot of search results for adding an item or merchandise in a commerce campaign;

FIG. 60 illustrates a screen shot of item selection in a commerce campaign;

FIG. 61 illustrates a screen shot for item adding in a commerce campaign;

FIG. 62 illustrates an exemplary login screen shot; and

FIG. 63 illustrates a fourth second system level embodiment of the present invention;

### DETAILED DESCRIPTION OF AN EXEMPLARY EMBODIMENT OF THE PRESENT INVENTION

### Table of Contents

I. EXEMPLARY EMBODIMENT

II. NODE-NODE ENVIRONMENT

III. MACHINE INSTRUCTIONS ENVIRONMENT

IV. COMPUTER HARDWARE ENVIRONMENT

V. CLIENT-SERVER ENVIRONMENT

VI. INTERNET AND WORLD WIDE WEB ENVIRONMENT

A. Introduction

B. Displaying Information and Navigating on the Web

VII. INTEGRATED MARKETING VEHICLE PLATFORM

A. Exemplary Environments

B. Basic Embodiment

C. Push Campaigns Embodiment

D. Second Embodiment

E. Third Embodiment

D. Fourth Embodiment

VIII. CONCLUSION

I. Exemplary Embodiment

While specific exemplary examples, environments and embodiments are discussed below, it should be understood that this is done for illustration purposes only. A person skilled in the relevant art will recognize that other components and configurations can be used without parting from the spirit and scope of the invention. In fact, after reading the following description, it will become apparent to a person skilled in the relevant art how to implement the invention in alternative examples, environments and embodiments.

II. Node-Node Environment

In one or more embodiments, the invention is practiced in the environment of a computer network or networks. The network can include a private network, or a public network (for example the Internet, as described below), or a combination of both. The network includes hardware, software, or a combination of both.

As skilled persons will recognize, from a high-level, telecommunications-oriented view, the network can be described as a set of hardware nodes interconnected by a communications facility, with one or more processes (hardware, software, or a combination thereof) functioning at each such node. The processes can inter-communicate and exchange information with one another via communication pathways between them called interprocess communication pathways.

On these pathways, appropriate communications protocols are used. Skilled persons will recognize that the distinction between hardware and software is not always easily defined, with the same or similar functions capable of being preformed with use of either. This is especially true for functionality associated with the communications between processes.

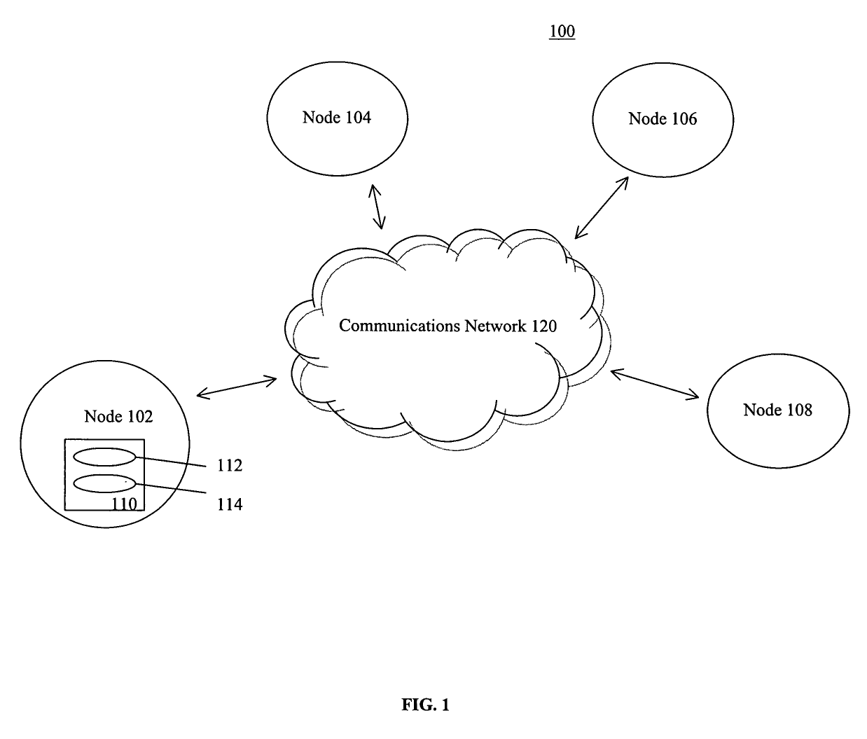

FIG. 1 illustrates an exemplary computer and telecommunications network environment 100. Environment 100 includes nodes 102-108, which include hardware, software, or a combination of hardware and software. Nodes 102-108 are interconnected via communications network 120. Each node 102-108 includes one or more processes 112, 114, executable by processors 110 incorporated into the nodes. It is possible that a single process 112 can be run by multiple processors 110, or that multiple processes 112, 114 can be run by a single processor 110. Additionally, each of nodes 102-108 can provide an interface point between network 100 and the outside world, and can incorporate a collection of subnetworks.

Persons of skill in the art will appreciate that the “software” processes 112, 114 include software and/or hardware entities that perform work over time, such as tasks, threads, and intelligent agents. Also, each process 112 can refer to multiple processes, for carrying out instructions in sequence or in parallel, continuously or intermittently.

In one embodiment, the processes 112, 114 communicate with one another through interprocess communication pathways (not labeled) supporting communication through any communications protocol. The pathways can function in sequence or in parallel, continuously or intermittently. The pathways can use any of the communications standards, protocols or technologies, described below with respect to communications network 120, in addition to standard parallel instruction sets used by many computers.

Nodes 102-108 include any entities capable of performing processing functions. Examples of nodes 102-108 that can be used with the present invention include computers (such as personal computers, workstations, servers, or mainframes), handheld wireless devices and wireline devices (such as personal digital assistants (PDAs), modern cell phones with processing capability, wireless e-mail devices including BlackBerry™ devices), document processing devices (such as scanners, printers, facsimile machines, or multifunction document machines), or complex entities (such as local-area networks or wide area networks) to which are connected a collection of processors, as described. For example, in the context of the present invention, a node itself can be a wide-area network (WAN), a local-area network (LAN), a private network (such as a Virtual Private Network (VPN)), or collection of networks.

Communications between nodes 102-108 is made possible by communications network 120. A node 102-108 can be connected either continuously or intermittently with communications network 120. As an example, in the context of the present invention, communications network 108 can be a digital communications infrastructure providing adequate bandwidth and information security.

Communications network 120 can include wireline communications capability, wireless communications capability, or a combination of both, at any frequencies, using any type of standard, protocol or technology. In addition, in the present invention, communications network 120 can be a private network (for example, a VPN) or a public network (for example, the Internet).

A non-inclusive list of exemplary wireless protocols and technologies used by communications network 120 includes BlueTooth™, general packet radio service (GPRS), cellular digital packet data (CDPD), mobile solutions platform (MSP), multimedia messaging (MMS), wireless application protocol (WAP), code division multiple access (CDMA), short message service (SMS), wireless markup language (WML), handheld device markup language (HDML), binary runtime environment for wireless (BREW), radio access network (RAN), and packet switched core networks (PS-CN).

Also included are various generation wireless technologies, as set forth in Table 1. It should be noted that the definitions provided therein and the other tables herein are provided for convenience of understanding the concepts of the present invention, and not by way of limiting the features and functions of the specification.

A exemplary non-inclusive list of primarily wireline protocols and technologies used by communications network 120 includes asynchronous transfer mode (ATM), enhanced interior gateway routing protocol (EIGRP), frame relay (FR), high-level data link control (HDLC), Internet control message protocol (ICMP), interior gateway routing protocol (IGRP), internetwork packet exchange (IPX), ISDN, point-to-point protocol (PPP), transmission control protocol/internet protocol (TCP/IP), routing information protocol (RIP) and user datagram protocol (UDP). As skilled persons will recognize, any other known or anticipated wireless or wireline protocols and technologies can be used.

TABLE 1

| GENERATION | DESCRIPTION |
|---|---|
| 1G | 1G refers to the first generation wide area wireless (WWAN) |
| | communications systems, dated in the 1970s and 1980s. These devices |
| | are analog, designed for voice transfer and circuit-switched, and include |
| | AMPS, NMT and TACS. |
| 2G | 2G refers to second generation WWAN communications, dated in the |
| | 1990s, characterized as digital, capable of voice and data transfer, and |
| | include HSCSD, GSM, CDMA IS-95-A and D-AMPS (TDMA/IS-136). |
| 2.5G | 2.5G refers to the generation of WWAN communications between 2G |
| | and 3G. |
| 3G | 3G refers to third generation WWAN communications systems recently |
| | coming into existence, characterized by data rates of 144 Kbps to over 2 |
| | Mbps (high speed), being packet-switched, and permitting multimedia |
| | content, including GPRS, 1xRTT, EDGE, HDR, W-CDMA. |
| 4G | 4G refers to fourth generation WWAN communications systems, |
| | expected to come in the years 2006-2010, characterized by very high- |
| | speed (over 20 Mbps) data rates, permitting high-resolution for video. |

As noted, each node 102-108 includes one or more processes 112, 114, executable by processors 110 incorporated into the nodes. In a number of embodiments, the set of processes 112, 114, separately or individually, can represent entities in the real world, defined by the purpose for which the invention is used.

Furthermore, the processes 112, 114 and processors 110 need not be located at the same physical locations. In other words, each processor 112, 114 can be executed at one or more geographically distant processor 110, over for example, a LAN or WAN connection.

Persons of skill in the art will appreciate a great range of possibilities for practicing the invention using different networking hardware and software configurations.

III. Machine Instructions Environment

In one or more embodiments, the steps of the present invention are embodied in machine-executable instructions. The instructions can be used to cause a processing device, for example a general-purpose or special-purpose processor, which is programmed with the instructions, to perform the steps of the present invention.

Alternatively, the steps of the present invention can be performed by specific hardware components that contain hardwired logic for performing the steps, or by any combination of programmed computer components and custom hardware components.

For example, the present invention can be provided as a computer program product. In this environment, the invention can include a machine-readable medium having instructions stored on it. The instructions can be used to program any processor (or other electronic devices) to perform a process according to the present invention.

The machine-readable medium can include, for example, floppy diskettes, optical disks, CD-ROMs, and magneto-optical disks, ROMs, RAMs, EPROMs, EEPROMs, magnet or optical cards, or other type of media/machine-readable medium suitable for storing electronic instructions, but is not limited to the foregoing.

In addition, the present invention can also be downloaded as a computer program product. Here, the program can be transferred from a remote computer (e.g., a server) to a requesting computer (e.g., a client) by way of data signals embodied in a carrier wave or other propagation medium via a communication link (e.g., a modem or network connection).

IV. Computer Hardware Environment

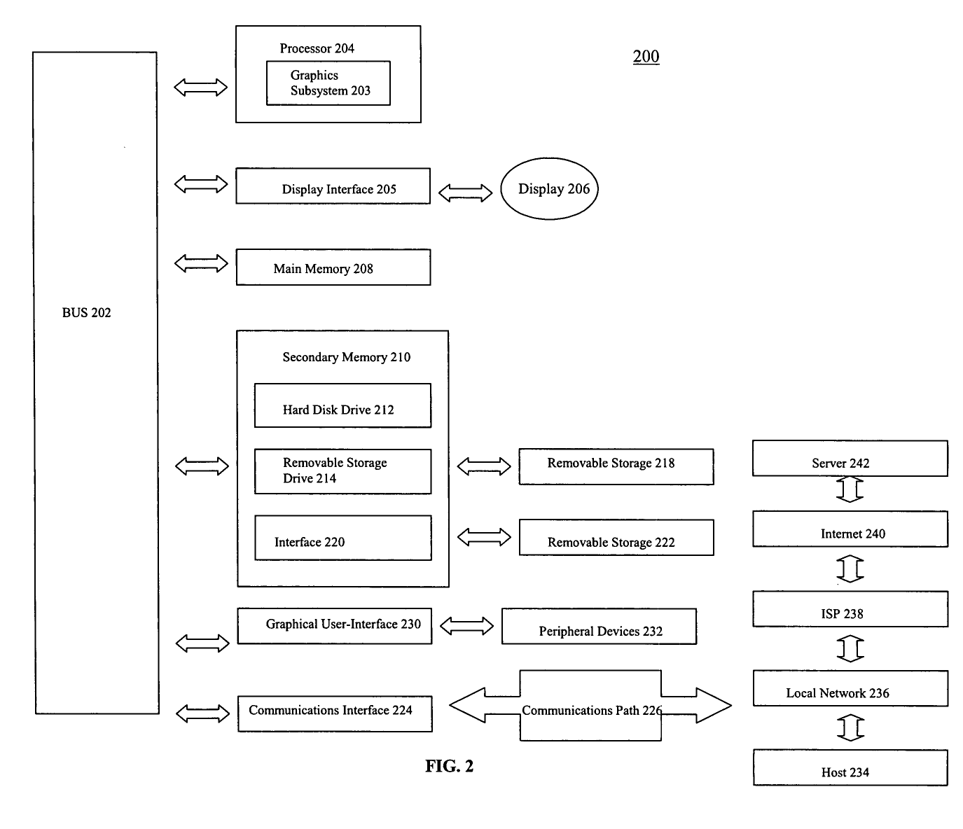

In one embodiment, illustrated in FIG. 2, node 102 is a computer system 200. Computer system 200 includes bus 202, processor 204 (including graphics subsystem 203), display interface 205, display 206, main memory 208, secondary memory 210 (including hard disk drive 212, removable storage drive 214, and interface 220), removable storage units 218, 222, graphical user-interface 230, peripheral devices 232 and communications interface 224. Computer system 200 is also connected via communications path 226 to external networks. Various embodiments are described in terms of this example computer system. After reading this description, it will be apparent to a person skilled in the relevant art how to implement the invention using other computer systems and/or computer architectures.

Processor 204, which can represent multiple processors, is connected to a communications bus 202. Graphics subsystem 203, shown as associated with processor 204, can be implemented as one or more processor chips. In fact, graphics subsystem 203 can be included as part of processor 204 as shown in FIG. 2 or as a separate graphics engine or processor. Graphics data is output from the graphics subsystem 203 to the bus 202.

Display interface 205 forwards graphics data from the bus 202 for display on the display unit 206. This graphics data includes graphics data for the screen displays described herein.

Main memory 208 can be a random access memory (RAM), and can also include a secondary memory 210. In the present invention the secondary memory 210 can include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well known manner. Removable storage unit 218 represents a floppy disk, magnetic tape, optical disk, etc., which is read by and written to by removable storage drive 214. As will be appreciated, the removable storage unit 218 includes a computer usable storage medium having stored therein computer software and/or data.

In alternative embodiments, secondary memory 210 can include other similar means for allowing computer programs or other instructions to be loaded into computer system 200. Such means can include, for example, a removable storage unit 222 and an interface 220. In the present invention examples can also include a program cartridge and cartridge interface (such as that found in video game devices), a removable memory chip (such as an EPROM, or PROM) and associated socket, and other removable storage units 222 and interfaces 220 which allow software and data to be transferred from the removable storage unit 222 to computer system 200.

Graphical user interface module 230 transfers user inputs from peripheral devices 232 to bus 206. These peripheral devices 232 can be a mouse, keyboard, touch screen, microphone, joystick, stylus, light pen, or any other type of peripheral unit.

Computer system 200 can also include a communications interface 224. Communications interface 224 allows software and data to be transferred between computer system 200 and external devices via communications path 226. Examples of communications interface 224 that can be used with the present invention include a standard or cable modem, a DSL connection, a network interface (such as an Ethernet card), a communications port, a LAN connection, a WAN connection, etc. Computer programs and data transferred via communications interface 224 are in the form of signals which can be electronic, electromagnetic, optical or other signals capable of being received by communications interface 224, via communications path 226. Note that communications interface 224 provides a means by which computer system 200 can interface to a network such as the Internet.

The present invention can be implemented using computer programs (i.e., “software,” or “computer control logic”) running on Processor 204. The software can be originally stored as a “computer program product” on removable storage device 218 or hard disk drive 212. Therefore, computer program product refers to means for providing software to computer system 200.

Computer programs can also be stored in main memory 208 and/or secondary memory 210. Computer programs can also be received via communications interface 224. Such computer programs, when executed, enable the computer system 200 to perform the features of the present invention as discussed herein. In particular, the computer programs, when executed, enable the processor 204 to perform the features of the present invention.

In another embodiment, the invention is implemented primarily in firmware and/or hardware using, for example, hardware components such as application specific integrated circuits (ASICs). Implementation of a hardware state machine so as to perform the functions described herein will be apparent to persons skilled in the relevant arts.

In the example environment shown, communication interface 224 provides a two-way data communication coupling via a communications path 226 to a local network 236. For example, if communication interface 224 is an integrated services digital network (ISDN) card or a modem, communication interface 224 provides a data communication connection to the corresponding type of telephone line, which comprises part of communications path 226. If communication interface 224 is a local area network (LAN) card, or connects to a LAN 236, then it can provide a data communication connection via communications path 226 to a compatible LAN. Wireless links are also possible. In any such implementation, communication interface 224 sends and receives electrical, electromagnetic or optical signals which carry digital data streams representing various types of information.

Communications path 226 typically provides data communication through one or more networks to other data devices. For example, in the present invention communications path 226 can provide a connection through local network 236 to host computer 234 or to data equipment operated by an Internet Service Provider (ISP) 238. In turn, ISP 238 provides data communication services through the worldwide packet data communication network now commonly called the “Internet” 240, described in detail in other embodiments.

Local network 236 and Internet 240 both use electrical, electromagnetic or optical signals that carry digital data streams. The signals through the various networks and the signals on communications path 226 and through communication interface 224, which carry the digital data to and from computer 200, are exemplary forms of carrier waves transporting the information.

Computer system 200 can send messages and receive data, as well as computer programs, through the network or networks, communications path 226, and communication interface 224. If the network used is the Internet, server 242 can transmit a requested code for an application program through Internet 240, ISP 238, local network 236 and communications path 226. Examples of such applications are the application programs run by application servers and database servers, as described in detail below.

V. Client-Server Environment

In one embodiment, the aforementioned nodes 102-108, processors 110, and processes 112, 114 running on the processors, are described by virtue of their functions with respect to information retrieval within a network.

Specifically, a node that requests information is termed a “client” and a node that transmits the requested information is termed a “server.” A node can have the dual roles of serving as both a client as well as a server.

The processes running on the clients are termed client applications, and the processes running on a server are termed server applications. Information exchange occurs between the server application providing the information or services, and the client application receiving the provided information and services.

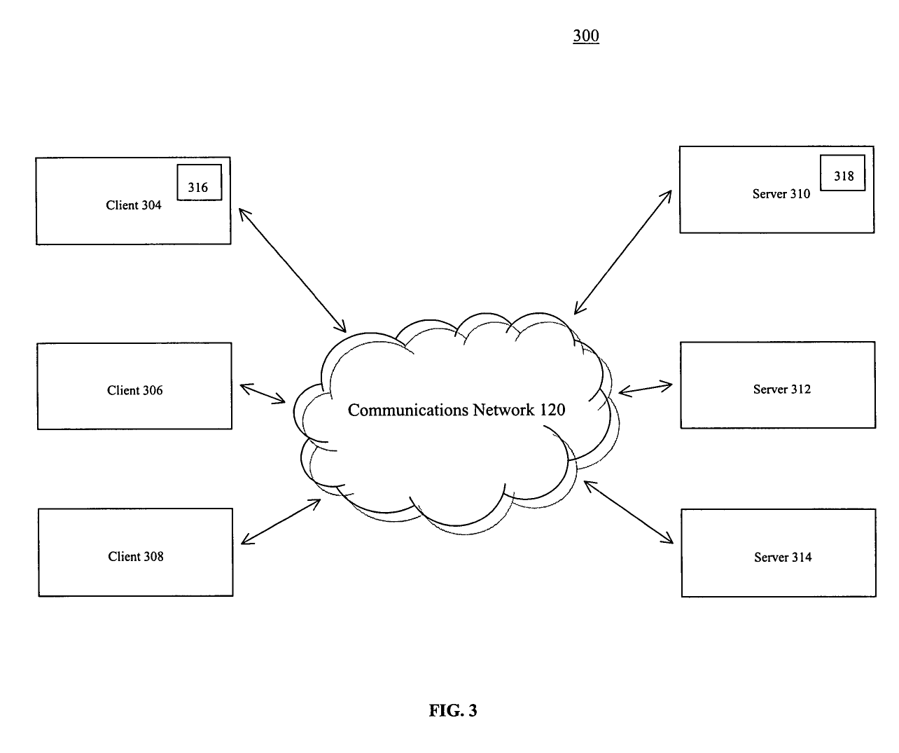

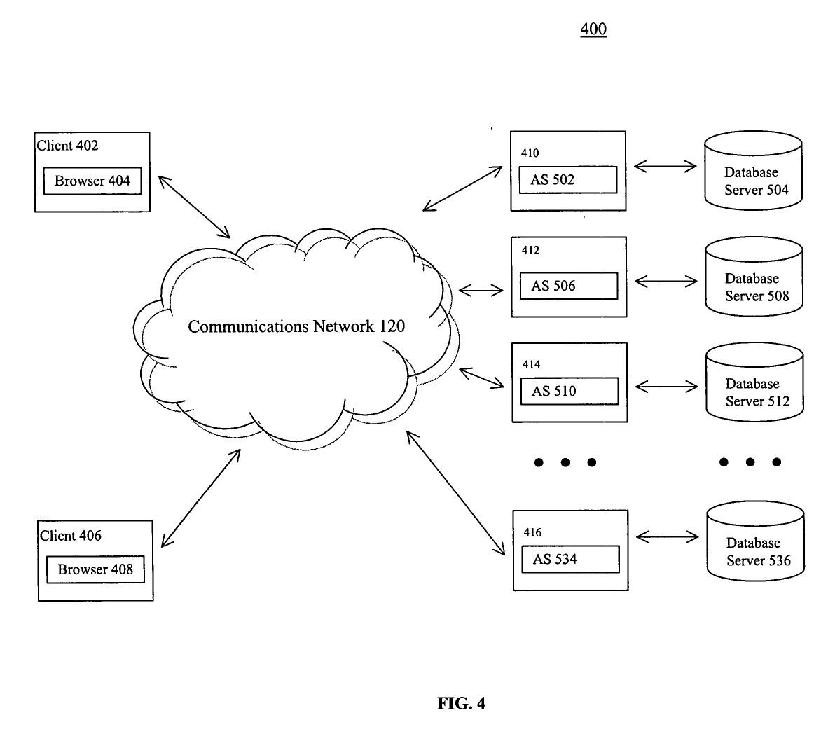

FIG. 3 illustrates an exemplary client-server environment 300. Client-server environment 300 includes the aforementioned communications network 120, which can be a national or an international network. It also includes a number of clients 304-308, and a number of servers 310-314. The clients 304-308 and the servers 310-314 are nodes connected to network 120, defined by their respective information retrieval functions.

Client 304 includes a client application 316, which is an information requesting or receiving application associated with client 304. Client application 316 either runs on client 304 or runs on another node and is passed to client 304.

Server 310 includes a server application 318, which is an information retrieval application associated with server 310. Server application 318 either runs on server 310 or runs on another node and is passed to server 310.

In operation, client application 316 is executed on client 304. In response, client 304 issues a request for information transmitted over network 120. The request is received by server 310, which executes server application 318. The requested information and/or services are then transmitted back to client 304 over network 120.

VI. Internet and World Wide Web Environment

A. Introduction

In these embodiments, an introduction of the Internet and how it is used in the context of the present invention is provided. As noted, network 120 can be any type of network, either private or public. In one or more embodiments, environment 300 (including network 120) refers to the Internet and World Wide Web (Web). In these embodiments, clients and servers transmit information in formats and media acceptable to the Internet and Web.

Internet refers to a worldwide system of interconnected computer networks that use the Transmission Control Protocol/Internet Protocol (TCP/IP) set of protocols. TCP/IP, in turn, typically refers to a bundle of network protocols, including: (i) the IP, a network layer protocol where unique IP addresses identify each network and each of its hosts, (ii) TCP, a connection-oriented protocol, where a connection is established via handshakes before any data is transmitted and (iii) certain application layer protocols, including telnet and file transfer protocol (FTP).

The parts of the Internet that are most widely used are electronic mail (e-mail) and the aforementioned Web. The Web is a network of computers located all over the world. These international computer networks can be comprised of clients and servers that users access to locate resources.

All the clients 304-308 and servers 310-314 in the Web can communicate with each other, and normally use a communication standard called Hypertext Transfer Protocol (HTTP). HTTP is an application protocol, i.e. a set of rules, for exchanging files on the Web that runs on top of TCP/IP.

The information on the Web is stored in documents called Web pages, which are files stored on the servers 310-314 comprising the Web. The clients 304-308 request the Web pages from the servers 310-314 (specifically server applications 318 running on the servers 310-314). More specifically, client applications 316 running on the clients 304-308 request the Web pages from server applications 318 running on the servers 310-314.

B. Displaying Information and Navigating on the Web

In these embodiments, the displaying of information and navigating on the Web in the context of the present invention is provided.

The client applications 316 are typically called Web browsers. Examples of well known browsers 316 that can be used with the present invention include Spry's Mosaic, Microsoft's Internet Explorer, and Netscape's Navigator. Browsers 316 are capable of understanding a variety of program languages used to design the Web pages, as well as protocols used to transmit the Web pages.

Web browsers 316 have varying levels of sophistication and functionality. Each screenful of information includes such items as highlighted words, graphics, menu choices, through which users can hyperlink (or “link”) to retrieve further information, either from the client 304-308 itself (for local files) or from servers 310-314 located on the Web. Table 2 contains common Internet terms known to skilled persons.

The manner of displaying the retrieved informational content in a web browser 316 is primarily according to formatting and display languages. Examples of formatting and display languages that can be used with the present invention include Hyper Text Markup Language (HTML), eXtensible Markup Language (XML), eXtensible HyperText Markup Language (XHTML), and Cascading Style Sheets (CSS).

HTML is used to create text files that contain markup tags, which inform the browser how to display the page. HTML files must have an “htm” or “html” file extension, and can be created using a simple text editor. XML is a markup language, permitting users to define their own markup tags. The markup tags in XML are not predefined as with HTML. XML uses a Document Type Definition (DTD) or an XML Schema to describe the data. While HTML was designed to display data, focusing on how the data appears, looks, XML was designed to describe data, focusing on the data itself, providing the ability to structure, store, and to send information. XML is pared-down version of Standard Generalized Markup Language (SGML), specifically designed for Web documents. SGML is a comprehensive system for the organization and tagging of document elements. Rather than specifying particular formatting, SGML specifies the rules for tagging elements. XHTML is the same as a version of HTML referenced as HTML 4.01. It is HTML defined as an XML application and applies a strictly defined version of HTML. CSS is used to design stylesheet pages, which define how the document is displayed or printed to the browser. CSS sheets can be attached to the HTML document itself. The cascading feature supported by CSS permits a single document to use two or more stylesheets, which are applied according to specified priorities.

The manner of formatting the information for retrieval from servers 310-314 and transmitting the retrieved information over network 120 are determined by protocols. A variety of protocols can be used to implement the present invention over the Internet, including the aforementioned HTTP, FTP, telnet, as well as, for example, Internet Relay Chat (IRC).

The main protocol (or set of rules for navigation and exchanging of files between clients and servers) used on the Web is HTTP, designed for exchanging files running on top of TCP/IP. HTTP not only defines how messages are formatted and transmitted, but also what actions Web server applications 318 and browsers 316 should take in response to various commands.

The act of using a client browser 316 to download a Web page located at a server application 318 can also be called navigating the Web, or browsing the Web, or linking to Web sites on the Web. Each Web page has a Web address called a Uniform Resource Locators (URLs). Consequently, Web pages are located by linking to the URL of a Web page and displaying it in the browser 316. Users can link to Web pages by selecting or clicking on menu choices, highlighted words, or graphics associated with URLs. When a user enters a URL in his/her browser, or otherwise attempts to link to a website, it causes an HTTP command to be sent to the appropriate Web server, directing it to fetch and transmit the requested Web page.

FIG. 4 illustrates a detailed exemplary client-server environment 400. Environment 400 of FIG. 4 includes the aforementioned communications network 120, a plurality of clients 402, 406 and a plurality of servers 410, 412, 414, 416, connected to network 120. The servers are shown connected to a plurality of database servers (DSs). Specifically, server 410 is connected to DS 504, server 412 is connected to DS 508, server 414 is connected to DS 512, and server 416 is connected to DS 536.

The clients 402, 406 and the servers 410-416 are nodes connected to network 120, defined by their respective information retrieval functions. Client 402 includes a client application 404, which is an information requesting or receiving application associated with client 402, and client 406 includes a client application 408, which is an information requesting or receiving application associated with client 406. Client applications 404, 408 can run either on clients 402, 406, respectively, or can run on another node and are then passed to the clients 402, 406. In one or more embodiments, the client applications 404, 408 are web browsers.

Servers 410-416 include a variety of processes, including operating systems, web server applications and application servers. The operating systems, which can also be called platforms, are the software programs that applications use to communicate with the physical parts of the servers 410-416. Examples of operating systems that can be used with the present invention include: Linux,™ Sun Solaris,™ Windows NT/2000,™ Cobalt RaQ™ and Free BSD,™ although any operating systems known or anticipated can be used.

The web server applications are software running on servers 410-416 that make it possible for the client browsers 404, 408 to download stored web pages. These applications also coordinate streaming audio, video, and secure e-commerce, and can be integrated with databases (as described below) for information retrieval. Examples of web server applications that can be used with the present invention include: Apache,™ Microsoft's Internet Information Server (IIS),™ O'Reilly & Associates WebSite Pro,™ Netscape's FastTrack Server,™ and StarNine's WebSTAR™ (for Macintosh), although any operating systems known or anticipated can be used.

The application servers sit on top of the formatting and display languages (for example, HTML) that a request from clients 402, 406 generate and translated the request for databases. Upon receiving information from databases, the application servers will translate this information back to the formatting and display languages and sent a response back to the browser. In one or more embodiments, the application server software resides at the servers 410-416, although with cross-platform programming technology, software performing the same functions can reside at clients 402, 406 as well. In one or more embodiments, the application servers will insert strings of programming code into the formatting and display language, with client browsers 404, 408 employing interpreters (or a plug-ins) to translate back into the formatting and display language (for example, HTML) to display a page. Examples of application servers that can be used with the present invention include: Cactus™, Cold Fusion™, Cyberprise Server™, Ejipt™, Enterprise Application Server™, Netscape Application Server™, Oracle Application Server™, PowerTier for C++™, PowerTier for Enterprise Java Beans™, Secant Extreme™, Enterprise Server™, SilverStream™, WebEnterprise™, WebSpeed™, and WebSphere,™ although any application servers known or anticipated can be used.

Taken together, the web servers and applications servers perform at least these functions: (i) providing an environment upon which server components can run; (ii) functioning as is a main program under which other components run as subroutines; (iii) providing services (for example, security related services, transaction related services), state management, and resources (for example, database connections); (iv) enabling communication with clients 402, 406.

The variety of processes running on servers 410-416 can be written using any program languages and types. Some or all of the programs can be cross-platform applications that additionally to running on the servers (or instead of running thereon) run on the clients 402, 404. Examples of cross-platform programs are Java applets, which run on clients, and servlets, which run on servers. Examples of programming languages that can be used with the present invention include: CGI™, Perl™, Java™, VBScript™, Python,™ Microsoft ASP™, Java™, C++, Visual Basic, Enterprise JavaBean (EJB), although any languages known or anticipated can be used.

For the convenience of condensing terminology, the aforementioned applications working, which work together on the servers 410-416 (or instead are processed at other nodes and passed to servers 410-416) are referred to as “application servers.” FIG. 4 illustrates applications servers (ASs) 502, 506, 510, 534 respectively running on clients 410, 412, 414, 416. In operation, client browsers 404, 408 are used to issue requests for information, or queued to transmit information, over network 120. Requests and responses are handled by servers 410-416 via running of ASs 502, 506, 510, 534, which in turn transmit information over network 120 for display by browsers 404, 408.

In one or more embodiments, additional functions required of ASs 502, 506, 510, 534 will be to connect the web servers 410-416 to, for example, back-end data resources such as relational tables, flat files, e-mail messages, and directory servers. In exemplary embodiments, additional programs incorporated in ASs 502, 506, 510, 534 typically called “middleware,” database utilities, or database management systems (DMBS) can be used, among other known or anticipated database methods.

For example, the ASs 502, 506, 510, 534 can include their own internal DBMSs, or DBMSs of other nodes, or the DBMSs labeled database servers (DSs) 504, 508, 512, 536. The DBMS refers to computer software for storing, maintaining, and searching for data in a database. In the present invention, the DBMS can also utilize facilities for increasing reliability and performance, and integrity, such as indexes, logging, and record locking.

In one or more embodiments, the DBMS includes interfaces for searching for and locating particular data items from the database and for presenting the result of these queries to a search engine. A search engine as used herein searches the database in response to a user request, which can be initiated at client browser 402, 406, for example, or at server 502-504, for example, and returns a result to the user, for example in the form of a relational table viewable in browsers 404, 408. The DBMS can refer to any type of database, including a relational DBMS (RDBMS), LDAP,™ VSAM™, IMS™, Active Directory Services,™ message stores, to name a few.

In one or more embodiments, the DBMS is an RDBMS that uses relational database to retrieve information from the database. In one or more embodiments, the relational database uses structured query language (SQL™), including SQL defined according to International Standards Organization (ISO) and American National Standards Institute (ANSI) standards, or follow these standards with additional language constructs. In one or more exemplary embodiments, ASs 502-504 are respectively connected to DSs 504-536 via an application programming interface (API), including for example the open database connectivity (ODBC™), Java database connectivity (JDBC™), APIs.

In one or more embodiments, additional interfaces are used that can be employed for multiple types of databases, not just relational databases. One example is Microsoft's OLE-DB™ that provides access to all types of information, whether stored in RDBMS™, VSAM™, IMS™, Active Directory Services,™ message stores, among others.

Any types of DBMS platforms can be used in the present invention. Exemplary platforms employed include Sun Microsystems' Java™ 2 Platform, Enterprise Edition (J2EE),™ which contains an Enterprise JavaBeans™ (EJB) server-side component architecture, and Microsoft's Windows™ Distributed interNet Applications Architecture (Windows DNA™), which contains the COM+™ server-side component architecture.

TABLE 2

| INTERNET | |
|---|---|
| TERM | DEFINITION |
| ActiveXControl | A COM object that can be loaded from a server via inter- or intranet and |
| | run on any NT-client. |
| Browser | A Browser (or Web Browser) is a computer application that fetches Web |
| | pages from servers on the Internet and displays them on the user's local |
| | machine. |
| CML | Chemical Markup Language is an XML schema designed for handling |
| | information concerning chemical substances. |
| COM | Component Object Model is an MS-paradigm for connecting |
| | components, which has implemented the base technology for COM on |
| | the NT platform. |
| CSS | Cascading Style Sheets refers to a W3C Recommendation for files that |
| | when attached to a document will describe how the document is to be |
| | displayed or printed. |
| DHTML | Dynamic HTML is a standard for extending HTML that consists of |
| | HTML 4.0, DOM, CSS, and certain scripting languages. |
| DocBook | DocBook refers to XML and SGML DTDs and DSSSL/XSL stylesheets |
| | owned by OASIS for use in modeling manuals and converting them. |
| DocZilla | DocZilla is the Web browser offered by CITEC that can render XML, |
| | SGML, and HTML documents. |
| DTD | Document Type Definition refers to a specification for schema |
| | specification for SGML and XML documents. The DTDs can be |
| | contained within a document or belong to an external subset that is |
| | referenced. Examples of DTDs include HTML, DocBook, CML, and |
| | IBTWSH. |
| ebXML | electronic business XML, A project jointly initiated by UN/CEFACT (= The |
| | United Nations body for Trade Facilitation and Electronic Business) |
| | and OASIS to standardize XML business specifications. ebXML intends |
| | to develop a technical framework that will enable XML to be utilized in a |
| | consistent manner for the exchange of all electronic business data. |
| FTP | File Transmission Protocol refers to an application protocol for |
| | exchanging files over top of TCP/IP. FTP can be used to upload a |
| | webpage to a server. |
| HTML | Hypertext Markup Language is a DTD that consists of both text and tags |
| | widely used for performing document layout and performing |
| | hyperlinking. Java applets can be included using an <APPLET> tag. |
| | The current W3C version of HTML is HTML 4.0, which is also known |
| | as XML-compatible HTML (XHTML). |
| HTTP | Hypertext Transfer Protocol is the application protocol that controls the |
| | exchanging of files on the Web, and is within the architectural domain of |
| | W3C. |
| IE | Internet Explorer, the leading web-browser offered by Microsoft and |
| | provided free-of-charge with Microsoft operating systems. |
| Internet | A worldwide system of computer networks based on the TCP/IP set of |
| | protocols. Its most widely used parts are electronic mail (e-mail) and the |
| | World Wide Web (WWW). |
| Intranet | A private network that is contained within an enterprise using TCP/IP, |
| | HTTP, and other Internet protocols. Intranets may include connections |
| | through gateway computers to the Internet using firewall servers for |
| | security. |
| IP | Internet Protocol, protocol in the TCP/IP internet layer for |
| | communication between nets and their hosts. An IP-address uniquely |
| | identifies each network and each of its hosts on the internet. Addresses |
| | consist of four bytes that can be represented by four integers (0 to 255) |
| | separated by dots, e.g. “157.189.162.75”. Dependent on the address' class |
| | and a subnet mask, a specific number of bits identify the net or subnet |
| | and the rest a PC's address within this net/subnet. |
| ISO | ISO is the acronym for the International Organization for |
| | Standardization, which is an influential international federation of |
| | national standards organizations from over 100 countries. |
| Java | Java is an object oriented programming language that is cross-platform |
| | compatible and supports multithreading. Java is executed on any |
| | platform using the Java Virtual Machine (JVM). |
| Java Applet | A component written in Java, that can be downloaded from a server via |
| | an intra- or internet and executed on a client. The applet runs in a |
| | sandbox, e.g. the security settings only allow the applet to access data |
| | located on the server the applet is downloaded from. Most browsers |
| | contain a Java Virtual Machine (JVM) and are thus capable of running |
| | applets. |
| JavaBeans | JavaBeans refers to a Java component model where reusable “beans” are |
| | created using a Bean Development Kit (BDK). |
| Netscape | Netscape Navigator refers to Netscape's web-browser, which is currently |
| Navigator | part of Netscape Communicator. |
| SGML | Standard Generalized Markup Language is the standard for documents |
| | adopted in 1986 by the ISO for defining documents using DTDs. |
| | Document contents are identified by using semantic tags. |
| Tag | A tag is a vanilla term for a language element descriptor. Markup usually |
| | refers to the set tags for a document. |
| TCP | Transmission Control Protocol is a transport layer protocol, which is |
| | used to establish a proper connection (hand shaking) before any data is |
| | transmitted. |
| TCP/IP | Transmission Control Protocol/Internet Protocol refers to the two |
| | primary Internet protocols, namely the Internet Protocol IP (from which |
| | colloquial usage of the term “Internet” comes) and Transport Protocol |
| | TCP. It can also refer to certain application protocols, including FTP and |
| | telnet. |
| URL | Universal Resource Locator refers to the unique address of a document or |
| | a resource on the Internet. |
| W3C | The World Wide Web Consortium is an influential industry consortium |
| | promoting and maintaining the standards for the Web. The consortium |
| | also handles interoperability issues between Web products through its |
| | production of specifications and reference software. |
| WAP | Wireless Application Protocol refers to the primary standard for |
| | accessing the Internet using wireless devices. |
| WML | Wireless Markup Language refers to the DTD used in WAP. (see above) |
| WWW | World Wide Web, or simply Web, refers to the resources and users on |
| | the “Internet” using the Hypertext Transfer Protocol (HTTP). |
| XHTML | Extensible HyperText Markup Language refers to a reformulation of |
| | HTML 4.0 in XML 1.0. |
| XMLHTTP | This term refers to “Microsoft.XMLHTTP” or an “XMLHttpRequest |
| | Object”, which refer to the ActiveXControl enabling access to instances |
| | of HTTP request. |

VII. Integrated Marketing Vehicle Platform

A. Exemplary Environments

The present invention is directed to an Integrated Marketing Vehicle Platform (IMVP). IMVP is a technology based product that permits any brand entities to interact with existing consumers, potential consumers, or individuals in general, through targeted push and pull advertising, communications, exchange of incentive rewards or cash, information exchange, extraction and abstraction of collected information, sign up and program participation, and general brand promotion, to name a few of the implementations described herein and contemplated by skilled persons. An example of a brand entity is an advertiser, though skilled persons will observe any other types of entities can make use of the present invention, as noted below.

In portions of the written description portion of the specification, the technology discussed in the foregoing sections is applied to two specific types of environments. Specifically, the environments are described with respect to (i) broadcasters desiring to target consumers through television, radio, wireless devices, and the Internet, in order to benefit their own consumers, namely advertisers and ad agencies, to for example provide specific and abstracted information about existing and potential consumers and to promote their company brands; (ii) companies desiring to sponsor race vehicles (which will display their company logos on the vehicles) in the National Association of Stock Car Auto Racing (NASCAR), where such sponsors can target consumers through television, radio, wireless devices and the Internet, in order to obtain benefit through for example obtaining specific and abstracted information about existing and potential consumers and to promote their company brands.

However, it is important to note that the method and apparatus described herein are equally relevant to any other applications, environments, and by any other types of entities other than the foregoing broadcasters, advertisers and NASCAR sponsors.

Examples of other entities include ad agencies, any business owners, organized sports and affiliations, public interest groups, non-profit companies, lobbying organizations, governmental agencies, and essentially any persons desiring to promote their messages or brand their products, though it should be noted the present invention is in no way limited to such entities, or the uses described herein, as skilled persons can determine.

Furthermore, the entities can also include machines (hardware and/or software) or other automated facilities affiliated with the aforementioned categories. For example, in the present invention, an advertiser can be a corporation, a business unit of the corporation, or one or more processes representing the corporation or business unit. Throughout the specification, the foregoing entities are referred to as “brand entities” or “brand entity users.”

In addition, the entities who are targeted by the “brand entities” or “brand entity users” through use of the present invention, including existing consumers and potential consumers, are referred to herein as “consumer users” or simply “users.” The foregoing labels are for the sake of convenience, and not by way of any limitation, and can refer to any of the foregoing entities, and any other entities, without departing from the features and functions of the present invention. The same applies to other entities used throughout this written description.

Skilled persons will also understand that the use of any terms throughout the specification depicting particular hardware, software, or combinations thereof, are provided by way of example, not limitation, and that the present invention can be utilized and implemented by any systems and methods presently known or possible without escaping from the features and functions disclosed herein.

In addition, the following embodiments describe the features and functions associated with the above-noted technologies. The embodiments also illustrate exemplary graphical user interfaces (GUIs), for examples web pages (also called “screen shots”) having one or more fields for informational content. The informational content can be (i) shown to individuals or entities, or (ii) stored, or maintained in the aforementioned database servers or any other capable device, or (iii) processed, downloaded, or uploaded by and from the aforementioned application servers, client servers or any other capable device.

B. Basic Embodiment

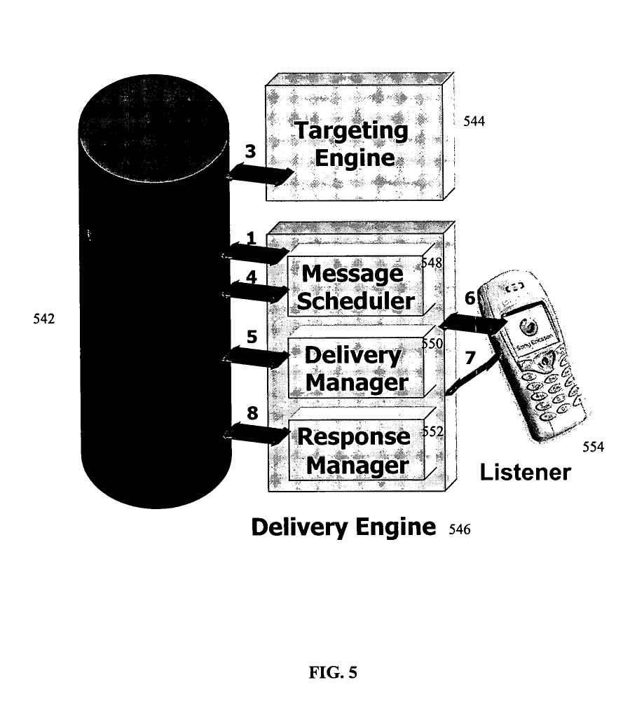

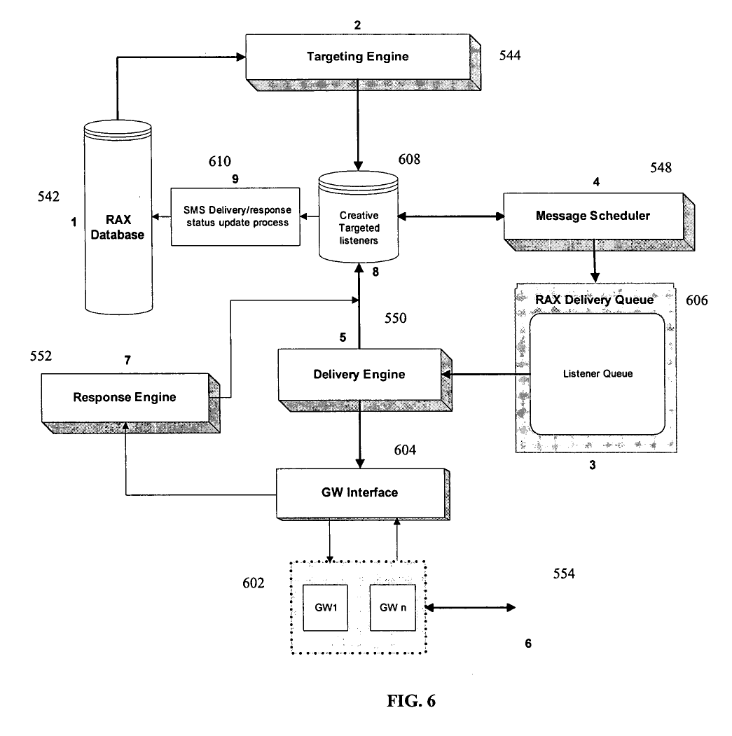

Referring to FIG. 5, a simplified structure for the present invention is illustrated. FIG. 5 includes database 542, targeting engine 544, delivery engine 546, and a consumer interaction device 554. In this example embodiment, the consumer interaction device 554 is a wireless cell phone, though any other device permitting consumer interaction known to skilled persons can be used. The delivery engine 546, in turn, includes a message scheduler 548, a delivery engine 550, and response manager 552.

It should be noted that the implementation illustrated in FIG. 5, and the other figures throughout this written description below, are for illustrative purposes, and not by way of limitation. Specifically, such figures are meant to embody the various embodiments described with respect to FIGS. 1-4 above.

For example, the database 542, targeting engine 544, delivery engine 546 (including message scheduler 548, delivery manager 550 and response manager 552) can be, for example, processes 112, 114 (i.e., applications) running on processor 110 of a node 102, connected over a communications network 120 (not labeled) to another node 108, namely consumer interaction device 554.

As another example, targeting engine 544, delivery engine 546 (including message scheduler 548, delivery manager 550 and response manager 552) can be, for example, applications running on an AS 502 on server 410, connected over a communications network 120 (not labeled) to client 102, namely consumer interaction device 514, and database 542 is database server 504.

The following is a description of the core functions of the database 542, targeting engine 544, and delivery engine 546 in this embodiment.

A consumer user, who is an existing consumer or potential consumer, uses consumer interaction device 554 to interact with delivery engine 546. Although illustrated as a wireless cell phone, in actuality consumer interaction device 554 can be any type of processing or interactive device conceived by skilled persons, including, without limitation, any combination of the nodes, processors, software, hardware, clients and servers described with respect to FIGS. 1-4 above.

As a few examples, device 554 can be a personal computer running a web browser and communicating over Internet access, or a wireless device receiving SMS text messages, or MMS multimedia messages, or running a web browser using WAP or another wireless Internet protocol, to name a few possibilities. The user uses consumer interaction device 554 to interact with delivery engine 546 over a communications network 120 (not labeled) using any protocols, over any mediums, including for example, wireline, wireless microwave, radio, and satellite. Consumer interaction device 554, which communicates with the delivery engine 546, permits the consumer user to perform the types of interactions and exchanges as described below, which includes responding to creative and campaign questions, among others.

Database 542 stores any type of information, for example, details about consumer users, campaigns and creatives, as described in detail below. A campaign refers to a process, or instance, for implementing a marketing campaign according to the features of the present invention. In one or more embodiments, a consumer user can be targeted in accordance with any, or all, or a combination of these push and pull marketing techniques: dialogues, lotteries, informational content exchange and responses (including demographics, psychographics, previous responses, brand entity user specific content), polls, quizzes, promotions, advertising, traditional commerce, treasure hunts, ecommerce (for example, direct online purchases, as well as online sponsorship and online advertising based models), auctions (for example, dollar bid auctions, points based auctions), token awards, coupons (for example, discount coupons, point-of-sale coupons), loyalty incentives, and questionnaires. A number of the foregoing categories are colloquially defined in Table 3. Collectively, the foregoing targeting categories can be referred to herein as “informational content exchange.” Brand entity users can conduct information content exchange with consumer users as described in detail below, for mutual benefit of the brand entity users and the consumer users. In fact, any of the type of information processed by targeting engine 544, as described below, can be implemented into a campaign. As used herein, the term campaign refers not only to the foregoing processes, or instances, but to the features and functions of such process, including the types of informational content exchanges themselves.

A creative refers to a particular process for implementing a particular informational content exchange of a campaign, for example a single poll, or a single quiz. In other words, campaigns are made up of multiple creatives. Any of the types of information processed by targeting engine 544, as described below, can be implemented into a campaign. As used herein, the term creative refers not only to the foregoing processes, or instances, but to the features and functions of such process, including the types of informational content exchanges themselves.

An example of a question type of creative is: Q1: Do you think Tiger Woods will win the Masters? 1) Yes 2) No. This particular type of creative permits using a generic term, namely an answer of 1 or 2, instead of a subjective answer to the question, though any types of creatives contemplated by skilled persons can be used.

Campaigns and creatives are manipulated based on the processing of targeting engine 544, as described below. For example, rules can be applied to campaigns, and the various campaigns and creatives within campaigns can interact with one another. Exemplary rules include (i) that from within a creative, an API call can be made to another campaign's first creative, but not another creative within that same campaign; and (ii) based on the response to a creative within a particular campaign, a creative from another campaign is exchanged with the consumer user at device 554.

As noted, a campaign can comprise, for example, a list of questions Q1, Q2, Q3 and Q4. As an example of the above rule (ii), from Campaign 1, the answer to Q1 causes Campaign 3's Q1 to be sent to the consumer at device 554. As another example, from Campaign 1, the answer to Q2 causes Campaign 2's Q1 to be sent to the consumer user at device 554.

As alluded to above, Table 3 includes a list of terms helpful to understanding the features and functions of the present invention (including term such as creatives and campaigns). As noted, the definitions provided therein and the other tables herein are provided for convenience of understanding the concepts of the present invention, and not by way of limiting the features and functions of the written description portion of the specification.

TABLE 3

| GENERAL TERMS | DEFINITION |
|---|---|
| acknowledgement | Acknowledgements are one type of specific responses to |
| | questions/messages of creatives and campaigns. |
| advertiser | Advertisers are brand entities who specifically benefit from the |
| | features and functions of the present invention. For example, an |
| | advertiser can purchase mobile or electronic campaigns from a |
| | broadcaster (where they may have restricted access to the inventive |
| | system), or an advertiser can be a sponsor of a NASCAR race. |
| | Advertisers can have restricted access to the system, where they are |
| | referred to as a brand entity user or an external user. |
| alpha query | Alpha query allows a brand entity user of IMVP to search the |
| | database, for an advertiser name or campaign name, by selecting the |
| | first letter of either name. Once the letter is selected, all the options |
| | for that selection can be displayed to the brand entity user. |
| ASP (application | Application service provider (ASP) is a provider who provides |
| service provider) | software delivered as a service. |
| auction | A dynamic commerce system enabling consumer users and brand |
| | entity users to determine prices in real time on a per-transaction |
| | basis. Brand entities may create and manage point-based and/or |
| | currency driven auctions, for example. |
| billing | Billing information is data that is pertinent to how much a brand |
| | entity pays, i.e., an advertiser owing a broadcaster (who runs |
| | IMVP), or a sponsor who runs IMVP owing its owners. The data |
| | that drives the creation of billing data can be entered in the ad |
| | manager. |
| broadcaster | Broadcasters own and operate radio stations. Radio stations are the |
| | interface between consumer users who are listeners and brand entity |
| | users, ultimately driving revenues for broadcasters. |
| buy now bid | The buy now bid is the amount that is entered during an auction that |
| | will allow a consumer user to immediately purchase the item before |
| | the auction is scheduled to end. |
| campaign | Campaigns refers to marketing campaigns using IMVP, and the |
| | respective processes that are run. Campaigns are, for example, sent |
| | by broadcasters as information driven promotions directly sent to |
| | consumer users. Campaigns created using IMVP may be in the |
| | format of specific creatives, such as polls, quizzes, commerce |
| | (auctions), and questionnaires. |
| campaign approval | Campaign approval can be required for every campaign entered into |
| | the system before it can be scheduled for delivery. Campaigns can |
| | be approved by brand entity users before being scheduled. |
| campaign cost | The campaign cost is the cost per campaign message multiplied by |
| | the number of messages sent. This information is important to |
| | brand entity users, because it is what they pay. |
| campaign linking | Campaign linking guides a consumer user through a series of |
| | campaigns based on criteria being met within that campaign. (For |
| | example, the first 50 people that answer correctly get the next |
| | campaign.) |
| copy | Copy is an IMVP function that permits a brand entity user to copy |
| | and rename any existing campaign. Once renamed, changes can be |
| | made to any data within the campaign. |
| coupon | A coupon is an offering to a consumer user that provides a discount |
| | of some type on an item offered by an advertiser. |
| cost per message | The cost per message is the total cost of the campaign divided by the |
| | number of messages that are sent. |
| CPM | CPM is a standard term in the advertising industry. CPM stands for |
| | cost per thousand impressions (Roman numeral M for thousand). In |
| | IMVP, CPM referrers to 1,000 messages. One message equals 1 |
| | impression. |
| Creative | A creative refers to a question/message within a campaign. A |
| | campaign can consist of multiple questions or creative. |
| creative priority | A creative priority is calculated within the targeting engine based on |
| | a campaign's start and end dates, along with the total number of |
| | messages to be sent and the total number of messages already |
| | delivered. This priority changes as the campaign gets ahead or |
| | behind schedule and determines when it will be scheduled |
| | considering the criteria for all other campaigns. |
| comma separated | CSV allows reports generated by IMVP to be rendered into Comma |
| value (CSV) | Separated Value text streams in order for programs, such as Excel, |
| | to easily import the data. |
| demographics | Demographics are a type of information regarding consumer users. |
| | Demographics are used by brand entity users to target consumer |
| | users with campaigns. Examples of psychographics include favorite |
| | foods, colors, movie, etc. Examples of demographics are age, |
| | income, race and marital status. |
| dialogs | Dialogs are campaigns that drive multiple responses. Campaigns |
| | that are developed as dialogs automatically send follow-up |
| | messages set by business rules created during the campaign set-up. |
| direct purchase | Direct purchases are fixed price (not dynamic) transactions made |
| | through the commerce manager. Campaigns maybe designed to |
| | allow consumer users to purchase or redeem points for merchandise. |
| dollar bid | Dollar bids are currency based transactions in the commerce |
| | manager application of IMVP. |
| duplicate responses | A duplicate response is when a consumer user submits an answer |
| | multiple times. The system will only allow one response per |
| | message. |
| external users | External users are the same as brand entity users, or in the case of |
| | the broadcasting environment, advertisers or ad agencies and other |
| | third party users that first party broadcasters give limited access too. |
| flow control | A workflow based system allowing IMVP to manage the capacity of |
| | wireless gateways. Business rules may be established to intelligently |
| | route campaigns to the preferred gateway determined by price or |
| | capacity. |
| frequency capping | Frequency capping is a feature managing the number of campaigns |
| | consumer users are sent during a defined period. Consumer users |
| | may set their desired preference of campaign frequency. |
| fuzzy search | Fuzzy search allows a brand entity user to search the database, for |
| | an advertiser name or campaign name, by entering a keyword or |
| | partial keyword. Once entered, all the options that match the |
| | selection are displayed to the brand entity user. |
| Globally unique | The GUID is a unique identifier of each consumer user based on the |
| identifier (GUID) | internal id of their mobile device. |
| item number | The item number can be, for example, the Unique Product Code |
| | (UPC) of the merchandise entered in the commerce manager. In |
| | some cases, UPC's will not exist for merchandise/items entered. A |
| | default item number is issued when adding an item in the commerce |
| | manager. |
| internal users | Internal users are the same as brand entity users, or in the case of the |
| | broadcasting environment, the first party broadcasters themselves |
| | (as opposed to third party advertisers who are third party users). |
| keyword | Keywords are terms that may be used during a search request. Brand |
| | entity users use keywords to search previous campaigns and |
| | responses for the purpose of adding new targeting criteria. |
| limited exposure | The ability to limit the number of times a consumer user views a |
| | specific campaign. |
| localization | Localization is the process of converting documents, training |
| | materials and multiple language data entry within the system. |
| | Localization does not necessarily require that the language within |
| | the UI be supported in multiple languages. |
| logging | A function that stores data for reporting, support or troubleshooting. |
| lottery | Campaigns that are contests allowing consumer users to guess a |
| | specific number generated by the broadcaster to earn points or win |
| | items. The system can be setup to allow one or multiple winners. |
| maximum listener | The maximum consumer user reach is the maximum target reach |
| reach | number divided by the total number of messages entered within the |
| | campaign. |
| message scheduler | The message scheduler reads the database and determines that a |
| | campaign is ready to be sent to the targeted consumer users. |
| MMS (multimedia | Multimedia message service (MMS) is an advanced protocol |
| message service) | allowing multimedia campaigns. (video, ring tones, pictures, etc.) |
| mobile marketing | A mechanism for advertisers and broadcasters to interact with their |
| | consumer users through their mobile devices. |
| net 15, net 30 | Net 15 or net 30 are standard terminology used in accounting for the |
| | amount of time a brand entity user has to settle an invoice/bill. For |
| | example, net 15 means a vendor (advertiser) has 15 calendar days to |
| | pay an invoice. |
| override rate | An override rate provides a percentage discount to advertisers for a |
| | specific campaign. The override is multiplied by the standard price |
| | and is the final campaign price. This rate overrides the permanent |
| | discount rate. |
| permanent discount | The permanent discount rate is a percentage discount offered to |
| rate | brand entity users, or in the case of first party broadcasters and third |
| | party advertisers, the discount offered to the advertiser and |
| | determined by the broadcaster. The permanent discount rate is used |
| | in all campaigns unless an override rate is imputed. |
| points | Points are a form of currency that has no set value. Points are used |
| | as incentives in campaigns. Points are redeemed through commerce |
| | based campaigns. |
| poll | Polls are surveys that ask questions which have no one correct |
| | answer. Polls are used to prompt consumer users to give opinions. |
| previous response | Previous campaign responses can be used for targeting criteria for a |
| | future campaign. Each consumer user's responses are saved for |
| | every campaign. |
| psychographics | Psychographics are a type of information imputed by the consumer. |
| | Psychographics are used by brand entity users to target consumer |
| | users with campaigns. Examples of psychographics include favorite |
| | foods, colors, movie, etc. |
| pull campaigns | A pull campaign is a campaign that is initiated by a consumer user |
| | by responding to information within a promotional campaign (for |
| | example, a billboard, radio ad, Coke ™ can, etc.) |
| push campaigns | A push campaign is a campaign that is initiated within the IMVP |
| | system and is pushed to the consumer user. |
| questionnaire | Questionnaires are campaigns that have multiple answers offered |
| | and are used to gather information about the consumer user. |
| quiz | Quizzes are campaigns that have multiple answers offered and have |
| | a correct answer to each question. As a quiz progresses, the |
| | difficulty of the questions can vary based on previous responses. |
| refined search | A refined search allows a brand entity user to further reduce the |
| | number of selections within a keyword/fuzzy search by entering |
| | more precise criteria. The refined search button must be selected or |
| | another keyword search will be ran |
| response | A response is the way a consumer user interacts with certain types |
| | of campaigns that they receive. All user responses are saved for |
| | future targeting criteria. |
| response number | The response number is the number of consumer users that can |
| | either win a campaign or the total number that can be accepted to |
| | continue a campaign. |
| retail value | The retail value of an item is entered by the consumer user when |
| | added within the commerce manager application of the IMVP. |
| schedule | The schedule defines when a campaign is set to be delivered. The |
| | schedule can be defined by, for example, the day, the week, the time |
| | and the time zone, etc. |
| SMPP (short | SMPP (short message peer to peer) protocol is an open industry |
| message peer to | standard SMSC access protocol that defines the external interface |
| peer) | between external entities, such as internet applications, and a mobile |
| | network SMSC. |
| SMS (short message | SMS (Short Message Service) is a service for sending messages of |
| service) | up to 160 characters (224 characters if using a 5-bit mode) to mobile |
| | phones that use Global System for Mobile (GSM) communication. |
| SMSC (short | The Short Message Service is a store and forward service where |
| message service | short messages are not sent directly from sender to recipient, but |
| center) | always via an SMSC (SMS center) instead. |
| SMTP (simple mail | SMTP (simple mail transfer protocol) is the protocol (or standard) |
| transfer protocol) | by which email is delivered on the internet. |
| supplier information | The supplier information for an item is entered by the user when |
| | added within the commerce managing applications of IMVP. |
| target reach | The target reach is the total number of consumer users that fit the |
| | targeting criteria selected. |
| text messages | Text Messages, such as through SMS, are a method for sending |
| | messages to wireless devices like mobile phones. |
| TCP/IP | TCP/IP is the layer 3 and layer 4 OSI protocols defining networking |
| | communications over the Internet, connecting a number different |
| | networks designed by different vendors into the network of |
| | networks known as the Internet. |
| treasure hunt | A treasure hunt is a type of campaign that can be defined by sending |
| | consumer users hints of where items can be found and then |
| | providing them further clues once the appropriate responses are |
| | received. |
| user login type | User logins allow each brand entity user, or consumer user, to be |
| | assigned a unique user login identification and password. Based on |
| | an id, the brand entity user, or consumer user, will only be shown |
| | the modules and information within the system that their id/group |
| | has been defined for. |
| web registration | Web registration can enable consumer users to register to receive |
| | mobile marketing messages on their favorite platforms, such as |
| | radio stations, or wireless devices. Based on their responses, highly |
| | targeted information can be pushed to the consumer user. |

Targeting engine 544 is the core processing engine that processes and maintains the creatives and campaigns. In one or more embodiments, targeting engine 544 has three basic functions, namely (i) builds a prioritized queue of campaigns and creatives from an internal database or database 542, (ii) in response to requests from brand entity users, returns queued questions to the brand entity users, and (iii) identifies consumer users and consumer user records (for example, specific to questions asked of consumer users) seen by and responded to by consumer users. The user identification can be performed in any manner, including by the use mobile identifiers (for example, GUIDs) in the case of wireless mobile phones, or other unique identifiers. Targeting engine 544 will enable brand entities to base campaigns on, for example, limit exposure, time basing, type basing (as defined below) and to log the results. Additional functions are noted below.

Targeting engine 544 can base the campaigns and creatives on numerous criteria, or filtering parameters. This type of “targeting” can be performed based any criteria or filters envisioned by skilled persons. Table 4 provides an exemplary set of such filtering criteria, referred to as “targeting types.”

TABLE 4

| TARGET- | |
|---|---|
| ING | |
| TYPES | DEFINITION |
| By brand | The brand entities desiring information about existing and |
| entities | potential consumer users. Examples of brand entities |
| | include broadcasters (and stations within the broadcaster |
| | entities), company advertisers (and ad agencies serving |
| | them, or particular business units within them), corporate |
| | sponsors (including ad agencies serving them, or particular |
| | business units within them) |
| Geography | The geographical location of the user, or the user's buying |
| | habits, including country, city, town, locale. |
| Sub-entity | The format of sub-entities within the brand entities. An |
| Format | example is the stations making up a particular broadcaster. |
| Demo- | The measurement of demographic data to permit population |
| graphic | segmentation, including by age, gender, income and |
| options | location. |
| Psycho- | The measurement of psychological characteristics from the |
| graphic | user to allow for segmentation of the population. Examples |
| options | include retrieving information on lifestyle, purchasing |
| | behavior, attitudes. |
| User's | The profile of information about the user. |
| profile | |
| Previous | The previous responses provided by the user. |
| response | |
| Day of | The frame or period of time, including the session, the time, |
| week/time/ | the date, the week, the month, the year. |
| day | |
| Time Zones, | The time zone and location within the time zone of the |
| Location | users. |

In one or more embodiments, the function performed by targeting engine 544 is to determine the campaigns and creatives to be sent for a specific time period (for example, a session, or a day) in a prioritized manner, based on system parameters and the parameters of brand entities. In one or more embodiments, the function of targeting engine 544 is to select the appropriate targeted consumers based on the person's preferred time frame (i.e., year, month, day, time of day).

In one or more embodiments, the function of targeting engine 544 is to perform a number of functions upon its daily activation. For example, one daily function is retrieving all details concerning campaigns and creatives for a given day and respective details regarding target consumers (including for example a user's mobile number, GUID or time preference for interaction).

In one or more embodiments, the function of targeting engine 544 is to apply one or more rules to the campaigns and creatives, as described above. For example, one creative within a given campaign may spark another creative to be exchanged with the user, which is part of the initial campaign.

In one or more embodiments, the function of targeting engine 544 is checking whether there is the above-noted limited exposure. Limited exposure refers to limiting the exposure of a given campaign. For example, the maximum number of exposures for a campaign, during a defined time period (for example, 3 days) can be a limited exposure. Limited Exposure can be configured by, for example, the campaign, any content (including the content of creatives) or by brand entities. For example, targeting engine 544 can limit exposures of certain content for each particular given user or group of users using device 554 over a specified period of time. Examples of “periods of time” include the session, day, week, month, and life cycle of a creative or campaign.

One example of exposures is the maximum number of user impressions. Another example of exposures is the number of send outs, which refers to the content or creative sent out to the user. Impression refers to the opportunity to see, opportunity to see (OTS), which is when the user is given the opportunity to view the impression. Other examples of limit exposure include targeting engine 544 limiting exposures of a given campaign, or a given brand entity, for a given user or group of users using devices 554 over a specified period of time.

The term “impression” is an ecommerce term. The skilled person will have a very strong understanding of ecommerce, and numerous ecommerce terms and concepts are employed throughout the specification. Table 2 provides a partial listing of ecommerce terms, for convenience, and not by way of limiting the features and functions of the specification.

TABLE 5

| ECOMMERCE | |
|---|---|
| TERMS | DESCRIPTION |
| Banner | Banner is a rectangular graphic element used for advertising on a web |
| | page, which encourages a Click-through by a user entity or other user. |
| Click-streams | Click-stream is an electronic path a user entity or other user follows |
| | during navigation between pages within a website, or between different |
| | web sites, which can be measured to determine advertising revenues. |
| Click-through | Click-Through is the clicking on an advertisement on a web page (for |
| | example, a banner ad) to link to the advertiser's web page or website. |
| | Click-through are one way to measure advertising revenues. |
| Click-Through | Click-Through Rate (CTR) is the rate of click-throughs, or advertisement |
| Rate (CTR) | response rate, usually calculated by dividing the number of click- |
| | throughs that an ad has received by the number of impressions, and |
| | multiplying by 100 to get a percentage. |
| Cost Per Action | Cost Per Action (CPA) refers to the cost to an advertiser for every |
| (CPA) | particular action, taken by user entities or other users, in response to an |
| | advertisement. The action can be a full sale, a sales lead, every time a |
| | potential customer submits certain information, the successful download |
| | of a software program, etc. |
| Cost Per Click | Cost Per Click (CPC) refers to the cost to an advertiser for every link |
| (CPC) | from an advertisement (for example, banner ad) to the advertiser's web |
| | page or website. |
| Cost Per Sale | Cost Per Sale (CPS) is the price paid by an advertiser to another site for |
| (CPS) | each sale that resulting from a visitor referred from the site to the |
| | advertiser's site. One way of tracking CPS is via cookies, applications |
| | stored on the user's computer. |
| Cost Per | Cost Per Thousand (CPM, using Roman numeral notation) refers to the |
| Thousand (CPM) | cost to an advertiser for every 1,000 impressions provided to his or her |
| | advertisement (for example, banner ad) on another site. |
| Demographics | Demographics refers to the measurement of demographic data to permit |
| | population segmentation, include by age, gender, income and location. |
| GIF | GIF is the most common compression format for banner advertisements |
| | and most others. Animated GIF is an animation created by combining |
| | multiple GIF images into one file, which is displayed to resemble |
| | movement. |
| Gross Exposures | Gross Exposures/Gross Impressions: The total number of times an ad is |
| or Gross | shown, including duplicate showings to the same person. |
| Impressions | |
| Hits | Hits refers to: Every time a file is sent by a server, be it text, graphic, |
| | video and so on, it is recorded as a hit. Not a reliable gauge to compare |
| | different sites, as one page with five graphic elements will register six |
| | hits when viewed, while a page with no graphics will only register one |
| | hit. |
| Impression | Impression refers to the Opportunity To See (OTS) of an advertisement. |
| Inventory | Inventory refers to the amount of available space for banners on a web |
| | site that can be delivered in a given time period. It is also used to refer to |
| | the number of gross impressions per month, or clicks if the CPC model is |
| | used. |
| Opportunity-To- | Opportunity To See (OTS) is when the user is given the opportunity to |
| See (OTS) | view the impression. Although a Page-View is an OTS, an impression is |
| | not so, because the advertisement can be located at the bottom of the web |
| | page, which will not be seen unless the user scrolls down. |
| Page-View | Page-View is when a user uses his or her browser to requests a web page, |
| | which is often used for tracking of impressions. |
| Popup Window | Pop-Up Windows are web pages that pop up between the user and what |
| (or Interstitial | the viewer is viewing or expecting to view. |
| advertisement) | |
| Psychographics | Psychographics refers to measurement of psychological characteristics |
| | from users to allow for segmentation of the population. Examples |
| | include retrieving information on lifestyle, purchasing behavior, |
| | attitudes. |
| Pull | Pull refers to any technology or tools that are available to the user |
| | passively, meaning that they must visit the website and retrieve the |
| | information for themselves. |
| Push | Push refers to any technology or tools that deliver information to a user |
| | or other user, for example at their browser. |
| Reach | Reach is the total number of users who will see an advertisement. |
| Sell-Through Rate | Sell-Through Rate is the percentage of advertisements sold, not bartered |
| | or traded through an advertisement network. |
| Session | Session refers to a full web site visit by a user entity or other user. |
| Sponsorship | Sponsorship is an online marketing program between a website publisher |
| | and an online advertiser designed to create the appearance that there is a |
| | close connection between the two companies. Instead of simple |
| | advertisement banner displays, a campaign can be created to blur the |
| | distinction between editorial content and promotion. In one or more |
| | embodiments, a user entity or a third party can sponsor web pages on the |
| | system to provide advertising for themselves, and to provide fees for the |
| | proprietors of the system, third parties, or other user entities. |
| Traffic | Traffic refers to the number (and possibly types) of user entities or users |
| | visiting the site. |

In one embodiment, the function of targeting engine 544 is to prioritize the creatives and campaigns on relevant parameters, as for example, the start date of the campaign, the end date of the campaign, and the impressions. Exemplary impression types upon which priority is based include the total number of impressions, the total number of impressions actually served, and the total number of impressions that were not served. Prioritization can also be based on system level parameters, including the amount of revenue generated from, for example, the consumer users, groups of consumer users, the types of products, and various other targeting types, such as the user's geographical area, demographics, psychographics, previous responses, or other targeting types. In one or more embodiments, the function of targeting engine 544 is to send a prioritized creative to a database for targeted campaign users.

In one or more embodiments, the function of targeting engine 544 is to insert in the database 542 or an internal database the list of all targeted users for each given campaign. A flag can be registered, for example, to indicate that a message has been “pulled” by the target engine, or that a message has been “pulled” by a user.

The skilled person will understand the difference between “pull” marketing and “push” marketing. The term “pull” refers to any marketing technology or tools that are available to the user passively, meaning that users must, for example, visit a website and retrieve the information for themselves, or place a phone call to interact. For example, in a pull campaign, the campaign is initiated by a user, himself or herself, responding to information within a promotional campaign, such as a billboard, a radio advertisement, a can of soda with bearing a company's logo.

On the other hand, “push” refers to any technology or tools that deliver information to a user, himself or herself, for example information delivered to a user's web browser, or an SMS message delivered to a user's cell phone, or an MMS message delivered to a user's multimedia device, or an e-mail delivered to such multimedia device. In other words, in a push campaign, the campaign that is initiated within the system and is pushed to the user. In one or other more embodiments, the function of targeting engine 544 is to deliver push messages and record responses of users to such push messages.

In one or more embodiments, the function of targeting engine 544 is to generate an identification regarding the user. Any types of identification can be used. Examples of user identification include the GUID of a user's mobile phone, the telephone number of the mobile phone or home phone, or the TCP/IP address of the user's personal computer. In one or more embodiments, the user's identification is linked to the relevant creative or campaign, to create a user-creative or user-campaign combination. Such identification can aid the targeting engine to categorize and identify the user when a response is received from the user.

In one or more embodiments, the function of targeting engine 544 is to target consumer users across different platforms. As used herein, the term “platforms” must be construed broadly, to include any type of vehicles, outlets, or platforms for technology (including any of the technologies mentioned with respect to the foregoing FIGS. 1-4, including without limitation, different transport mediums, protocols, processors, instances of processes, clients and servers), campaigns (as defined herein), informational content exchange (as defined herein) and marketing vehicles known or conceptualized by skilled persons.

As noted, delivery engine 546 comprises three components, namely message scheduler 548, delivery manager 550 and response manager 552.

Beginning with message scheduler 548, in one or more embodiments, it has the following functions: (i) manages the campaign scheduling process and determines when to deliver a campaign; (ii) determine which consumer users are eligible for the scheduled campaigns by querying the database 542 (or an internal database) to ensuring that a consumer user does not receive more campaigns than such consumer user has elected to receive in a given time period (for example, by default, message scheduler 548 can perform this action once per day, usually during off-peak hours); (iii) for each eligible consumer user, supplying a user identification (for example, a GUID) to targeting engine 544 and request the appropriate number of push messages to be sent to such user; (iv) storing information pertaining to the consumer user, such as the consumer user's identification, in local push files to be used by the delivery manager 550; (v) repeating the above-noted process until the end of the consumer users in database 542 is reached.

Three other features and functions of the message scheduler 548, comprising three embodiments, related to (i) user-specific message times, (ii) maximum messages per day and opting in/opting out, and (iii) fault tolerance.

With respect to (i), user-specific message times, this refers to the brand entity and the user having the ability to specify what day(s) and time(s) (or other time frames) a particular user can receive push messages. Message scheduler 548, along with delivery manager 550 sends messages only during the specified times.

Maximum messages per day and opting in/opting out refers to the fact that the message scheduler will schedule only the specified maximum number of messages for each user per day (or other time period). If the user has not opted-in or has decided to opt-out, this maximum number is set to zero.

Fault tolerance refers to the fact that the message scheduler 548 can “lock” the push file until it has finished processing the entire user database. This ensures that the delivery manager 550 does not begin to send messages before the message scheduler 548 has finished its tasks. This also ensures that if the message scheduler 548 component fails, another instance of the component will process the user database as if the failed instance never existed.

Another component of the delivery engine 546 is the delivery manager 550. In one or more embodiments, delivery manager 550 has the following functions: (i) continually monitoring a specified location for push files to be created and “unlocked” by the message scheduler 548, which files may be stored locally or in a location that is network accessible; (ii) once a new push file is detected, processing the push file for messages to be sent; (iii) at the appropriate time, delivering each message via the appropriate delivery mechanism (examples include SMS or email), wherein the delivery mechanism is read from the push files along with the other information that message scheduler 548 has written; (iv) updating push files to indicate the message has been sent. Once all push messages have been sent, delivery manager 550 can delete the push file created by message scheduler 548, which ensures that another delivery manager instance does not send duplicate messages. Messages that cannot be sent within the specified timeframe, for example, are not sent and are marked as undeliverable. The delivery manager can maintain statistics for undeliverable messages and error types.

Addition key features and functions of delivery manager 550 include (i) multiple delivery mechanisms and (ii) fault tolerance. Multiple delivery mechanisms refers to the fact that for delivery of push messages, the delivery manager can support multiple delivery mechanisms. For example, SMS is used for devices 554 that support SMS, but another delivery mechanism, such as for example e-mail, is used for devices that do not support SMS. Other examples of delivery mechanisms include WAP Alerts, voice alerts, EMS, and MMS, in addition to any other mechanisms known or envisioned by skilled persons.

Fault tolerance refers to the fact that the delivery manager 550 can read, write, and lock files following a process that ensures that the sent message history cannot be lost, even if the delivery manager 550 fails. This can enable other instances of delivery manager 550 to continue sending messages without duplication from where the failed instance left off.

Another component of the delivery engine 546 is the response manager 552. In one or more embodiments, response manager 552 manages users' requests to accept a push message. Response manager 552 can perform the following tasks, among other tasks known to skilled persons: (i) when a user responds to a push message (for example, via an SMS message, or email message, etc.), response manager 552 records the acceptance of the message; and (ii) response manager 552 can accept requests from users depending upon the presence of particular flags, variables, or parameters. For example, if a parameter called a “list” parameter is present in the received request from a user, the response manager 552 sends only messages corresponding to the list, but if the parameter is not provided, response manager 552 sends all accepted messages from the user.

C. Push Campaigns Embodiment

As illustrated, the targeting engine 544 and delivery engine 546 together can provide brand entity user full technology manifested push marketing capability. Together, these systems can provide brand entity users the features and functionality to support any type of effective push campaigns. As noted, a wide variety of targeting vehicles, called information content exchange, can be performed between the consumer users and the inventive system.

In one or more embodiments, the brand entities have a single type of user interface screen, capable of setting up all types of different push campaigns, with the type of content entered being used to determine the type of campaign that is being sent to the user.

Exemplary push model campaigns that targeting engine 544 can process, and delivery engine 552 can deliver (and receive), over any type of media, include: (i) target based: campaign criteria dictate the users that will be targeted; for example, a marketer may wish to target users that are in a certain age range and use SMS at least ten times per day; (ii) schedule based: push messages are delivered at times the broadcaster or the marketers specify; for example, a broadcaster, on behalf of a restaurant chain, may send the daily lunch specials Monday through Friday at 11:00 am for the restaurant's regular advertisers; (iii) answer based: push messages are delivered and responses accepted for a contest campaign until the desired number of users have won the campaign; and (iv) time based: push messages may be sent only during time intervals that the user has previously specified; for example, the user may specify that he would like to receive promotions for a given shopping center only on the weekends; (v) any combination of the foregoing models as the brand entity deems fit; for example, a push campaign may be target-based (e.g., users that are female and are between ages of 13 and 19) as well as time-based (e.g., 2 pm to 5 pm during the weekdays and 11 am to 7 pm during the weekends).

Additionally, delivery engine 546 supports standalone campaign messages as well as campaign messages that are appended to other content messages such as market-driven stock alerts or scheduled weather reports.

Brand entity users have full management capability. A brand entity user can, for example, list active and inactive push campaigns, update a push campaign, or delete a push campaign. In one embodiment, if a brand entity user selects to delete campaigns or questions that are already active (or have previously been launched), the campaigns and questions will not actually be deleted from the system, but instead be marked “inactive,” enabling the system to produce reports for campaigns and questions that are no longer used. In one or more embodiments, for push campaigns delivery engine 546 supports variable data storage, fault tolerance, and high performance.

Regarding data storage, delivery engine 546 components can utilize the same database 542 resources as the rest of the system, or additional database tables are created to record consumer users' accepted messages. Delivery engine 546 components can use a local file system to store transactional information while processing a push campaign. For example, the message scheduler 548 can store the push message content, target consumer users, and push a schedule in a local file that delivery manager 550 reads and updates as it pushes the messages via the delivery mechanism.

Regarding fault tolerance, delivery engine 546 is designed to be highly robust and fault-tolerant. Each component of delivery engine 546 can read and write push campaign data to the database and file system in a transactional manner. If a delivery engine process goes down or is halted for any reason, other instances of the process can take over where the failed process left off. The transactional file processing assures that all push messages are sent per campaign criteria and that users do not receive redundant messages due to failed processes.

Regarding high performance, techniques known to skilled artisans can be used to increase performance, including load balancing, traffic management, expanded throughput techniques, and quality of service manipulations.

D. Second Embodiment

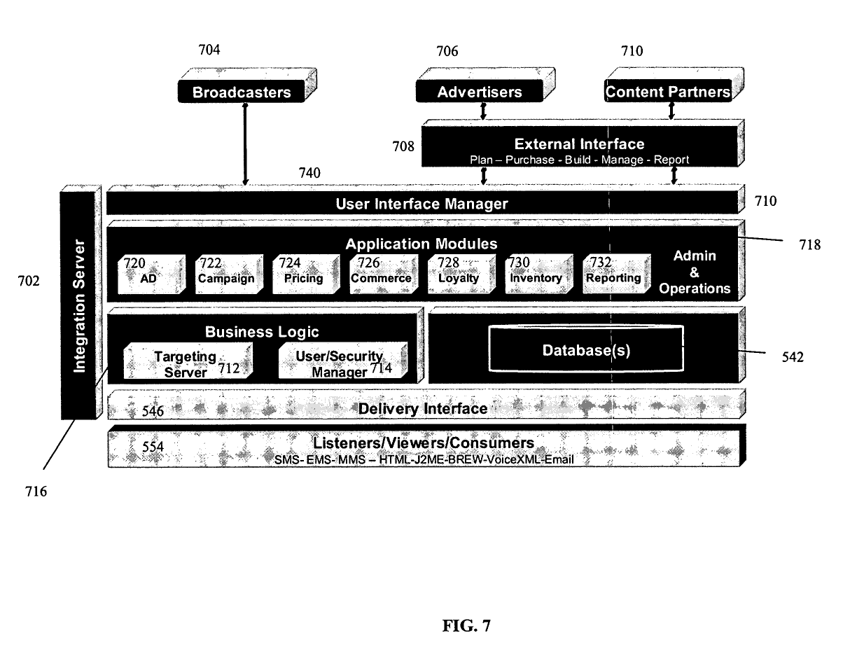

FIG. 6 illustrates a second system level embodiment of the present invention. Included in FIG. 6 are response manager (engine) 552, database 542, targeting engine 544, creative targeted users database 608, message scheduler 548, delivery queue 606, consumer interaction device 554, gateway 602, gateway interface 604, delivery manager (engine) 550 and database update process 610.

First, it should be noted that the elements of FIG. 6 labeled the same as elements in FIG. 5 have the same respective features and functions, with any additional features and functions described with respect to FIG. 6. The following is a summarized view of the features of functions of this embodiment, leaving out substantial details of features and functions described with respect to FIG. 5.

In one or more embodiments, delivery engine 546 is illustrated as comprising response manager 552, delivery manager 550 and message scheduler 548, the same as in FIG. 5, with additional components of the gateway interface 604 and delivery queue 606.

In one or more embodiments, database 542 stores the details about users, campaigns and creatives. Each creative will be mapped to the users through respective target details.

In one or more embodiments, and as noted, targeting engine 544 is the core processor of the system which basically determines the campaigns and creatives to be sent for a specific day in a prioritized manner. It also selects the appropriate targeted users based on their preferred day and time. In one or more embodiments, during daily activation, targeting engine 544 performs these functions: (i) retrieves all active campaign-creative details for the day and respective target consumer user details, (ii) checks for limited exposure, (iii) prioritizes the creatives based on campaign start date, end date, total impressions, including both served impressions and un-served impressions, (iv) prioritizes based on system level parameters like revenue, inserts the database with the list of all targeted users for each campaign, and sets a flag indicating the message has been pulled by the target engine, (v) generates a user identification (for example GUID) for identifying each user-creative combination (to identify the user when a response is received), and (vi) sends the prioritized creative to a campaign targeted user database.

In one or more embodiments, message scheduler 548 will run every preset period of (for example, every 30 seconds), reads creatives from the creative targeted consumer user database 608 and posts batch messages in to delivery queue 606 based on the user preferred time. The schedule mechanism includes (i) reading the first creative in the database, and checking if the creative is valid for the current time, and (ii) if the creative is valid, selecting all the users who have opted for the current time as preferred time.

In one or more embodiments, delivery message queue 606 is the queue of messages which needs to be pushed to the delivery engine.

In one or more embodiments, delivery manager 550 reads each message from delivery message queue 606 and sends them to the gateway interface 604. It performs gateway level optimization which is optimization of the message for superior gateway performance. Depending upon the type of gateways and format in which the messages are received, delivery manager 550 will create appropriate messages, including bulk or individual messages. Delivery engine 550 can use a mechanism for switching between different gateways, so that if one gateway fails, the delivery engine has to deliver the messages to the users through the other gateway. All database updates will be posted to the database 542 update queue. Thus both successes and failure will be updated to database 542.

In one or more embodiments, response manager 552 reads the user responses. It identifies the user identification (for example, GUID) on the response message body and calls the target engine 544 so that the next linked creative can be trigged.

In one or more embodiments, creative targeted consumer user database 608 stores all creative targeted users list in the order defined by the priority. For fast retrieval, a code base database can be used for this storage.

In one or more embodiments, database update process 610 can run as a background process, which will read from the creative user database 608 and update database 542 accordingly, justifying whether the message was successfully delivered (“sent”) or not deliverd (“not sent”). The update can run as a separate process, to not hinder the performance of the delivery engine 546.

E. Third Embodiment

FIG. 7 illustrates a third system level embodiment of the present invention. Included in FIG. 6 are integration server 702, listeners/viewers/consumers 554, delivery interface 546, business logic 716 (including targeting server 712 and user/security manager 714), database 542, application modules 718 (including ad module 720, campaign module 722, pricing module 724, commerce module 726, loyalty module 728, inventory module 730, and reporting module 732), user interface 710, external interface 708, broadcasters 704, advertisers 706 and content partners 710. As used in this embodiment, the term “user” refers to a brand entity user.

FIG. 7 illustrates a more detailed view of the aforementioned features and functions with respect to FIG. 6. It should be noted that the elements of FIG. 7 labeled the same as elements in FIG. 6 have the same respective features and functions, with any additional features and functions described herein with respect to FIG. 7.

In particular, in one or more embodiments, (i) the aforementioned functions of the targeting engine 544 are performed by business logic 716 and application modules 718; (ii) the aforementioned functions of delivery engine 546 (or alternatively, the combination of response engine 552, delivery engine 550, message scheduler 548, delivery queue 606, and gateway interface 604) are performed by delivery interface 546; (iii) the aforementioned functions of the consumer interaction device 554 are performed by listeners/viewers/consumers interface 554; (iv) the aforementioned brand entity users are represented as broadcasters 704, advertisers 706 and content partners 710.

In addition, in one or more embodiments, two new interfaces have been added, namely (i) a standard user interface 740 for brand entity users, providing full access to the system; and (ii) an “external interface” meant for parties having partial access. The distinction is applied in a case where the party interfacing with consumer users, such as a broadcaster (first party brand entity user) has their own customer, such as an advertiser or content partner (third party brand entity user) to whom they desire to grant partial access. In these embodiments, the first party brand entity users are referred to as “first party brand entity users,” “brand entity users,” simply “users,” or simply “broadcasters.” In these embodiments, the third party brand entity users are referred to as “third party brand entity users,” “external brand entity users,” simply “external users,” or “advertisers.”

In addition, in one or more embodiments, a new integration server 702 has been added, acting as an API (application programming interface) to integrate with 3rd party data sources. For example, integration server 702 can use the XML (extensible markup language) standard allowing the IMVP to interface with 3rd party systems, such as accounting, billing and reporting systems.

In addition, in one or more embodiments, a new user/security manager module 714 has been added to business logic 716. In one or more embodiments, all or some of the features and functions of IMVP are controllable through the user/security manager module 714 allowing users to give groups of users the exact privileges they need. For example, each feature allows control for the actions of ‘add’, ‘edit’, ‘view’, and ‘delete’. Users can have access to view things they can't edit, add things they can't delete, etc. according to organizational needs. Each action can be set to system-wide or limited to a module so that each action grants control only where the user has relevance. The user manager module 714 enables broadcasters to manage workflow approvals and notifications. Workflow approvals and notifications can be set for all edit and delete functions.

In one or more embodiments, if a user wants to delete an advertiser from the system, he cannot do so without an approval from a superior (for example, an ad manager administrator), and an email can be sent to the superior with a hyperlink. The superior user must approve the request prior to it being completed. Once the action is either approved or declined the system will be updated and an email will be sent to the user who initiated the action.

Workflow approvals can be determined within the user manager module 714 and are utilized throughout the entire system. In one or more embodiments, features/roles that are required to have workflow approvals will require an approval prior to an update or completion of a task. If a user who accesses any feature that requires an approval has the security permission to approve the specific action/task, no additional approval will be needed. However, In one or more embodiments, a confirmation email will still be sent.

Advertising management module 720 enables brand entity users to manage their own content or the content of external brand entity users. It allows such parties to add, edit and delete external brand entity users from the system. Broadcasters will input and manage the contact information for advertisers from this module. This module allows broadcasters to add/edit/delete external users (advertisers) from the system. Security permissions or rights are set in a user manager module (not shown), allowing the module to be restricted to only those users that have been given access. The default user type or security groups are ad administration and ad user. Broadcasters are able to create detailed profiles of their advertisers.

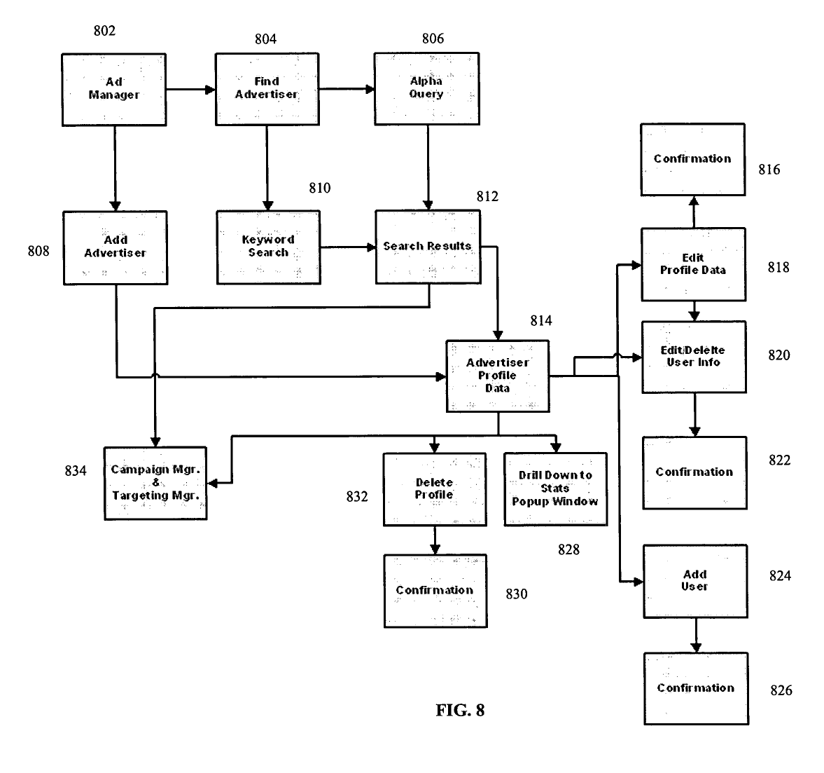

Reference is made to FIG. 8 wherein steps 802-834 illustrate an exemplary flow chart showing the functionality of advertisement module 720 in one or more embodiments of the present invention.

In one or more embodiments, for each advertiser profile, multiple individual contacts may be added. For example, if Coke™ is the advertiser, the primary contact is entered with their telephone number, fax number, mobile number, email and physical address. As part of this advertiser's profile, broadcasters may add unlimited numbers of external users that are grouped within the profile.

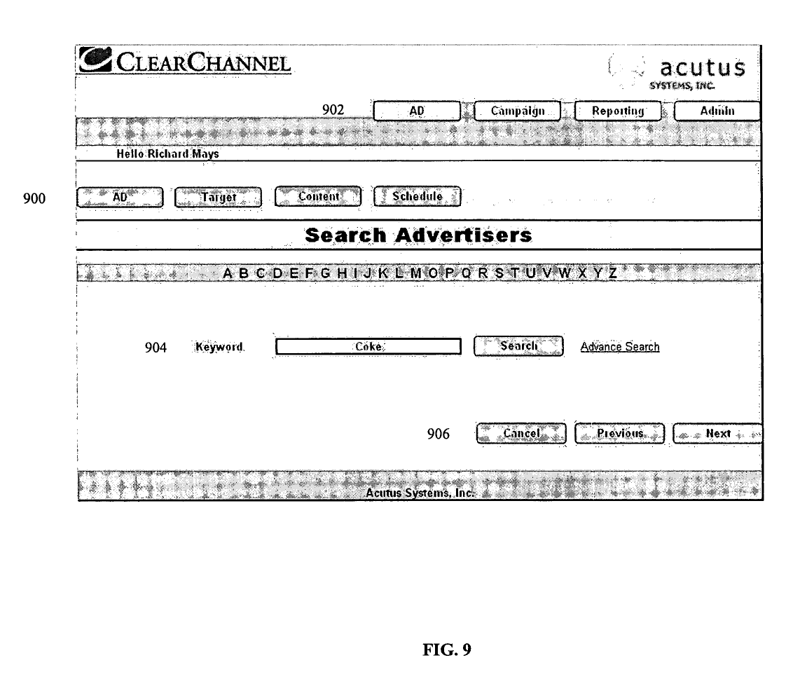

FIG. 9 illustrates a screen shot of the basic brand entity user interface. FIG. 9 includes tabs 902 for management of different advertisers, campaigns, reporting and administration, tabs 900 for management of the relevant advertiser target, content, and schedule, tabs 904 for performing an alpha query or keyword query, and tab 906 for navigation between screens.

Reference is made to FIG. 9 which illustrates the initial functions of this module. The following is an example of a user case scenario: The main/top navigation menu offers users (i.e., the brand entity users, such as broadcasters) two primary options once within the module. The first option is to add a new advertiser and the second is to find an existing advertiser.

The find advertiser function of the module enables broadcasters to quickly find an advertiser. This function is used to view or edit advertiser profiles and to select an advertiser prior to developing a campaign. The find advertiser function provides users with two options to perform: to search an alpha query or fuzzy free form query. Alpha query is defined as when users select the first letter of the advertiser's name. This function quickly retrieves and displays all advertisers beginning with the letter selected by the user. Free form query is when users enter the full name or partial name of an advertiser (example: Pep for Pepsi™ and select Search Now button). This function quickly retrieves and displays all advertisers beginning with the letters entered by the user.

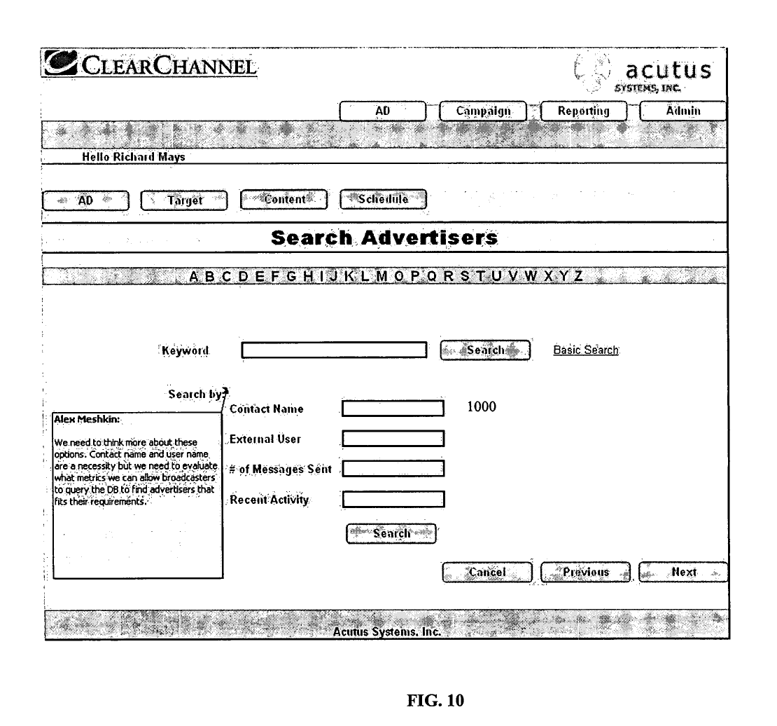

In addition, advanced searching is possible, wherein in addition to entering a name or partial name of an advertiser, broadcasters may enter additional information to narrow a query. In one or more embodiments, this function can be made not available to external users. Advance search enables users to query the database searching for a specific advertiser brand entity user. This feature allows users to add additional parameters to a query such as the contact name at an advertiser, the number of messages an advertiser has sent/purchase in a given time period, and the dollar volume (revenue) in a certain time period. Reference is made to the screen shot of FIG. 10.

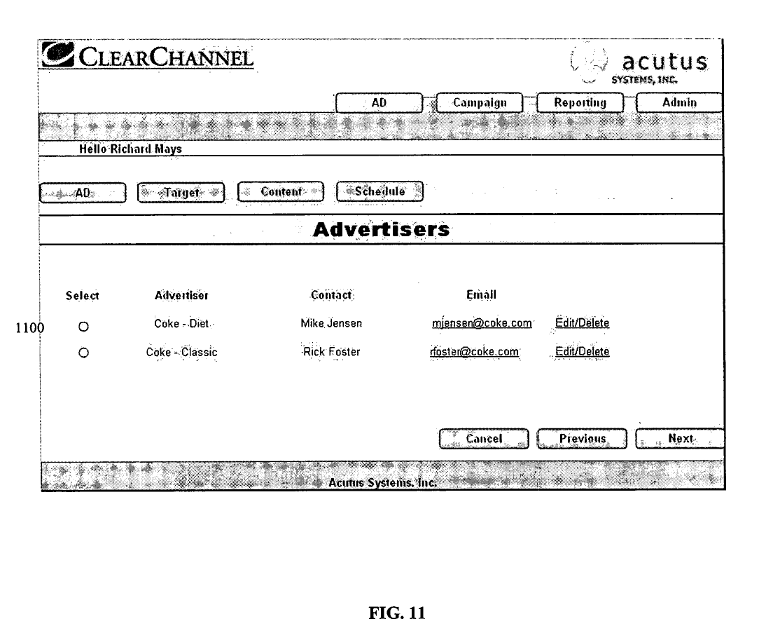

Reference is made to the screen shot of FIG. 11, illustrating the information displayed from the database after performing a basic search. In one or more embodiments, the name of the advertiser, the primary contact and the primary email will be displayed on the search results page. Users may edit or delete advertisers' profiles by clicking on the hyperlink next to each advertiser. The permissions for the edit/delete feature can be set in a user manager module (not shown). Users are capable of selecting an advertiser profile to create a campaign. Users may select an advertiser to create campaigns, edit/delete advertiser's profiles and add/edit external users. The permissions for viewing/editing/deleting advertisers and external users can be set in the user manager module. These features will require workflow based approvals.

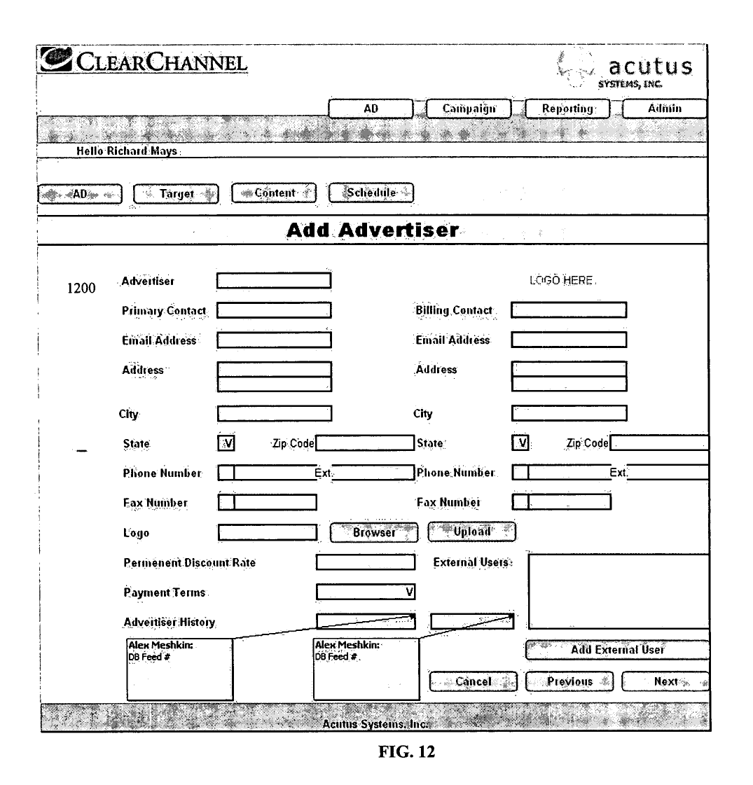

Broadcasters are able to create detailed profiles of their advertisers. Reference is made to the screen shot of FIG. 12, where for each advertiser profile, multiple individual contacts may be added, or selected. For example, if Coke™ is the advertiser, the primary contact is entered and includes their telephone number, fax number, mobile number, email and physical address. As part of this advertiser's profile, broadcasters may add unlimited numbers of external users grouped within the profile. Users are able to input the advertiser's name, their address, the main contact person's name, phone number and email address. These can be required fields that the user must complete in order to continue to the next screen.

In one or more embodiments, the following additional optional features can be provided: (i) users will have an option to upload the advertiser's logo that appears when advertisers access IMVP; the logo may then be displayed on reports generated specifically for the advertiser; (ii) users will also select the payment terms for the advertiser; these payment terms will be determined by each broadcaster; the default options will be net 15, net 30, end of Campaign, and advance (reference is made to Table for definitions); (iii) if a user selects advance, a screen is displayed to accept a credit card number; otherwise a screen appears to enter a purchase order number; there is a default purchase order number that may override the user; (iv) through the administrative interface, broadcasters are able to schedule the automated export of billing data that interfaces with the broadcaster's accounting system; (v) the SMS message rate is the amount the broadcaster is charged when they send an SMS message; the broadcaster is charged this rate whether it is an internal or external campaign; the owner of IMVP or other permitted users can enter the message rate for the broadcaster; this message rate can only be changed by permitted users in one or more embodiments; (vi) the total number of messages sent can be updated automatically when the advertiser's data is being viewed; this can allow the user to determine if a new discount rate needs to be given; this field can be selected and a popup of the statistics will be shown; (vii) the permanent discount rate can be assigned to an advertiser; this discount percentage can be applied to every campaign sent; the value of the discount may be changed by the broadcaster; (viii) the override discount rate can allow the user to override the permanent rate for a specific campaign in one or more embodiments; if the override rate is selected, the perm discount rate can go to 0% and the override rate can then be used for that campaign; once the campaign is sent, all following campaigns will continue to use the original permanent rate; (ix) once all required data is entered, the user has the ability to add external users to the account; by selecting the add user button, users are displayed a page allowing them to add an unlimited amount of external users; as noted, external users can be defined as users that have limited access to IMVP; external users can be given restricted access to add/edit/view campaigns and reports specific for their account; to create an external user, users can input name, address, phone, email and title; (x) in one or more embodiments, one or more tabs (such as field name total messages sent) provides the feature of allowing users to drill-down and view detailed statistics in the form of a graph; (xi) in one or more embodiments, by selecting the next tab, the user is taken to add a campaign for that advertiser.

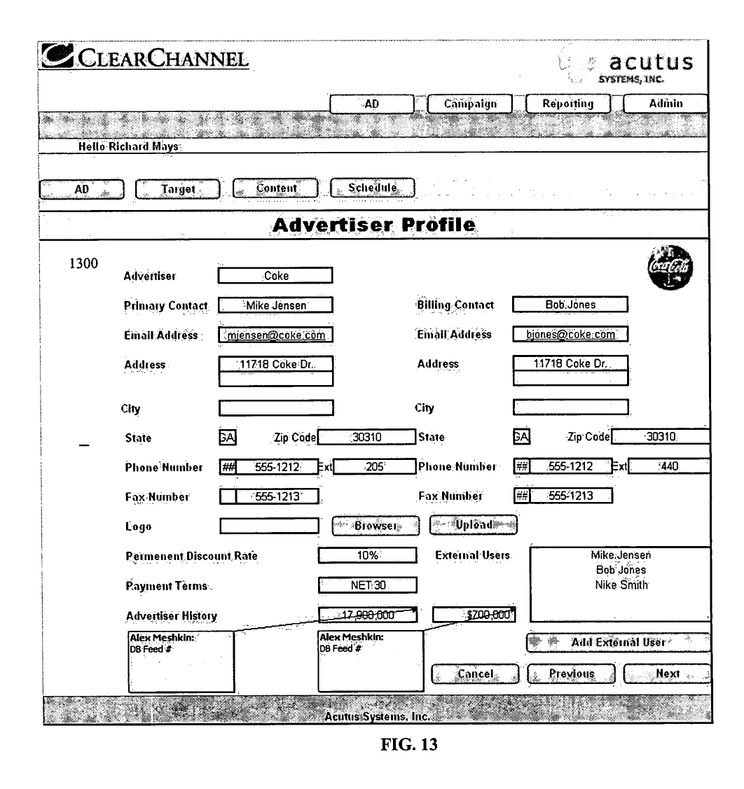

Reference is made to the screen shot of FIG. 13, illustrating the advertiser profile page. In one or more embodiments, the advertiser profile page will be displayed when users click on the advertisers' name from the search results pages. This page can also be displayed when a user selects the edit/delete function.

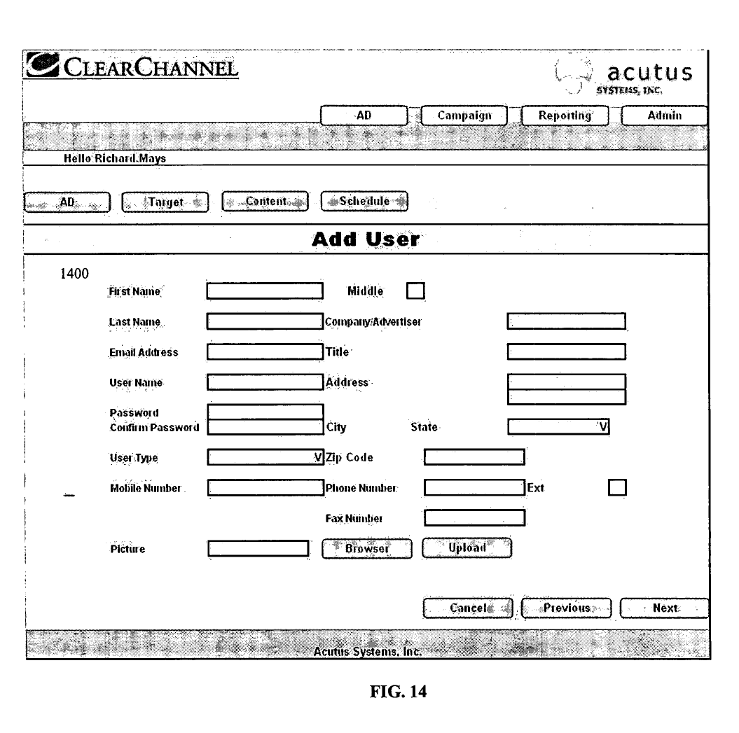

Reference is made to the screen shot of FIG. 14, illustrating the add external user page. In one or more embodiments, broadcasters can add an unlimited amount of external users to each advertiser profile. A user manager module can support the creation of multiple external user groups that are given different privileges.

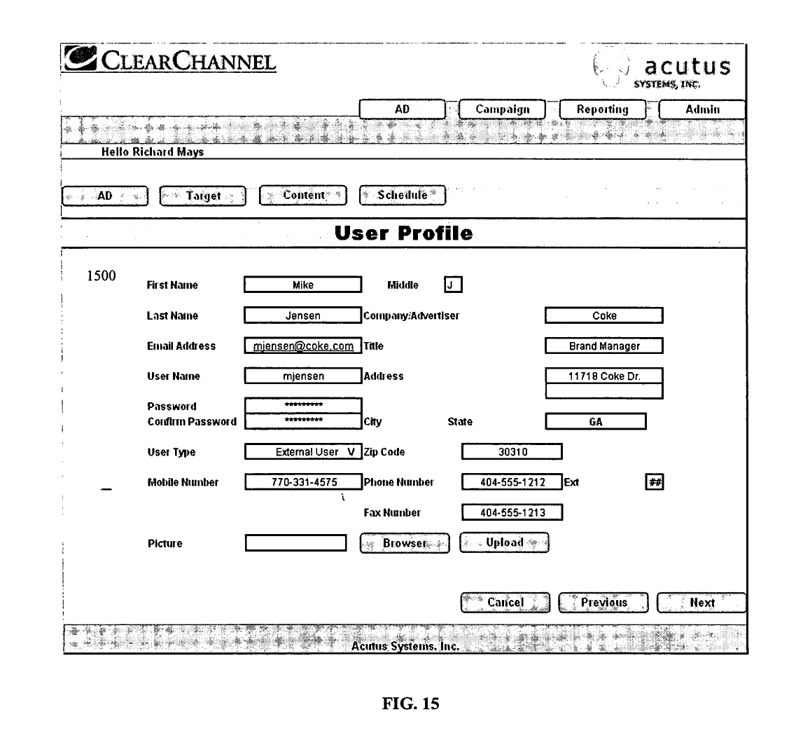

Reference is made to the screen shot of FIG. 15, illustrating the function to edit an external user.

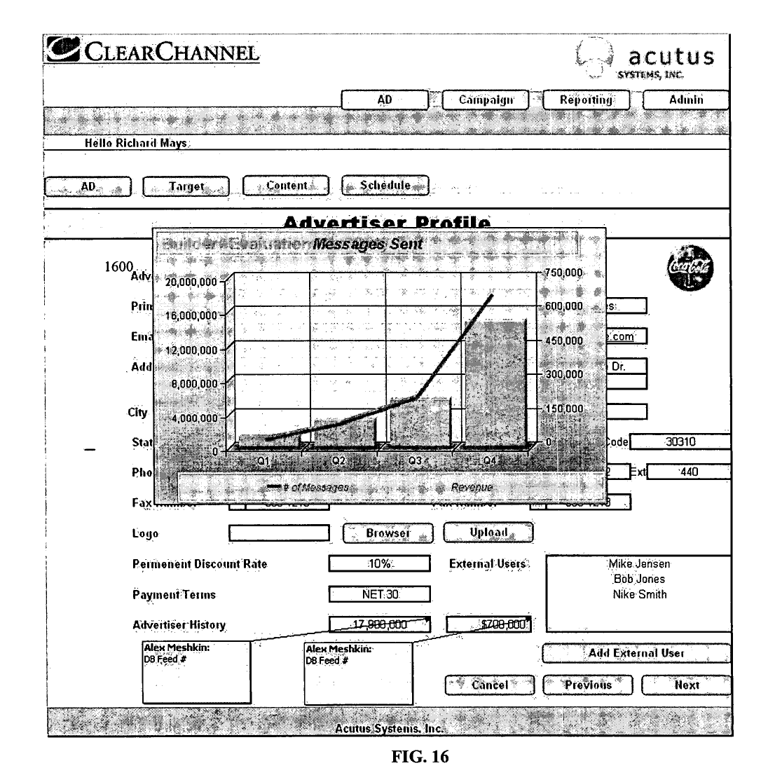

Reference is made to the screen shot of FIG. 16, illustrating an exemplary advertiser history pop-up. In one or more embodiments, when a user clicks on the value in any advertiser history field a window will pop-up with a chart illustrating the data. The chart represents the data in graphical manner with the exactly values in numeric form.

Campaign manager module 722 performs the features and functions with respect to handling of campaigns and creatives. In one or more embodiments, campaign manager module 722 enables broadcasters to design interactive promotions that drive interaction, revenue and loyalty, to name a few examples. The campaign manager module 722 can enable broadcasters to create and schedule interactive promotions/dialogs with the consumer user. Broadcasters can create campaigns for informational content exchange, as defined herein, and any other hybrids or new uses known to skilled persons, that may be sent through or performed on different platforms. Exemplary media for distribution channels include wireless, wired and traditional channels. The campaign manager module allows broadcasters to send, for example, email, SMS, MMS based promotions, and promotions using any of the foregoing technologies described in this written description. Additionally, campaign manager 722 module can support traditional or direct mail, to name a few examples.

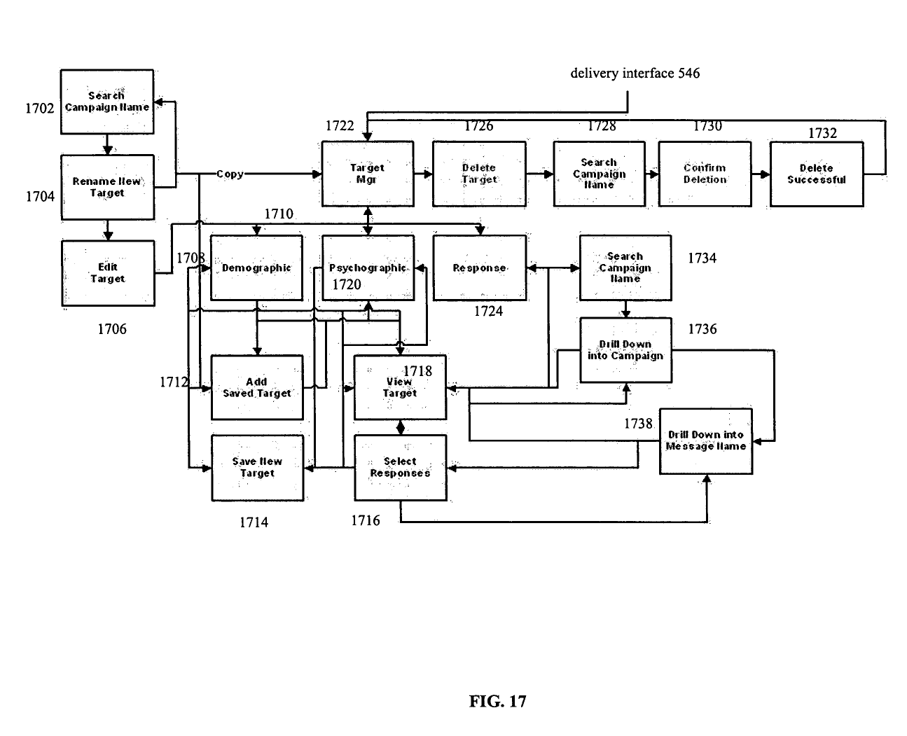

Reference is made to FIG. 17 wherein steps 1702-1738 illustrate an exemplary flow chart showing the functionality of campaign manager module 722 in one or more embodiments of the present invention.

In one or more embodiments, the process to create a campaign begins with the selection of the intended audience. Broadcasters and/or advertisers can target consumer users based upon broadcaster specific information such as a particular station, group of stations, type of station and location of stations (cities).

In addition to targeting consumer user based upon station information, broadcasters and advertisers can target consumer users on demographics (for example, personal profiles). Demographics are defined as information imputed by the consumer user through the web-based registration form.

In one or more embodiments, in addition to targeting consumer users based upon demographics, broadcasters and advertisers may target consumer users on personal interests or psychographics. Similar to demographics, psychographics can be developed by the consumer user answering questions through a registration or opt-in process.

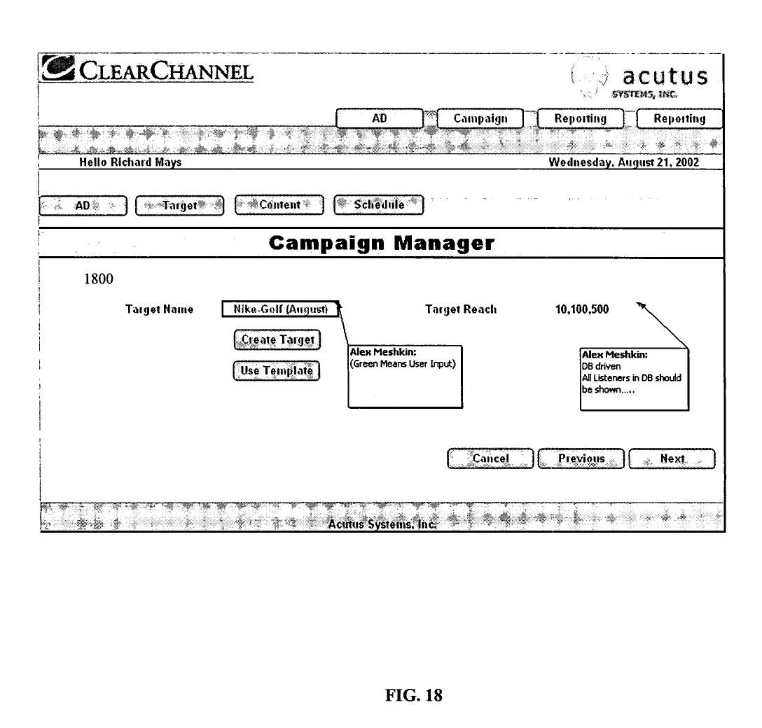

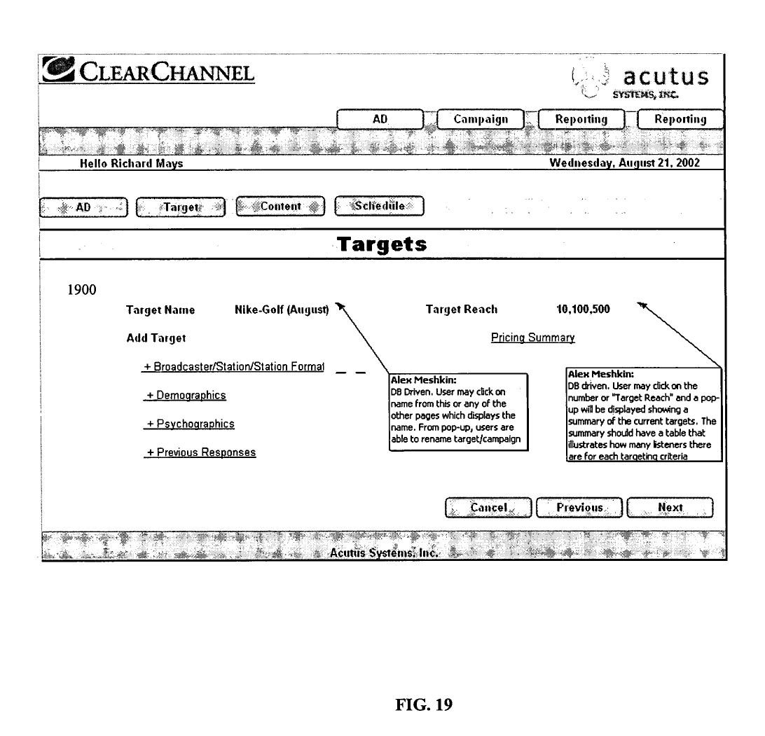

In one or more embodiments, another option is to target consumer users on previous campaign responses. Broadcaster and advertisers can target consumer users on any previous campaign response and/or campaign participation. Reference is made to the screen shots of FIGS. 18, 19, illustrating that the user can select the view target button and get a summary of all targets selected.

In one or more embodiments, the first step the campaign targeting process is to name the target. There are two purposes for naming a target. The first is for reporting requirements and the second is for templates requirements. When creating a new target, users will have the opportunity to use a template or create a new target from scratch. If users select to use an existing template the user can add or delete targeting criteria, but in one or more embodiments, the changes will save to the new target name, the original template will not change. By requiring users to create a new target rather than editing existing targets provides for reporting at the target level in addition to the campaign, message and response levels. Anytime in the future once a target has been created and saved the broadcaster and/or advertiser can use the saved target in a new campaign.

After users name their new target they can select the targeting criteria to add to their target. Targeting criteria can be divided into four groups, namely the aforementioned broadcaster specific, demographics, psychographics, and previous responses. Users can add an unlimited amount of targeting criteria but every time new criteria are added to a target the target reach will get smaller.

In one or more embodiments, a target reach feature is provided. The target reach can display the number of consumer users that can be reached with the defined target. In one or more embodiments, this number does not state the number they will reach, just the number of individuals within the database that match their targeting criteria at that time. This can be used as a good estimate for the advertiser. If the advertiser desires to reach, for example, 1,000,000 consumer users and their targeting only shows 200,000 people, then that would alert the user that they need to limit the number of consumer user reached or remove targeting criteria.

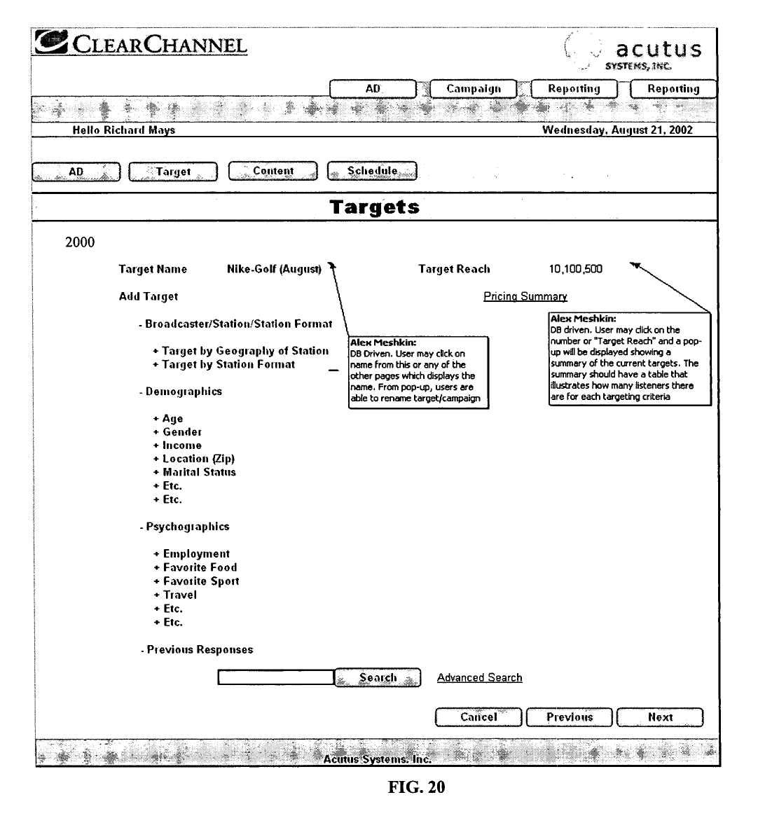

Reference is made to the screen shot of FIG. 20, illustrating that the user can expand the targets. In one or more embodiments, when users click on the + sign the children of the targeting criteria selected will expanded and be displayed. Users can then click on the − sign and the children will then retract and no longer be displayed. Users are able to display an unlimited amount of targets on a single page.

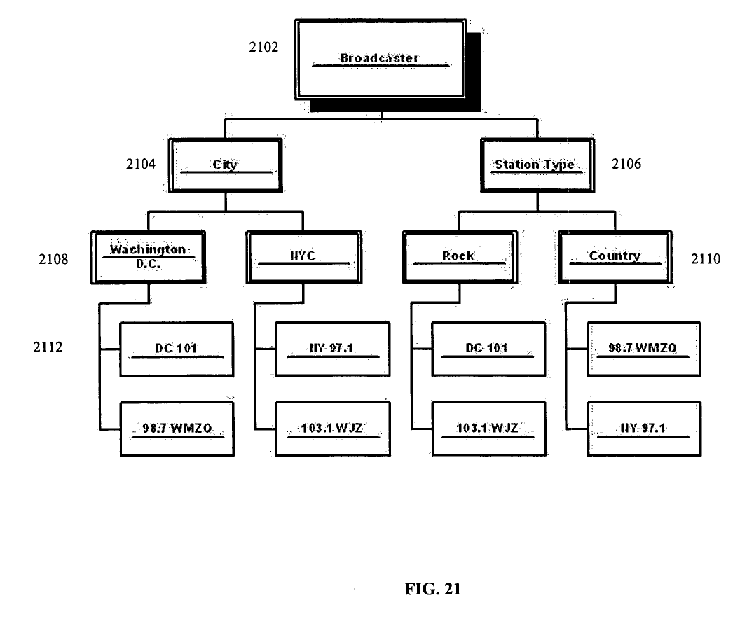

Broadcasters and/or advertisers can select particular station, group of stations, and/or format of station and/or location of stations (cities) to target and segment the audience. The default choice is to target all consumer users in all stations for the broadcasters. Stations will be grouped by city and type but they are all children of the broadcaster. Reference is made to the screen shot of FIG. 21, illustrating the parent broadcaster 2102, its children city 2104 and station type 2106. The children of the city 2104 are cities 2108, whose children are the radio stations 2112. The children of the station type 2106 are music categories 2110, whose children are the radio stations 2112. Since every station is under the broadcaster's umbrella, users can, for example, target consumer users by city (entire areas such as Washington, D.C. or New York, N.Y.), by a particular station, or by a generic station type (for example, rock or country music).

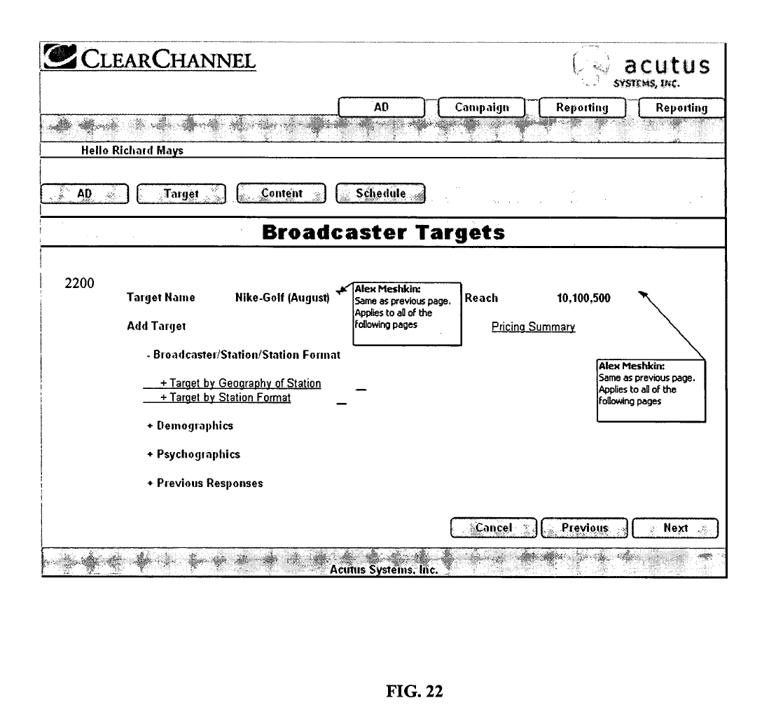

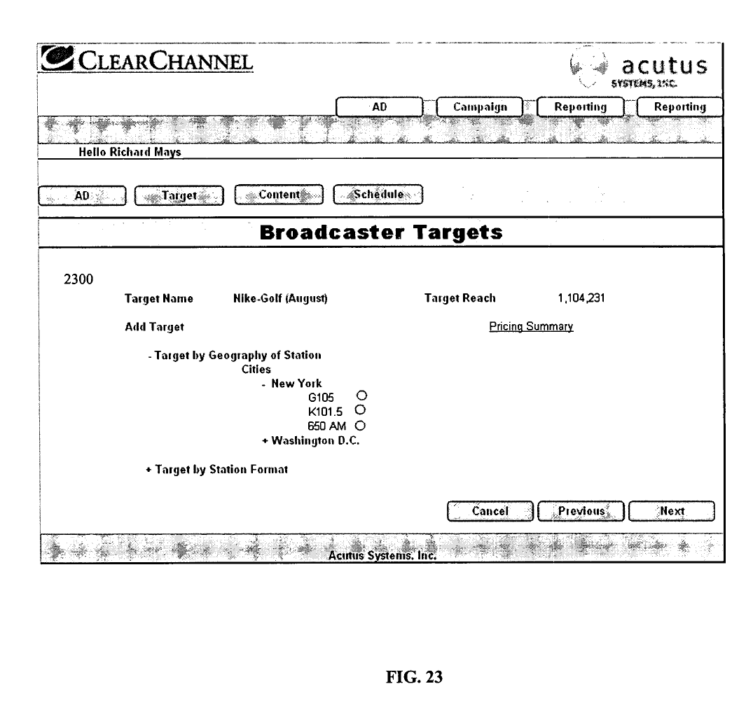

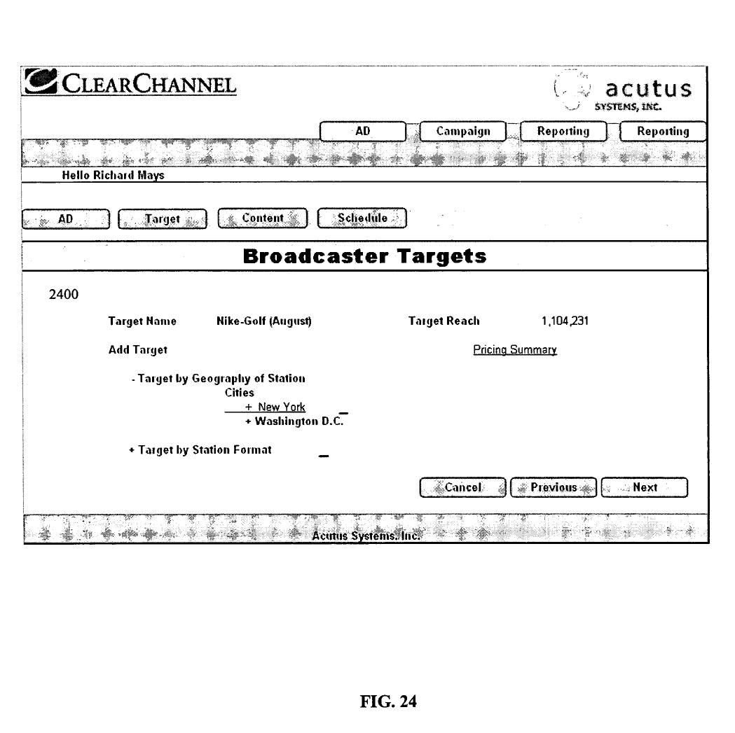

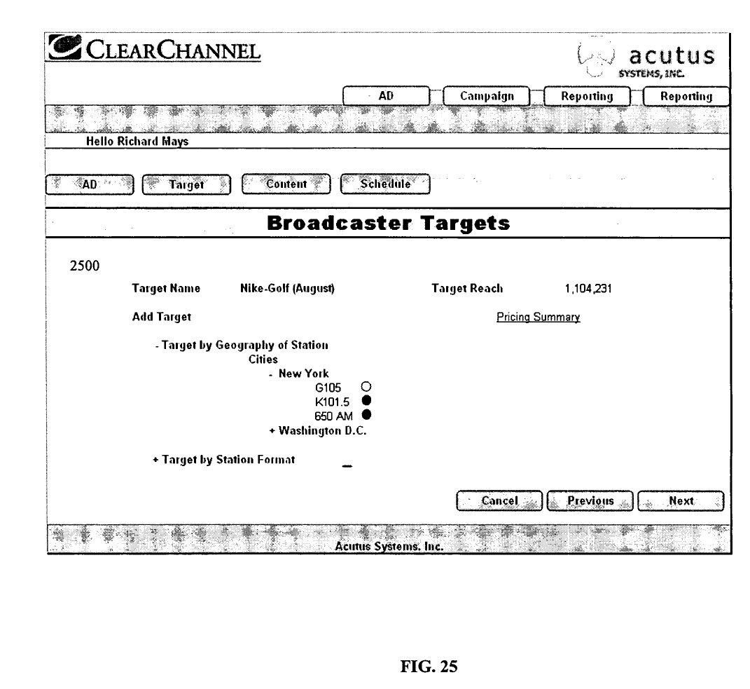

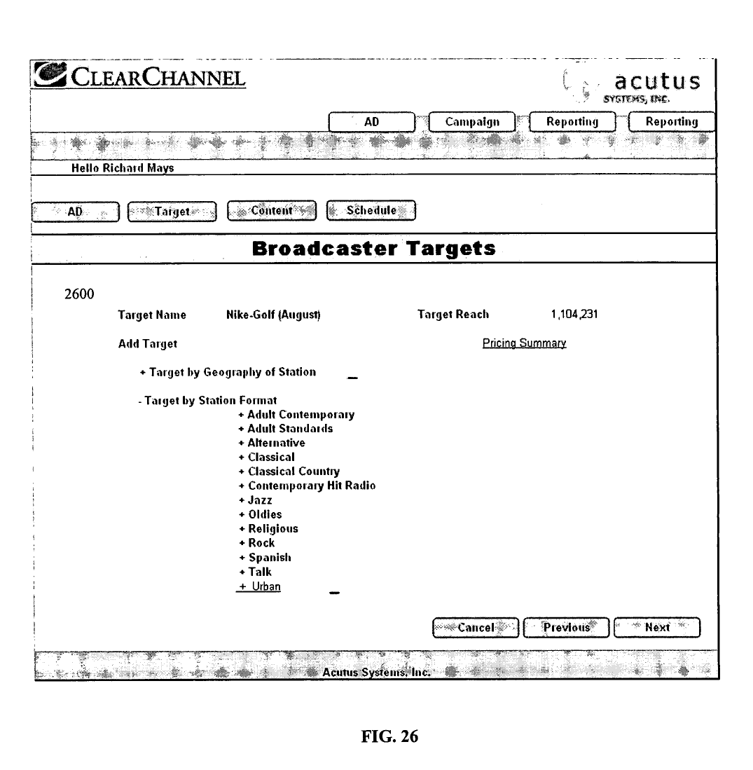

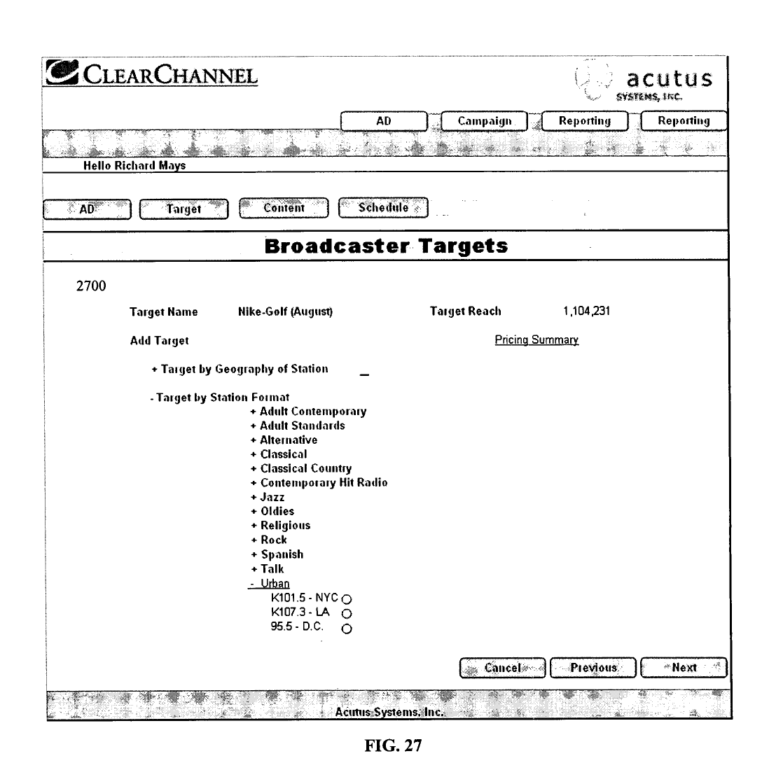

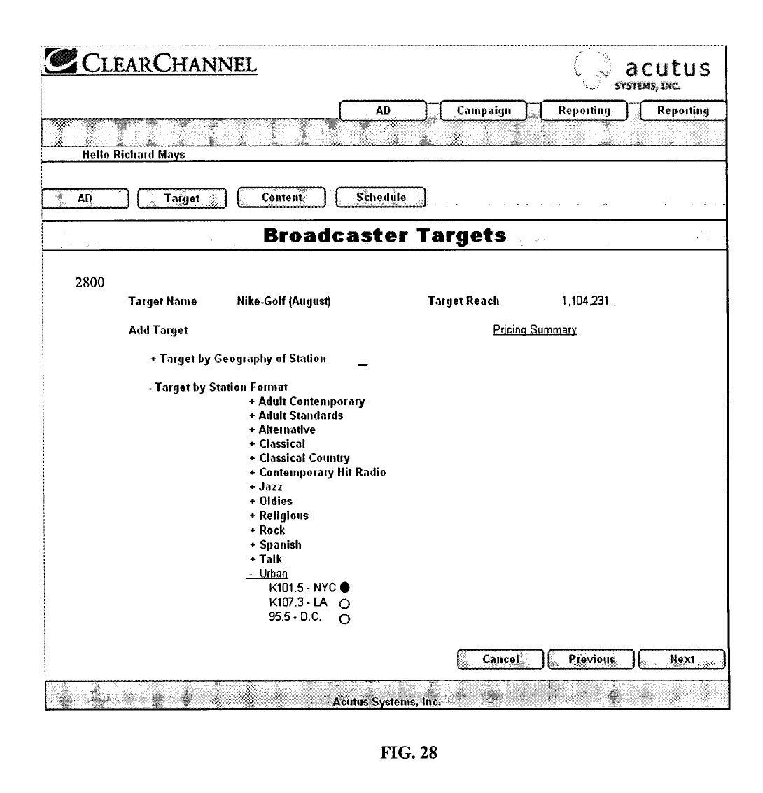

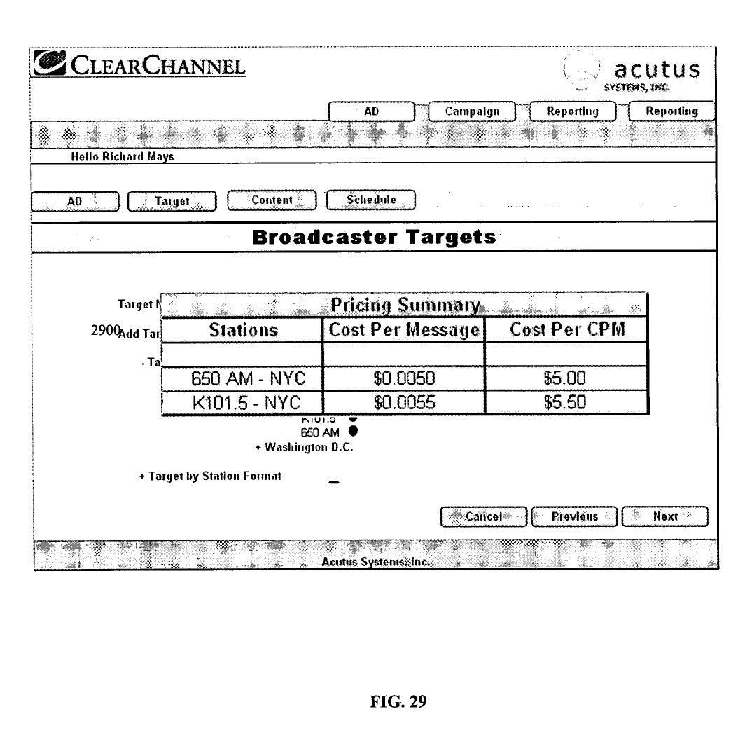

FIGS. 22-29 illustrate a number of remaining screen shots that further demonstrate the features and functions for targeting consumer users. FIGS. 22-25 illustrate the expansion and selection of targets for broadcasters into cities. FIGS. 26-28 illustrate the expansion and selection of targets for broadcasters into station format. FIGS. 22-25 illustrate the display of costs to broadcasters for particular city campaigns, including costs per message, and costs per CPM.

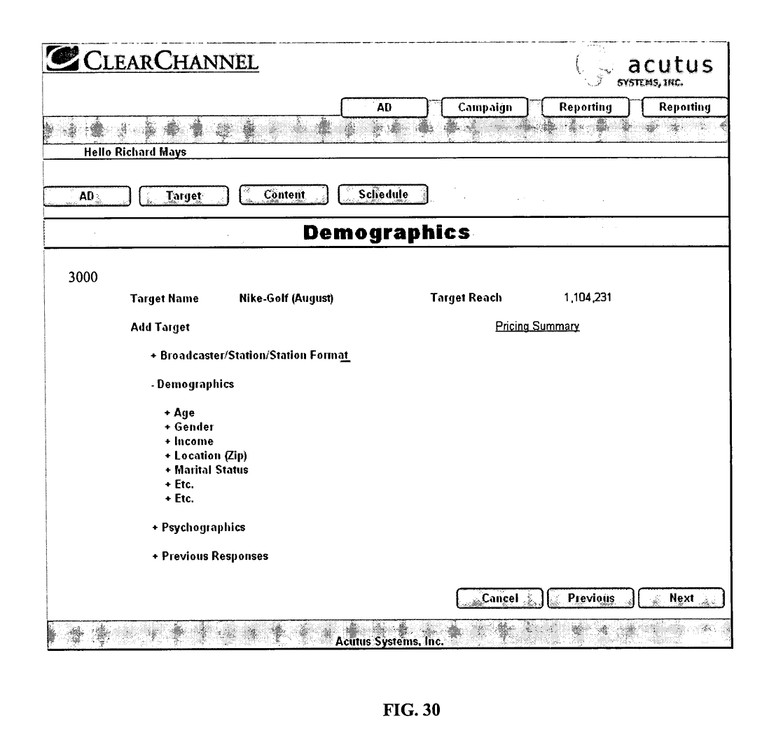

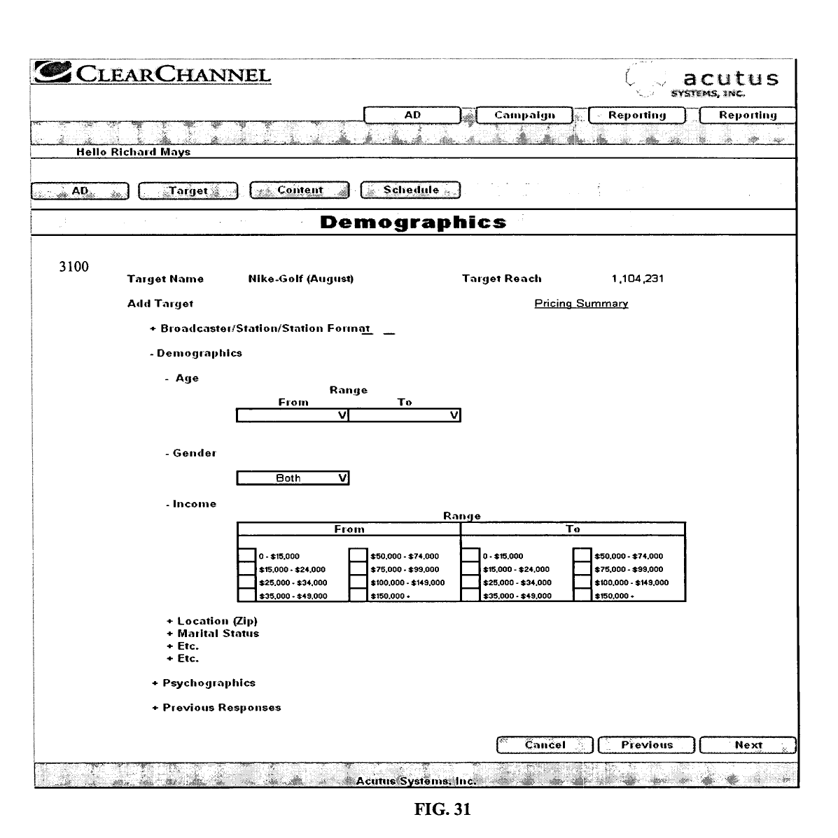

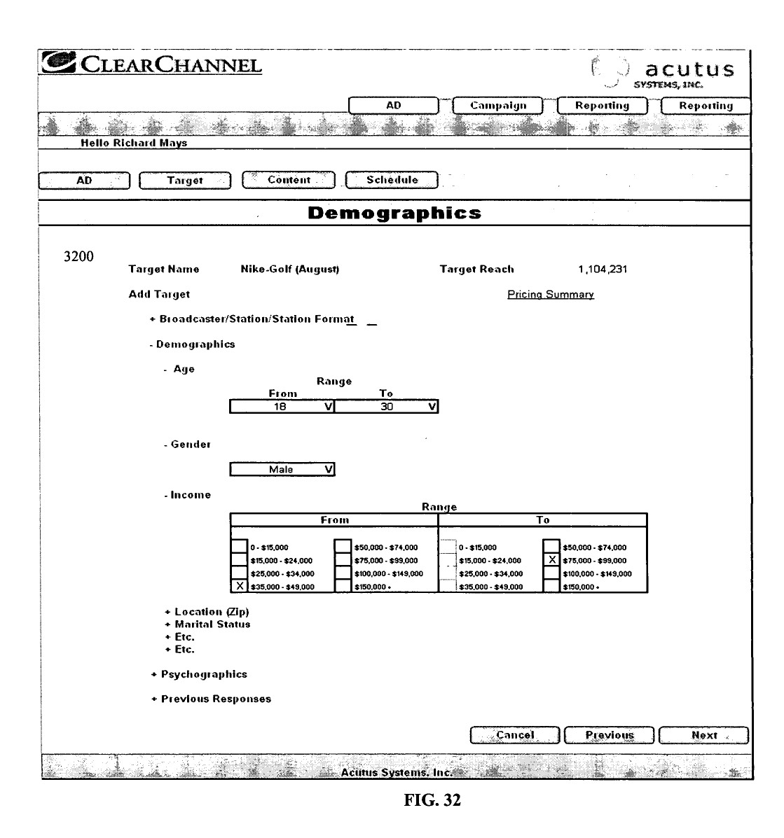

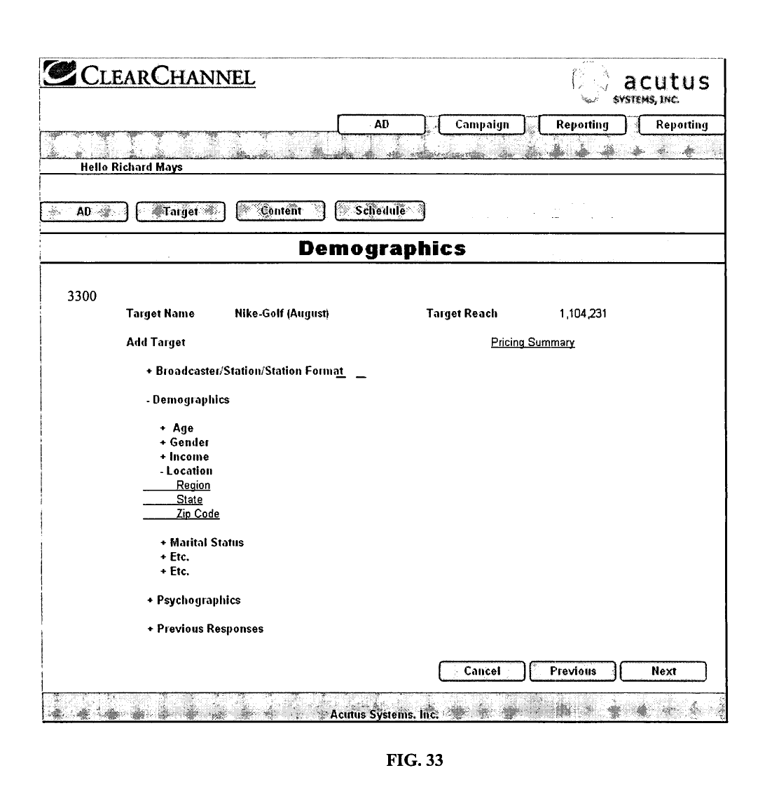

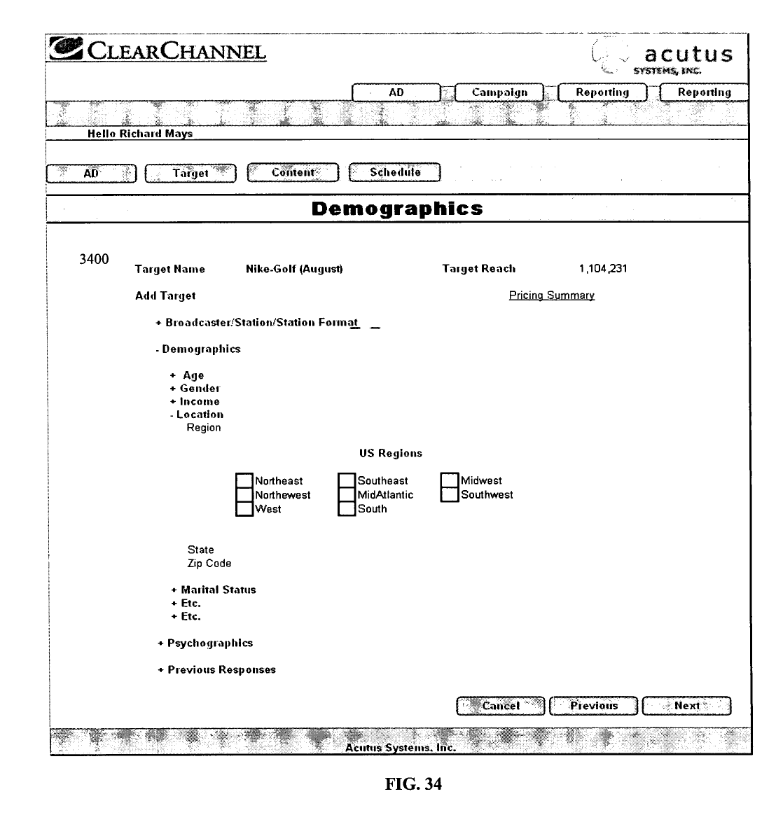

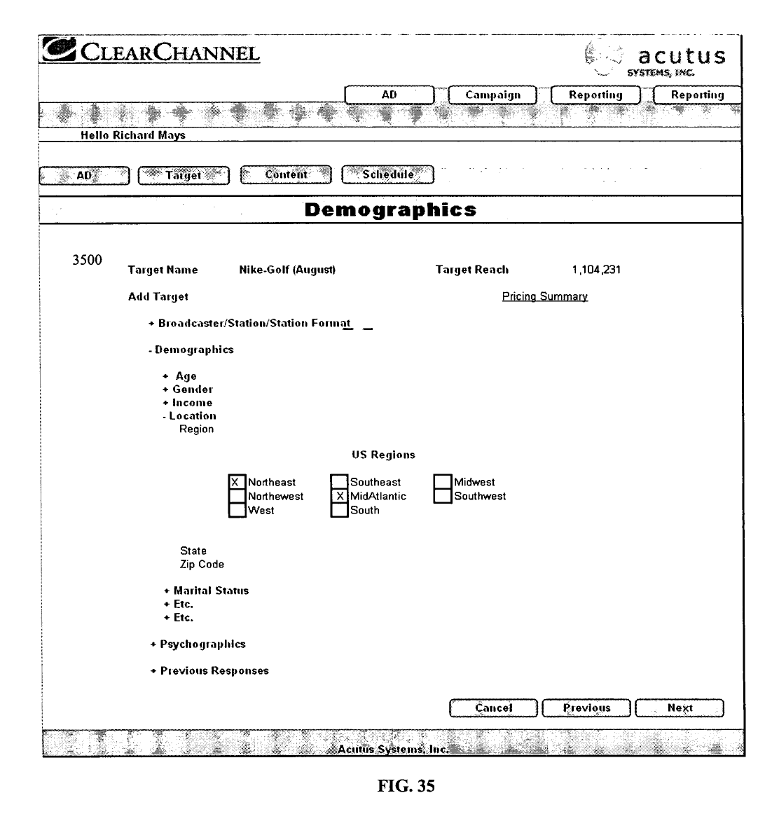

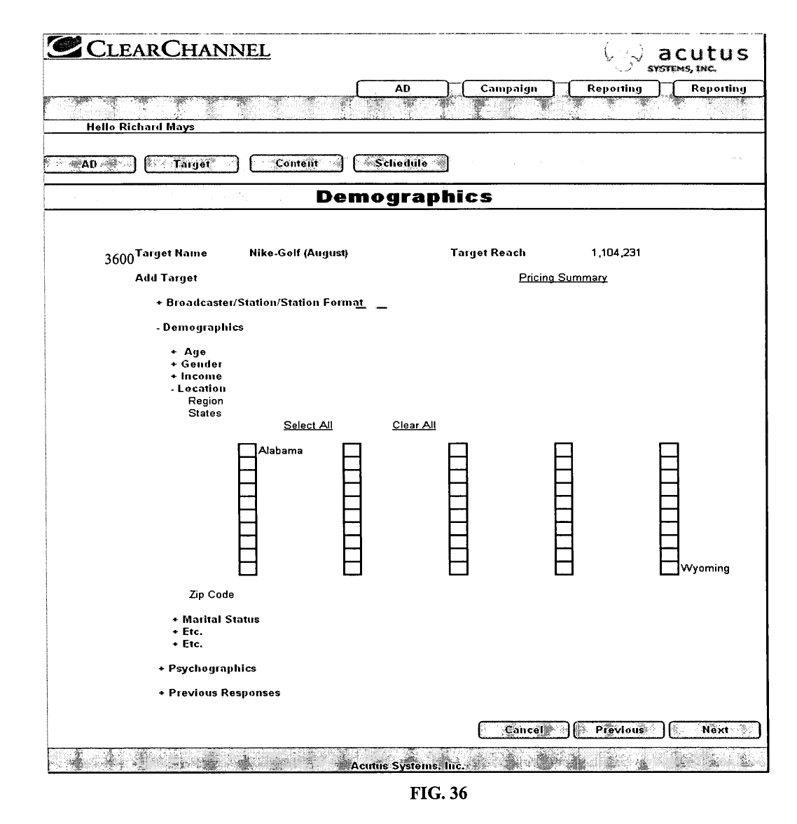

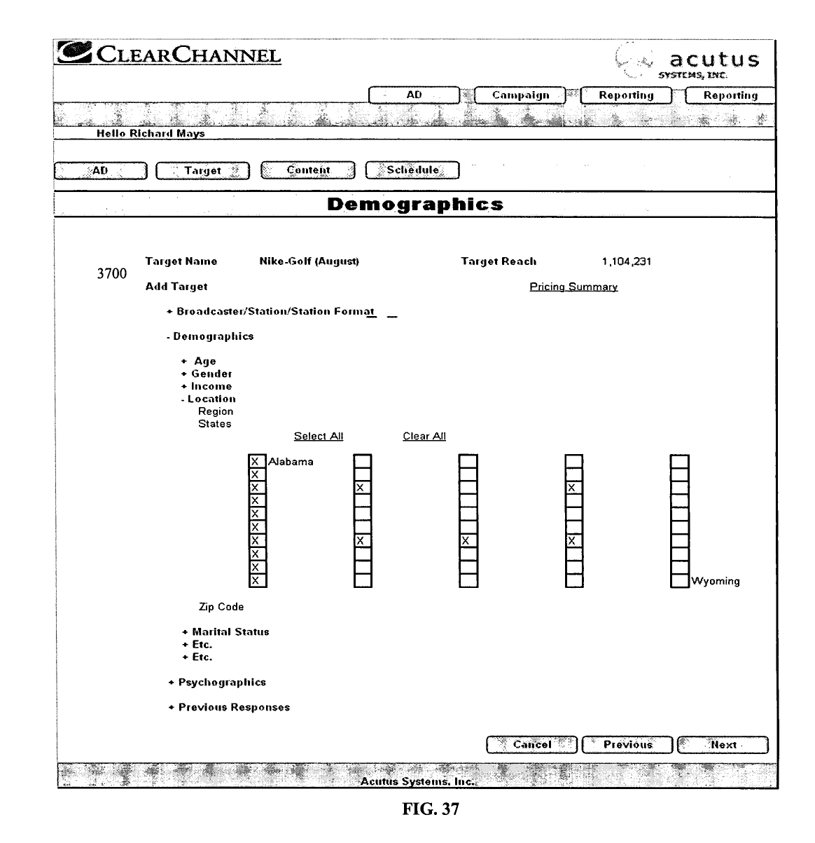

FIGS. 30-37 illustrate a number of screen shots that further demonstrate the features and functions for targeting consumer users based on demographics. Specifically, FIG. 30 illustrates demographic targets, FIG. 31 illustrates demographic targets expanded, FIG. 32 illustrates demographic on age, gender and income, FIG. 33 illustrates demographic targets on location, FIG. 34 illustrates demographic targets on location and region, FIG. 35 illustrates demographic targets selection on location and region, FIG. 36 illustrates demographic targets on location and state, and FIG. 37 illustrates demographic targets selection on location and state.

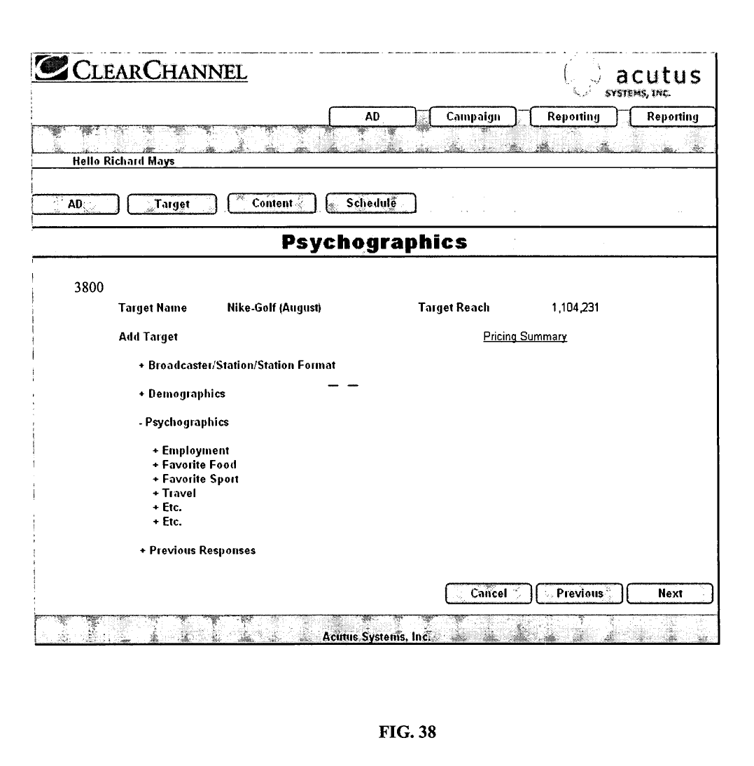

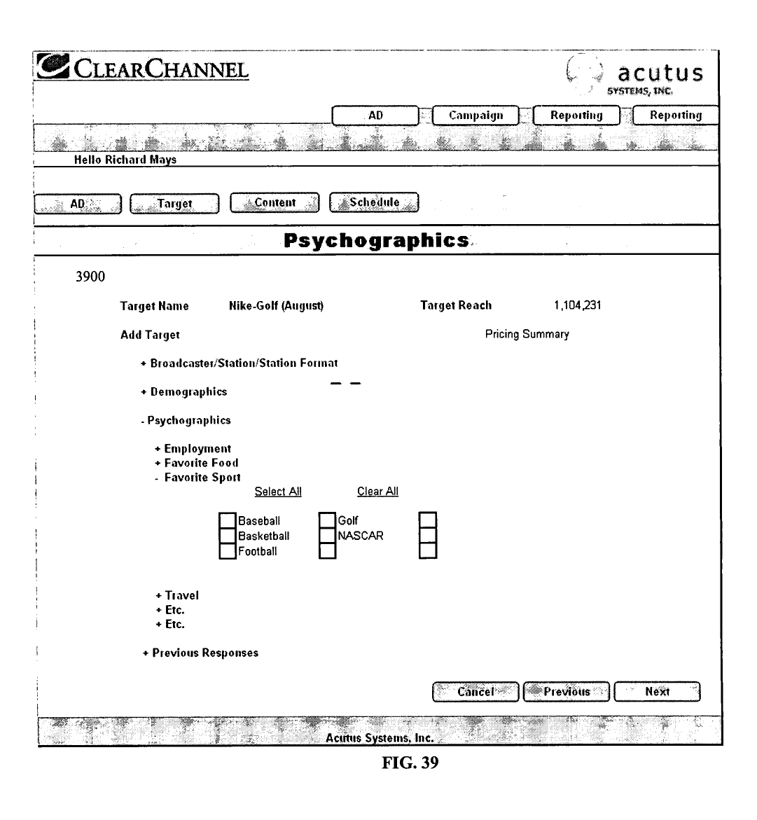

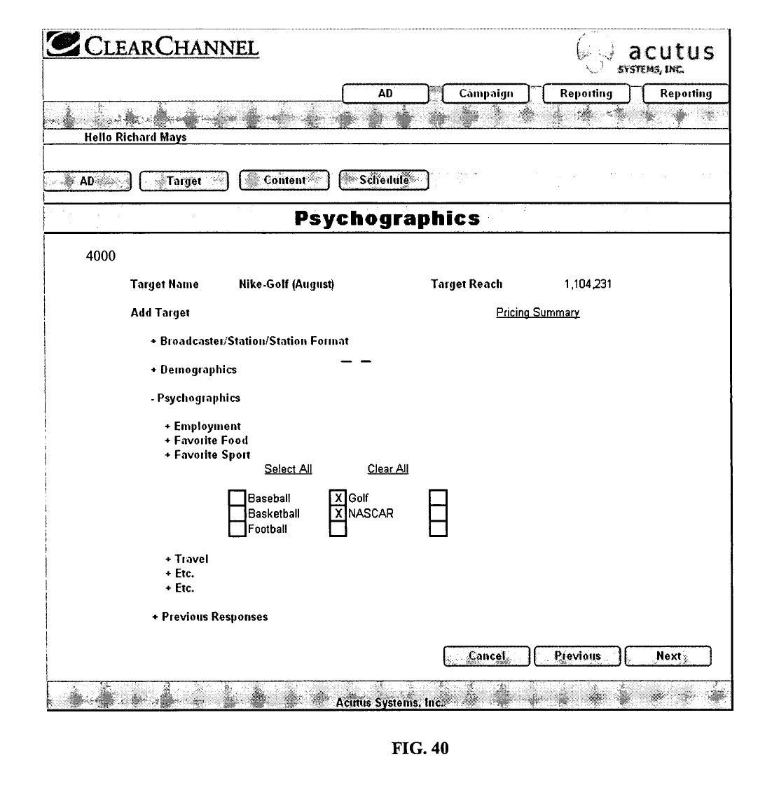

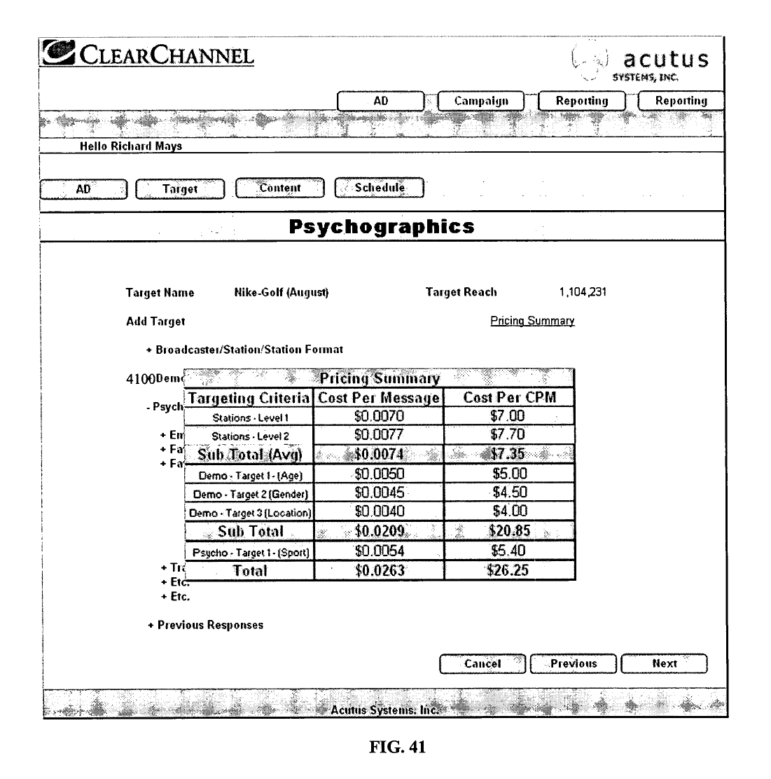

FIGS. 38-41 illustrate a number of screen shots that further demonstrate the features and functions for targeting consumer users based on psychographics. Specifically, FIG. 38 illustrates psychographic targets, FIG. 39 illustrates psychographic targets on favorite sports, FIG. 40 illustrates psychographic targets selection on favorite sports, and FIG. 41 illustrates psychographic targets pricing summary.

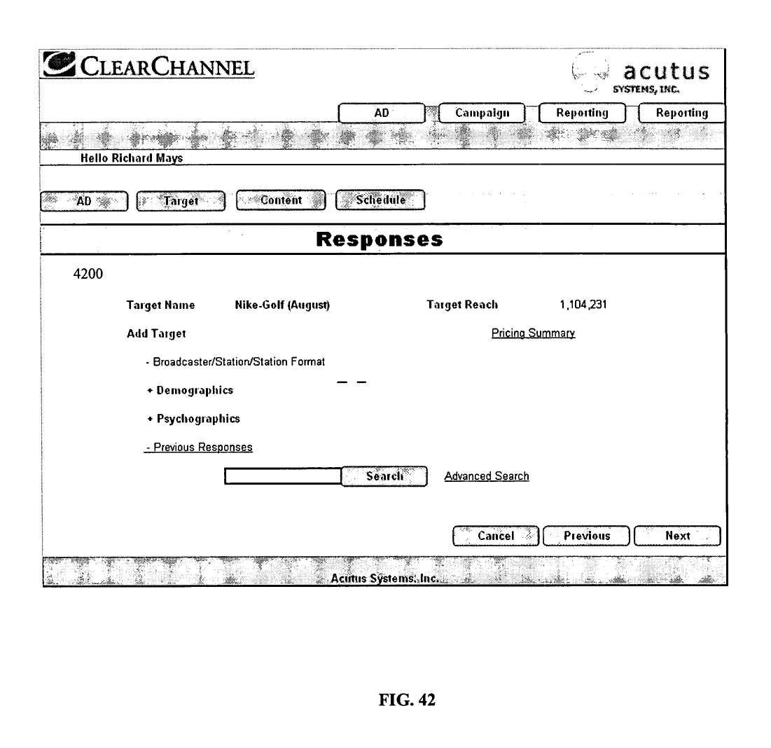

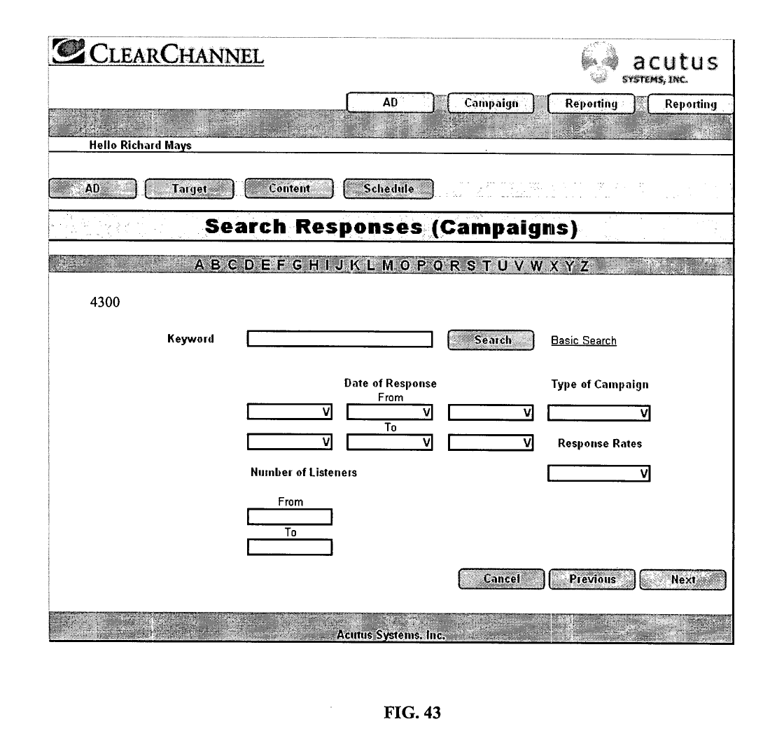

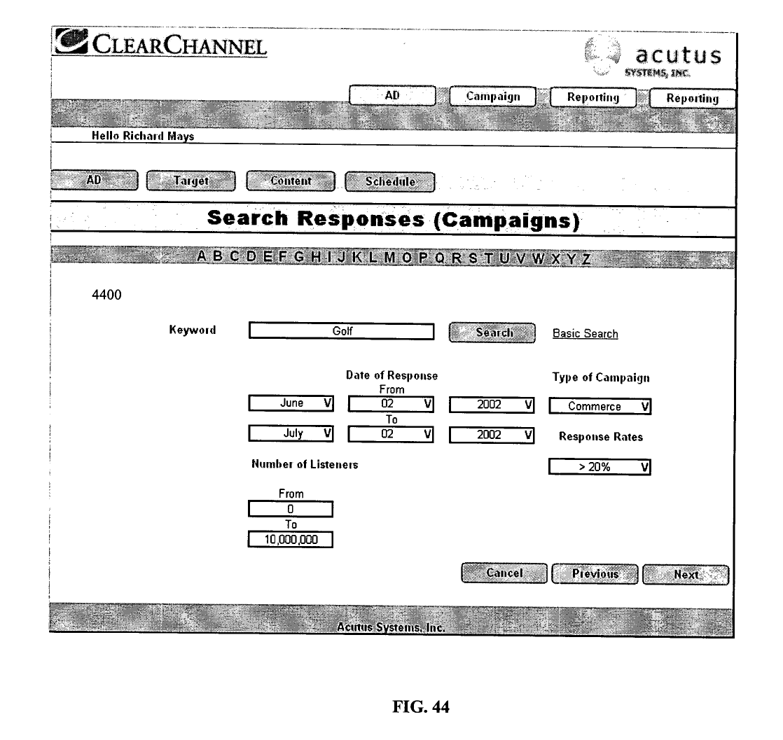

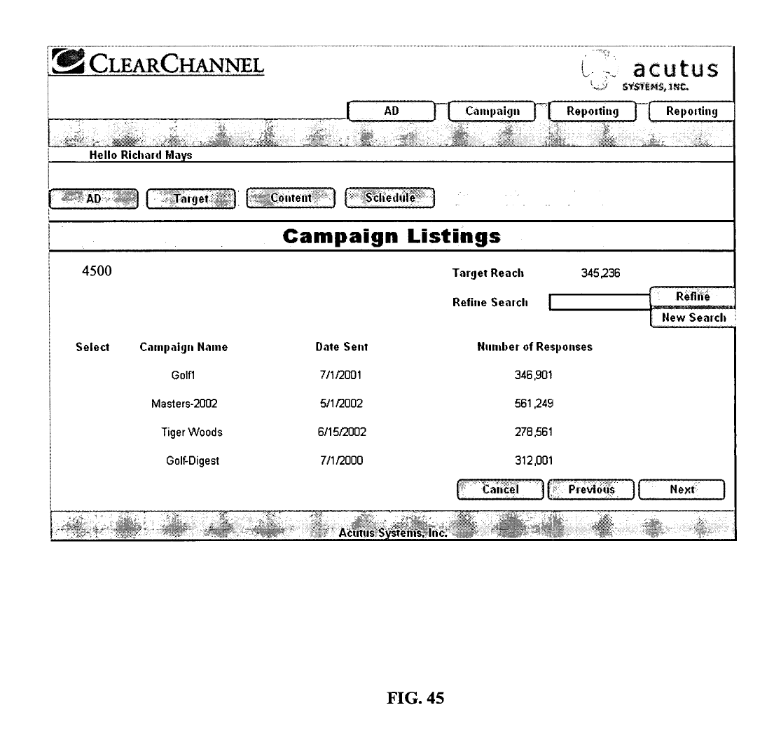

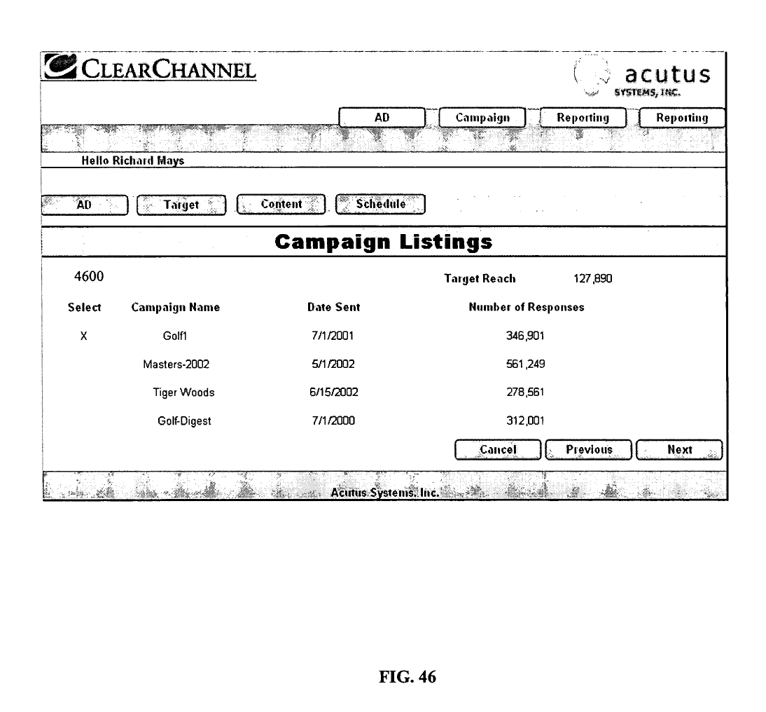

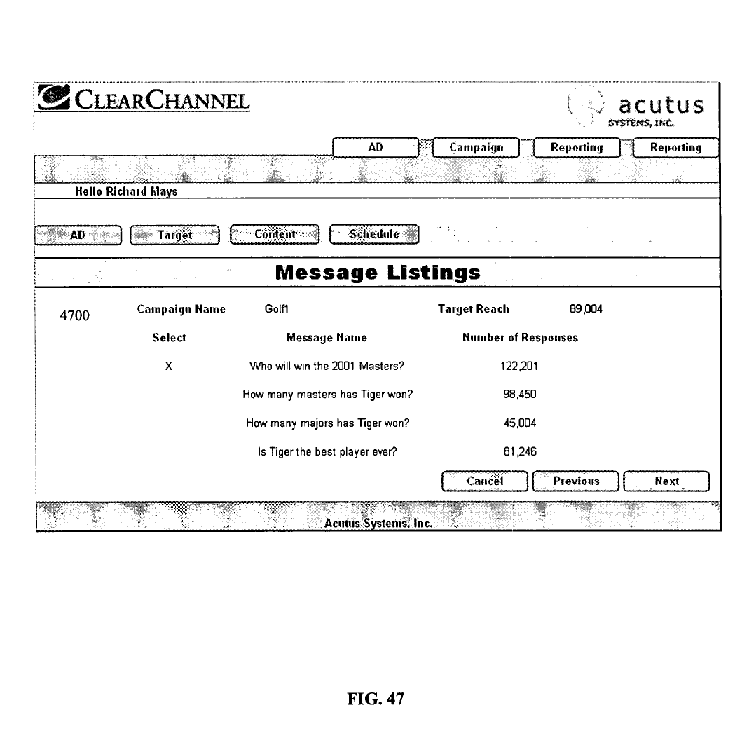

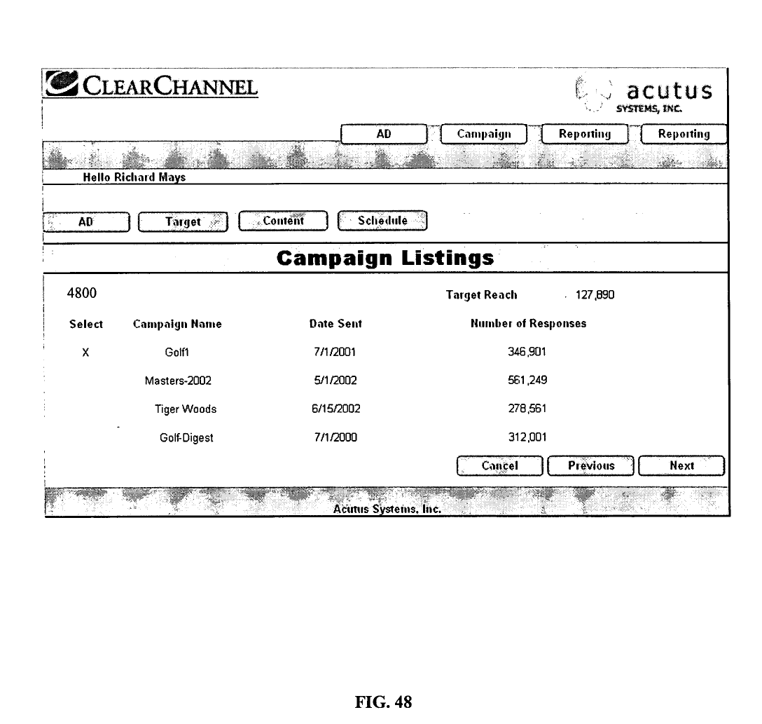

FIGS. 42-48 illustrate a number of screen shots that further demonstrate the features and functions for targeting consumer users based on previous responses. Specifically, FIG. 42 illustrates previous response targets, FIG. 43 illustrates advanced searching on previous response targets, FIG. 44 illustrates advanced searching criteria for previous response targets, FIG. 45 illustrates search results for previous response targets, FIG. 46 illustrates campaign selection on previous response targets, FIG. 47 illustrates message selection on previous response targets, and FIG. 48 illustrates response selection on previous response targets.

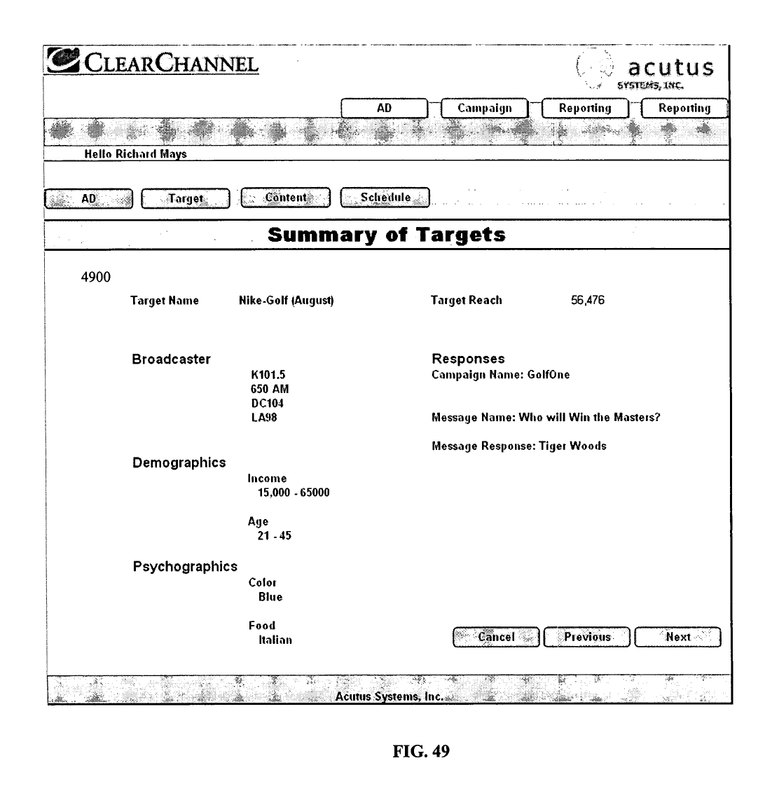

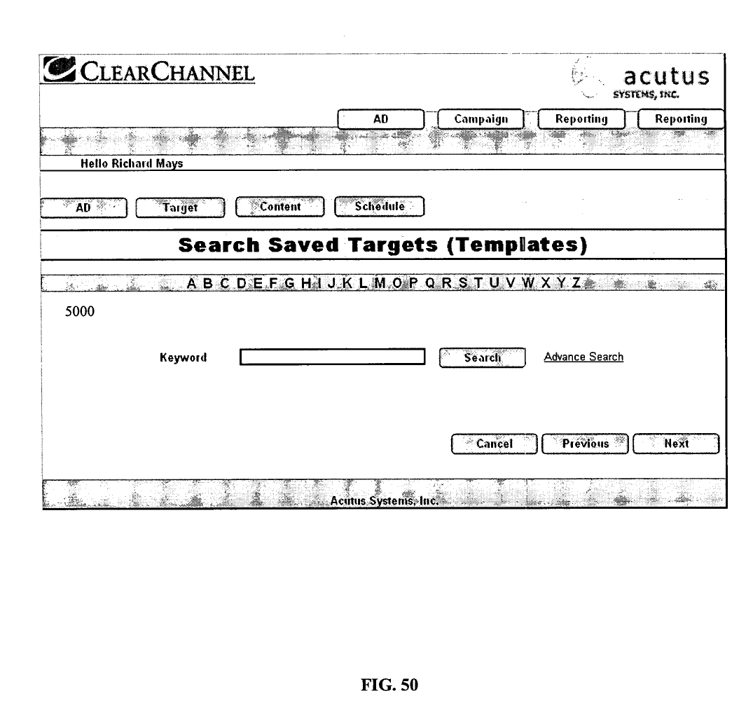

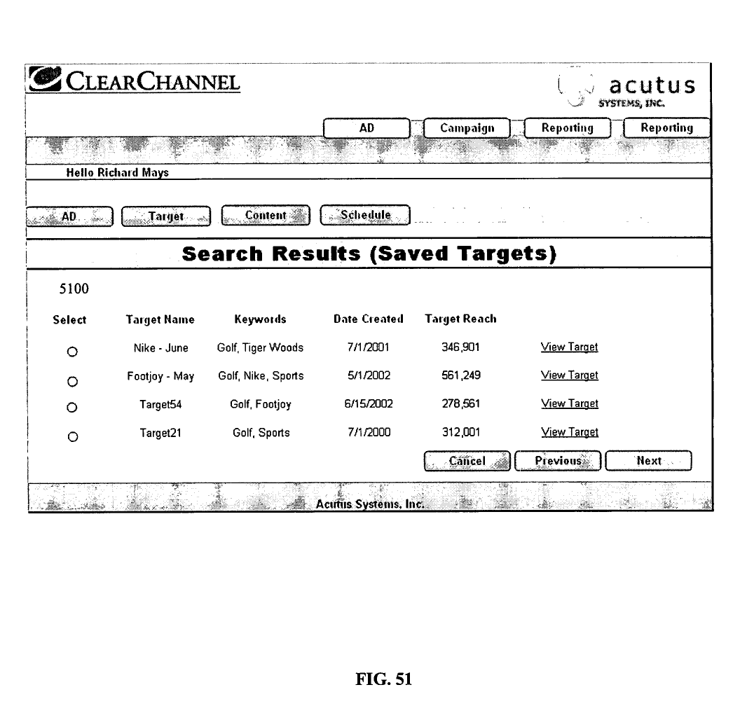

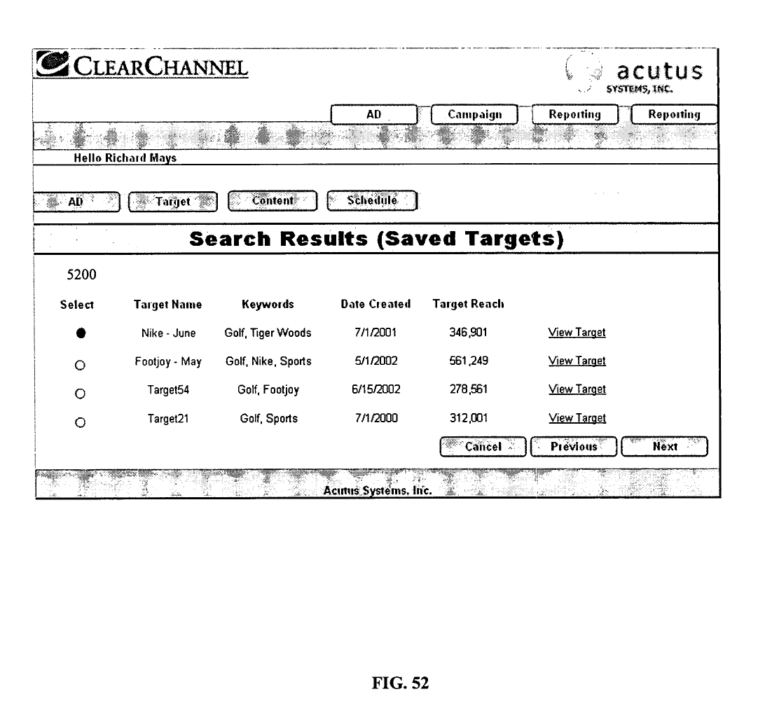

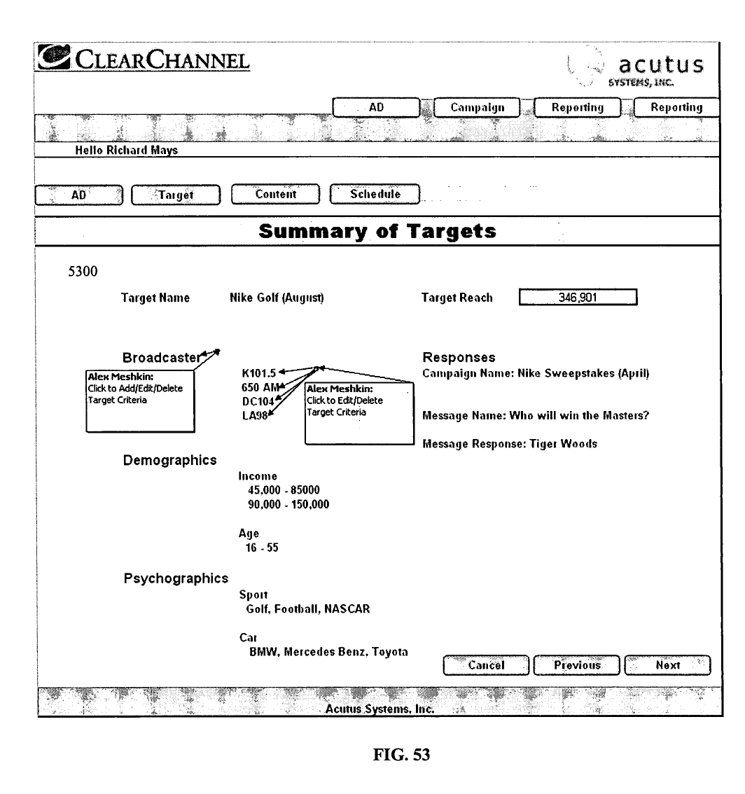

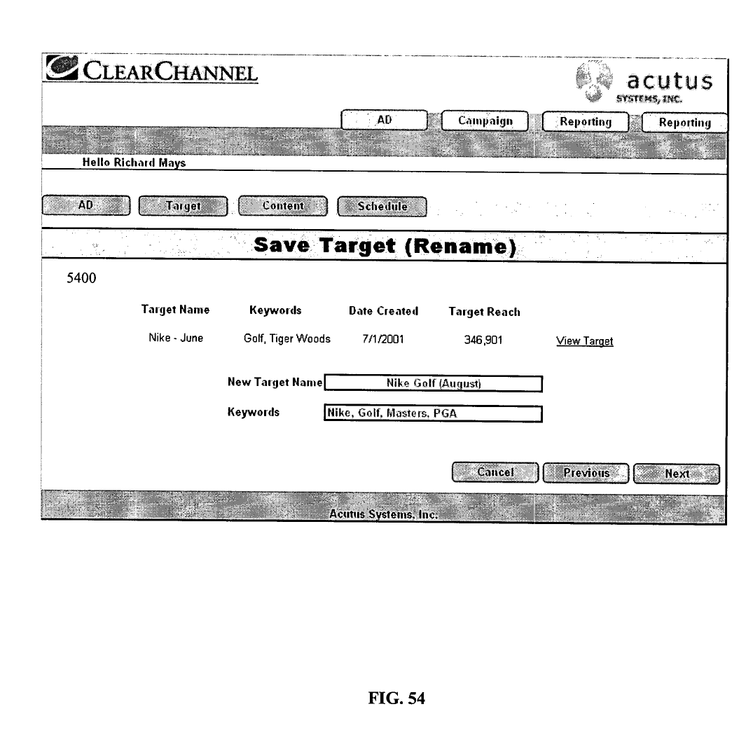

FIGS. 49-54 illustrate a number of screen shots that further demonstrate the features and functions for analysis and display of the targeted results. FIG. 49 illustrates a display of a summary of the different targeting types. FIG. 50 illustrates how saved targets (target templates) can be searched, in accordance with the aforementioned query types. FIG. 51 illustrates search results pertaining to a search for saved targets (target templates). FIG. 52 illustrates selection of a saved target. FIG. 53 illustrates the view of how a target template is viewed. FIG. 54 illustrates the view adding of keywords and naming a target template.

The commerce manager module 730 has a number of commerce and ecommerce related campaign functions. Brand entity users are enabled to view, update, and extrapolate from key features regarding commerce campaigns. In one or more embodiments, IMVP permits searching and selection on products, adding products, descriptions of products, and viewing responses to informational content exchange (for example, “Which item would you like to bid on?). In one or more embodiments, the following information is gathered regarding commerce campaigns: (i) number of Messages sent for a specific campaign by an advertiser; (ii) number messages responded to for a specific campaign; (iii) effectiveness of a campaign; (iv) number of individuals who participated (for example, the percentage of overall sent, or the ability to drill down and see number of bids by each consumer user); (v) number of consumer users (for example, by percentage) who bid multiple times in a single campaign; (vi) number of total bids per item; (vii) number of total bids per campaign; (viii) number of points issued per item; (ix) number of points issued per campaign; (x) number of bids per item (by, for example, UPC code of the item); (xi) bid history per item (by, for example, UPC code of the item); (xii) average opening bid per item (by, for example, UPC code of the item); (xiii) average closing bid per item (by, for example, UPC code of the item); (xiv) opening bid per item (by, for example, UPC code of the item); (xv) closing bid per item (by, for example, UPC code of the item); (xvi) number of items sold per item (by, for example, UPC code of the item); (xvii) total value of items sold; and (xviii) total value of items redeem for points.

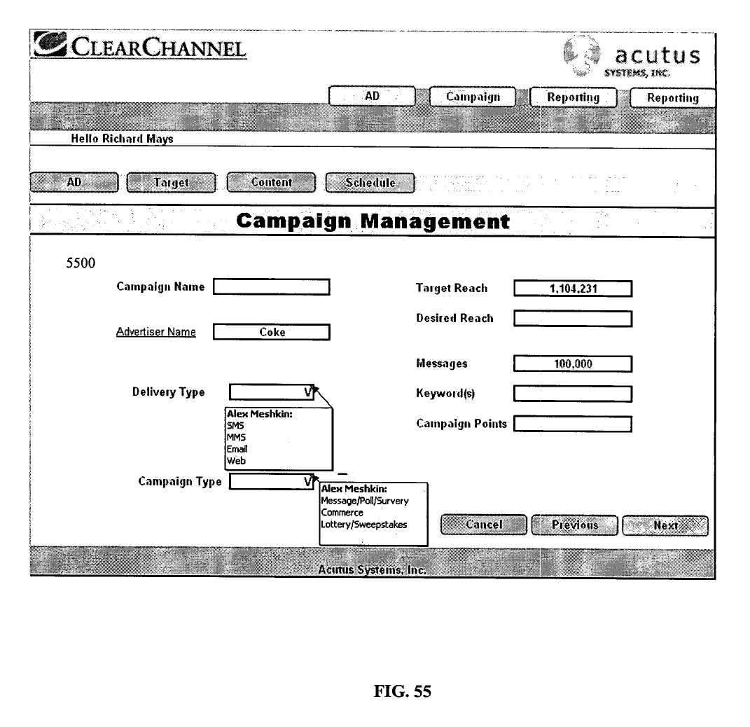

FIGS. 55-62 illustrate a number of screen shots that further demonstrate the features and functions for commerce campaigns.

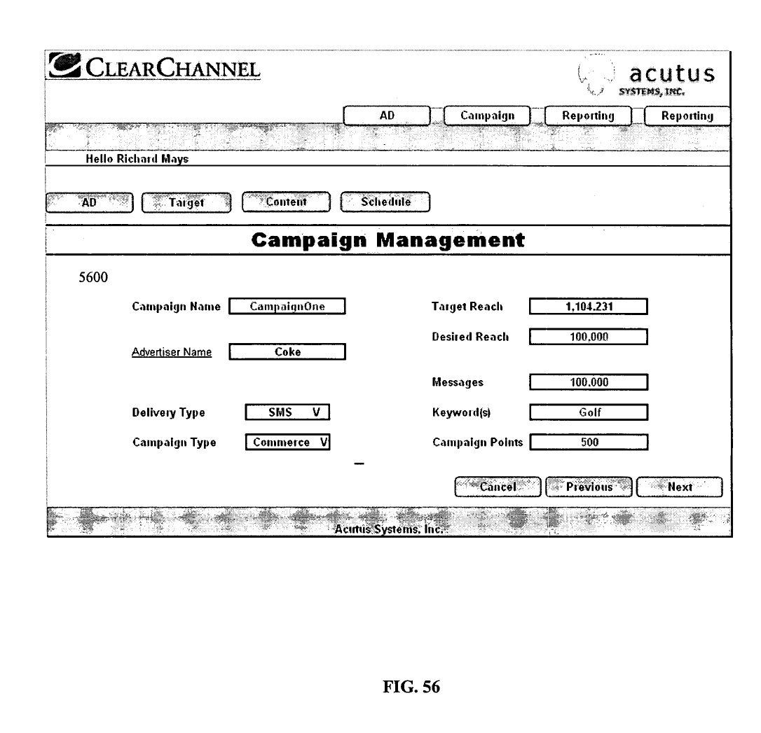

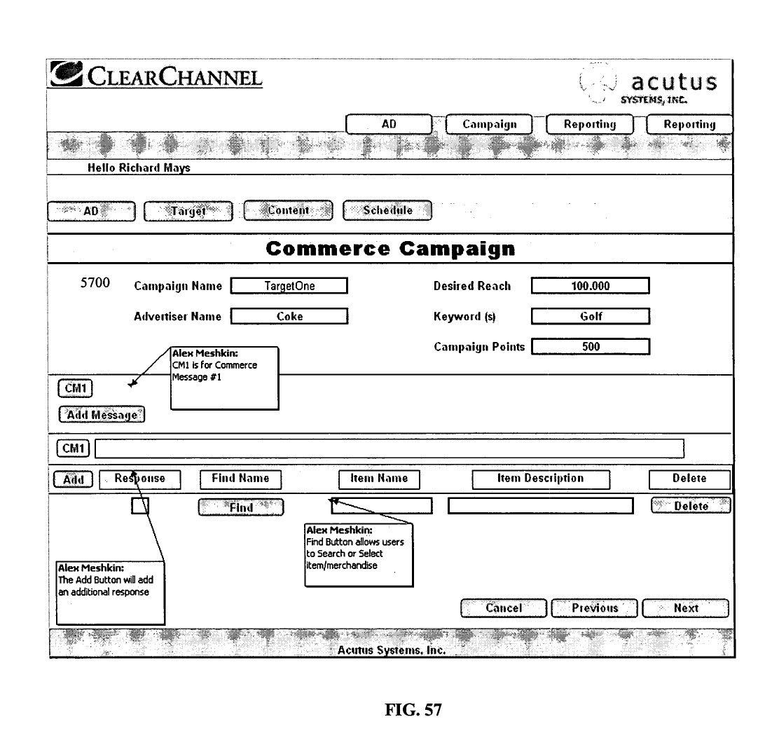

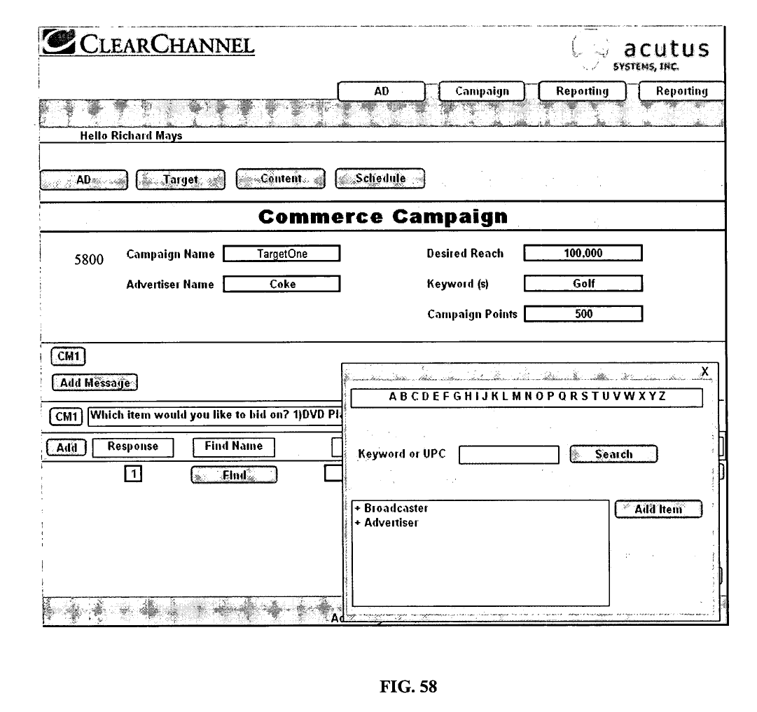

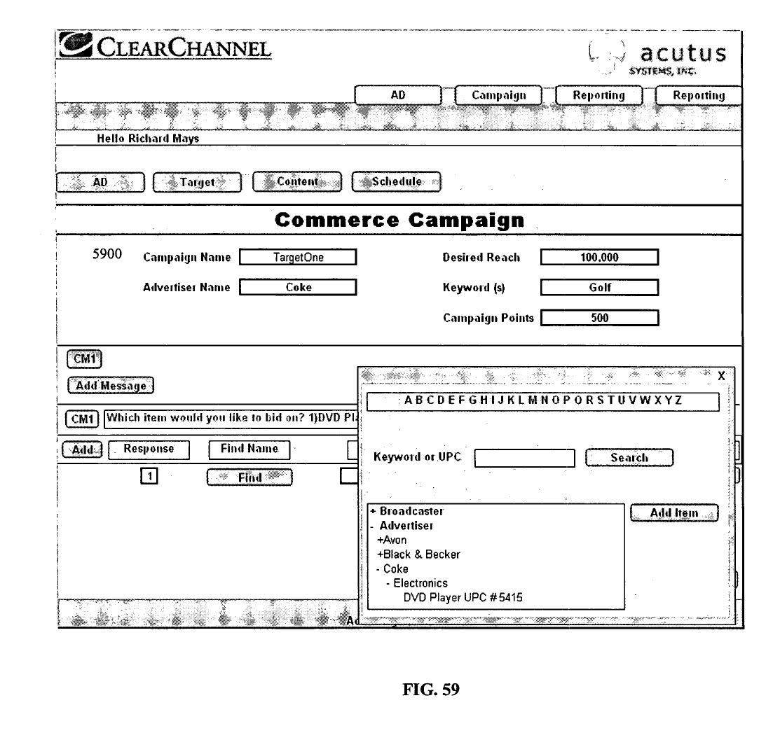

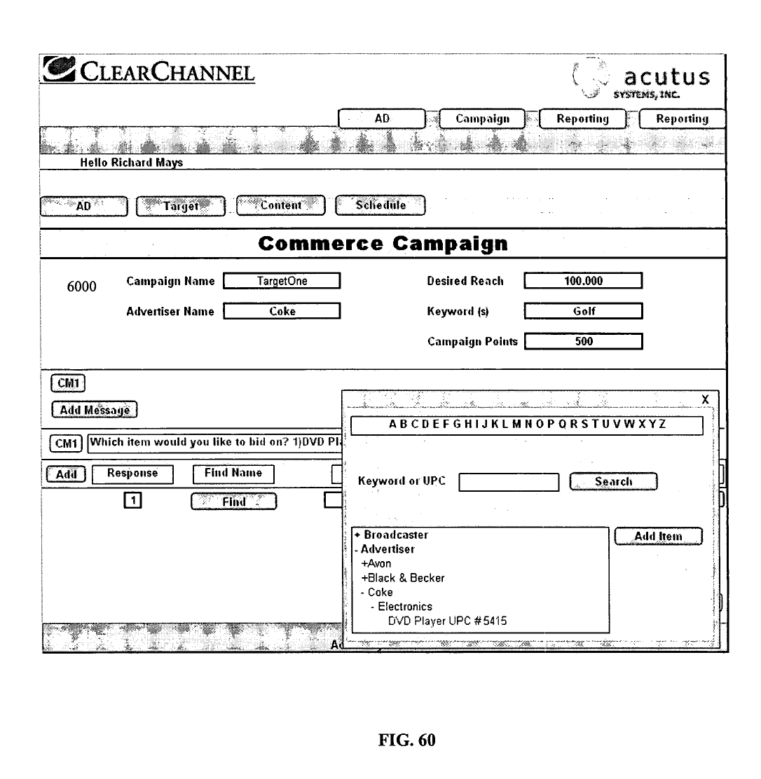

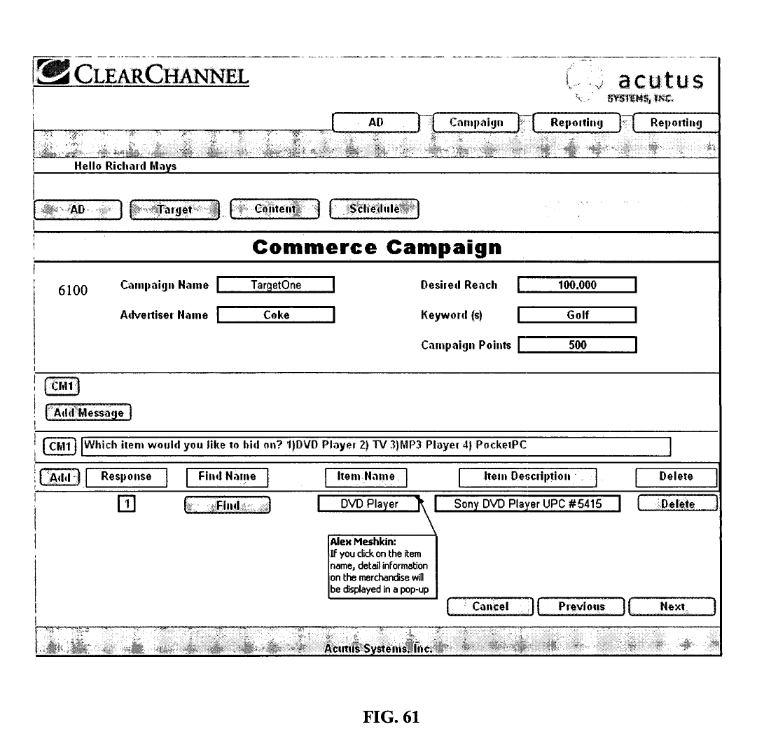

FIG. 55 illustrates a screen shot of a basic commerce campaign. FIG. 56 illustrates a screen shot for an SMS commerce campaign. FIG. 57 illustrates a screen shot showing commerce campaign fields in detail. FIG. 58 illustrates a screen shot for how an item or merchandise is added in a commerce campaign. FIG. 59 illustrates a screen shot of search results for adding an item or merchandise in a commerce campaign. FIG. 60 illustrates a screen shot of item selection in a commerce campaign. FIG. 61 illustrates a screen shot for item adding in a commerce campaign.

Features and functions of the loyalty manager module 728 are described below, with respect to the fourth embodiment.

The inventory manager module 730 has a number of inventory related functions. In one or more embodiments, the inventory manager module 730 calculates, for a given forecast period and based on a given historical period, the number of projected, scheduled, and reserved impressions that IMVP should accept. Historical data can be the basis of inventory projection. For each day of the given historical period, the inventory manager module 730 can derive from database 542 the number of impressions that were served under a given set of conditions.

In one or more embodiments, inventory forecasting is a key component of inventory manager module 730. The projection reports can use historical impression rates to predict the future number of impressions per campaign, creative or target, for example. Inventory manager module 730 can identifies over-commitment or under-selling of impressions by combining that prediction with the number of ads actually scheduled.

The reports differ only in the criteria by which results can be grouped and broken down. In one or more embodiments, broken down by selected criteria, the inventory manager module 730 (and the projection reports) can present: (i) scheduled impressions (S)—calculated by analyzing active campaigns plus pending campaigns; this is the number of impressions that have been sold in advance (for example, 1000); in calculating scheduled impressions, the inventory manager module can account for overlap in campaigns; if the target could be satisfied by ads from several campaigns, the scheduled number of impressions from each campaign is scaled down to reflect the historical record; (ii) reserved impressions (R)—the number of impressions that have been reserved but not yet scheduled by the confirmation process (for example, 200); (iii) projected impressions (P)—calculated by analyzing the trend of the historical period (for example, 200); (iv) percent used—the ratio of scheduled and soon-to-be-scheduled impressions to deliverable impressions, or (S+R)/P; in other words, this is the percentage of anticipated deliverable impressions that are already sold and ready to roll out (for example, (1000+200)/1500=80%); (v) available impressions—the number of anticipated deliverable impressions that are yet to be scheduled or reserved, or P−(S+R); this can be interpreted as an additional sales goal (for example, 1500−(1000+200)=300). The foregoing five statistics can be broken down by a variety of criteria that depend on the report. The totals can be further broken down by day, week, or month of the projection period. Results are written to a comma-separated value (CSV) list, which can be input to a report server for creation of a business report. The resulting report can be sorted or grouped by a variety of criteria.

In one or more embodiments, inventory manager module 730 performs inventory statistics, as follows: (i) average (the default)—for example, if 3, 4, and 5 ads are served on consecutive days, averaging predicts that 4 ads would be served the next day; (ii) linear regression—the calculation of a straight line through a set of points; for example, if 3, 4, and 5 ads are served on consecutive days, linear regression predicts that 6 ads would be served the next day; (iii) multiple regressions—calculation that yields a prediction that accounts for fluctuation in impression rate by day of the week; if a site's impression rates fluctuate by day of the week, multiple regressions are a better predictor than linear regression; and (iv) sampling—the proportion of all served informational content exchange (fore example, questions) that is to be sampled and stored in a database that is dedicated to projections; as an example, 1000 means that for projection purposes, the product records 1 creative per thousand served; a higher sampling rate (a lower number) or a longer historical period in the report parameters generates more data and possibly better reports.

In one or more embodiments, an inventory query function of inventory manager module 730 enables users to query the inventory forecast based on historical data. By doing this, it allows the brand entity user to see what may be available and if it meets the requirements of existing and new campaigns. This can be most beneficial when a user is looking to give information while speaking with the client.

In one or more embodiments, a capacity query function of inventory manager module 730 allows the brand entity user to query the database for the total number of existing consumer users based on selected targets. The campaign manager module 722 has the ability to query the number of consumer users in a table that meet the criteria for a specified target. The brand entity user can select the target button and the query will generate the number available at that point and not when the campaign would actually run.

In one or more embodiments, an inventory/capacity reservations function of inventory manager module 730 enables brand entity users to plan and reserve campaigns within a product by viewing the current inventory available and the capacity at that time. Brand entity users can reserve campaigns, track and analyze campaign progress and effectiveness. Once reserved, the inventory can be marked as unavailable for other queries.

In one or more embodiments, an inventory forecast of inventory manager module 730 can support the creation and utilization of an overlap matrix that allows for quick estimates to be done on reservations against currently existing targets. The inventory manager module 730 can support queries against non-existing targets as well. The inventory manager module 730 has a changeable prioritization routine. Initially there are at least two ways to show inventory availability: (i) optimized for overall broadcaster revenue generated, and (ii) optimized for the best throughput (for example, most messages per unit time).

In one or more embodiments, a reservation system function of inventory manager module 730 allows the inventory analysis to consider both active campaigns and campaign reservations, when receiving inventory request. Additionally, it can adjust results for overlapping targets.

In one or more embodiments, a capacity planning function of inventory manager module 730 provides additional measurements on the capacity for messaging. These measurements are estimates and will likely change over time and will change as new channels of distribution are established. Inventory calculations can take into account: (i) actual delivery traffic; (ii) user database of profile information; (iii) advertiser preferences on frequency; (iv) user preferences on frequency; (v) delivery device capabilities (for example, gateway throughput limits); and (vi) seasonal factors and unusual events.

In one or more embodiments, the capacity planning function permits predicting delivery capabilities based on a target. A target with a date range can fully qualify any inventory query. Inventory queries can be independent of whether or not a target has had any actual delivery traffic. In one or more embodiments, inventory queries can take into account: (i) all types of frequency limitations; (ii) overlap estimates of other reservations; (iii) time of day limitations for the message and user preferences on delivery time; and (iv) gateway capabilities.

The pricing manager module 724 determines the pricing criteria and conditions for fees to be paid by broadcasters or advertisers for use of the system. In one or more embodiments, pricing calculation is partly driven by the targeting process, because every time a targeting criteria is added, it will affect (raise) the CPM rate for a campaign. In one or more embodiments, the total campaign price itself is not affected for the foregoing, but only the price per message or cost per thousand (CPM) will increase. In other words, the campaign price may decrease since the target reach is smaller. Pricing for campaigns can be determined by any number of unique and known mechanisms, including the size, reach, processing requirements, and other characteristics of a campaign and corresponding creatives. In one or more embodiments, exemplary pricing models used also include (i) a flat fee first usage payment structure based upon usage of the IMVP system; (ii) a flat fee periodic payment fee structure based upon usage of the IMVP system; (iii) an escalating fee structure based upon usage of the IMVP system; (iv) a transactional fee structure based on transactions carried through the IMVP system; (v) an advertising fee structure based upon advertisements featured on the IMVP system; (vi) a sponsorship fee structure based upon sponsorship of the IMVP system; (vii) a direct marketing fee structure whereupon user information is sold for payments; and (viii) a hybrid model comprising a combination of any of (i) through (vii).

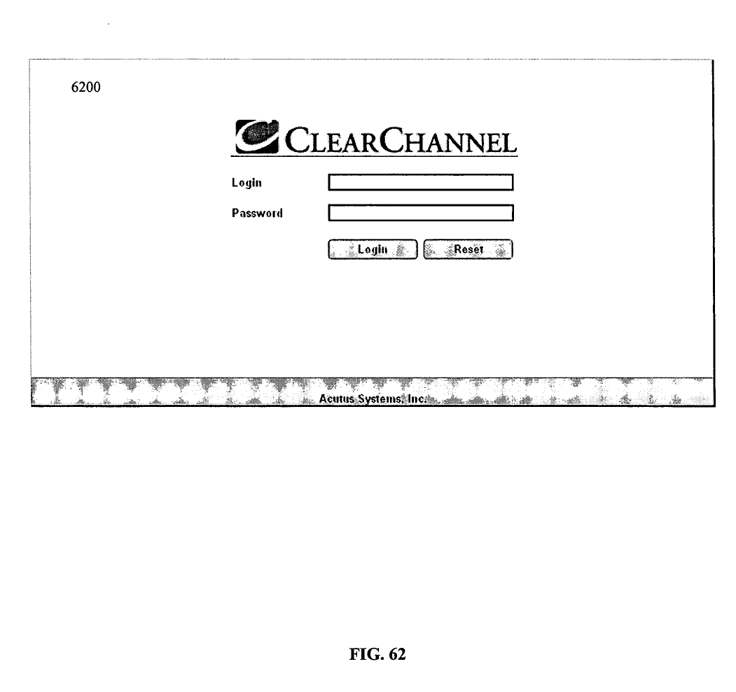

The reporting manager module 732 has the function of generating reports for brand entity users, including broadcasters and advertisers. In one or more embodiments, within the reporting manager module 732, reports are divided into external reports (for advertisers) and system reports (for broadcasters). Within the user manager module 714, administrators can set security permissions to enable the broadcaster to limit advertisers' access only to the reports they want these third party users to view. FIG. 62 illustrates an exemplary login screen shot.

In one or more embodiments, external reports can be specific to the advertiser's campaigns and actions only. These external reports are a subset of the system reports noted above. In one or more embodiments, reports can be divided into message campaign reports, commerce campaign reports and lottery campaign reports.

The following is a list of exemplary reports: (i) number of campaigns sent per type (commerce, lottery and message); (ii) number of campaigns sent per delivery type (including, for example, SMS, MMS & email delivery types); (iii) number of campaigns sent; (iv) number of messages sent; (v) number of responses; (vi) number of points awarded by an advertiser; (vii) costs of campaigns; and revenue generated by the advertiser.

The following is a list of exemplary message campaign specific reports: (i) number of dialog messages sent for a specific campaign; (ii) number dialog messages responded to for a specific campaign; (iii) effectiveness of a campaign (response rate); (iv) effectiveness of a question (response rate); (v) response rates for message campaigns; (vi) response rates broken down by delivery type; (vii) average response rates by delivery type; (viii) average response rates; (ix) number of points awarded per campaign; (x) number of points awarded per question; (xi) number of points awarded for message campaigns; and (xii) number of people who responded to a message with a certain response and then search on those individuals on a separate keyword search that may or may not have been tied to the campaign (for example, “Show me everyone who answered YES to coke campaign; now show me everyone who said YES and likes football.”).

The following is a list of exemplary commerce campaign specific reports: (i) number of Messages sent for a specific campaign by an advertiser; (ii) number messages responded to for a specific campaign; (iii) effectiveness of a campaign; (iv) number of individuals who participated (for example, the percentage of overall sent, or the ability to drill down and see number of bids by each consumer user); (v) number of consumer users (for example, by percentage) who bid multiple times in a single campaign; (vi) number of total bids per item; (vii) number of total bids per campaign; (viii) number of points issued per item; (ix) number of points issued per campaign; (x) number of bids per item (by, for example, UPC code of the item); (xi) bid history per item (by, for example, UPC code of the item); (xii) average opening bid per item (by, for example, UPC code of the item); (xiii) average closing bid per item (by, for example, UPC code of the item); (xiv) opening bid per item (by, for example, UPC code of the item); (xv) closing bid per item (by, for example, UPC code of the item); (xvi) number of items sold per item (by, for example, UPC code of the item); (xvii) total value of items sold; and (xviii) total value of items redeem for points.

expanded throughput techniques, and quality of service manipulations.

D. Fourth Embodiment

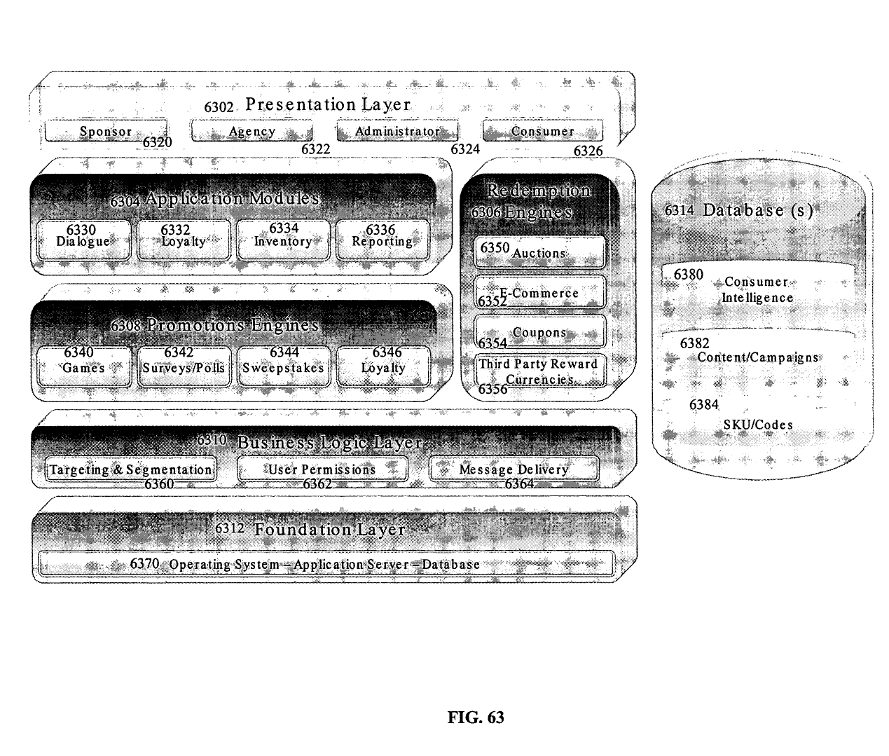

FIG. 63 illustrates a fourth system level embodiment of the present invention. Included in FIG. 63 are presentation layer 6302, application layer 6304, promotion layer 6308, business logic layer 6310, foundation layer 6312, redemption layer 6306 and databases 6314.

Presentation layer 6302 comprises sponsor module 6320, agency module 6322, administrator module 6324, and consumer module 6326. Application layer 6304 comprises dialogue module 6330, loyalty module 6332, inventory module 6334, and reporting module 6336. Promotions layer 6308 comprises game 6340, surveys/polls module 6342, sweepstakes module 6344, loyalty module 6346. Business logic layer 6310 comprises targeting and segmentation module 6360, user permissions module 6326, and message delivery module 6364. Foundation layer 6312 comprises operating system 6370. Redemption layer 6306 comprises auctions module 6350, ecommerce module 6352, coupons module 6354, and third party reward currencies module 6356. Finally, database 6314 comprises consumer intelligence module 6380, content/campaigns module 6382 and SKI/codes module 6384.

FIG. 63 illustrates a more detailed view of the aforementioned features and functions with respect to FIG. 7. It should be noted that the elements of FIG. 63 have the same respective features and functions as those in FIG. 7, in addition to any additional features and functions described herein with respect to FIG. 63.

In particular, in one or more embodiments, (i) the aforementioned functions of the database 542 are carried out by database 6314; (ii) the aforementioned functions of applications module layer 718 is performed by applications layer 6304, promotions layer 6308, and redemption layer 6306; (iii) the aforementioned functions of user interface 710, external interface 708, and listeners/viewers/consumers layer 554 are performed by presentation layer 6302; and (iv) the aforementioned functions of business logic layer 716 and delivery layer 546 are performed by business logic layer 6310.

In one or more embodiments, the dialogue manager module 6330 manages consumer interactions and focuses not only on generating transactions, but in optimizing interactions. Brand entity users, who are for example sponsors in the NASCAR environment, are given interaction between the consumer/fan in order to grow the consumer relationship and brand loyalty.

This module leverages the platforms' promotion engines and other application modules to enable brand managers to engage consumers with real-time cross-platform dialogues, such as, games, polls and surveys, loyalty and sweepstakes, with reference to the layers 6308 and 6306. Once created, the dialogue manager module 6330 delivers the interactive campaign across platforms and channels such as wireless, internet, email and direct mail. The dialogue manager module supports multiple wireless protocols including SMS, MMS and WAP promotions.

In one or more embodiments, the dialogue manager module 6330 can gain and leverage consumer intelligence with advanced targeting and consumer profiling capabilities through the integrated targeting engine 6360. Targeting engine 6360 enables brand entity users to select and define the target consumer audience based on criteria such as demographics and psychographics and participation history and previous responses.

IMVP permits real-time and seamless push and pull campaigns and enables real-time interaction with the consumer. In one or more embodiments, with the dialogue manager module, sponsors can establish cross platform pull campaigns that begin with an on-the-car announcement. A pull campaign, which is initiated by the sponsor, may utilize universal short codes by placing a code/number on the car, such as 12345, to prompt fans to use their wireless phones and text messaging capability to participate in a sponsor promotion. Push campaigns leverage the promotion layer module 6308 to enable sponsors to target and initiate consumer interactions. Push campaigns can be interactive polls/surveys, games, sweepstakes and incentive based promotions.

The dialogue manager module defines future campaigns by compiling past direct and indirect consumer responses into the consumer intelligence database. Through the use of dynamic cross-platform promotions, the dialogue manager module can guide the process of building advanced permission based wireless and traditional marketing promotions.

Promotions layer 6308, including its modules, offers brand entity users the use of interactive promotional tools to create interactive marketing campaigns. The modules are interactive tools that enable brand entity users to create and market promotions to consumer users, and give consumer users the ability and opportunity to earn incentives. The power to interact with the consumer in real-time and at the point-of-purchase enables sponsors to acquire valuable consumer intelligence, while offering consumers valuable incentives.

In one or more embodiments, the modules comprising the promotions layer 6308 are used in creating campaigns for consumer's participation in ongoing interactive dialogues and interactive marketing promotions, including games, surveys/poles, and sweepstakes, to name a few. The dialogue manager module 6330 in particular pulls upon these tools to create interaction between sponsor and consumer, and creates specific dialogues in order to acquire detailed consumer intelligence. Each module allows for consumer participation in different actions and offer brand entity users the use of specialized tools to tailor their marketing strategy to the targeted consumer.

For example, game module 6340 seamlessly integrates game technology of any complexity into a sponsor's program. Consumers interact with a higher degree of anticipation when offered rewards for interactivity. Games might be as simple as Virtual Crew Chief and entering the number of tires to be changed during a pit-stop or locating Chipper the Mascot on the Team's Car. A simple click-to-reveal game rewards the consumers with a branded currency to be used for redemption. The game module also integrates third-party or custom built games into the program allowing for rewards to be offered across all games.

As another example, the survey/poll module 6342 permits brand entity users to query their consumers multiple times during the course of a promotion with little effort. This module provides surveys and polls based on the information that consumers provide during account creation (i.e., age, gender, zip, etc). This module provides for the ongoing evolution of consumer intelligence, as returning consumers are served different questions dependent on the answers they provided to previous surveys.

In one or more embodiments, the surveys can also change depending on consumer information and consumer location at the point-of-purchase. Consumer users have immediate interaction with sponsor and team and are given immediate rewards with earned branded currency. This rewarded interaction between sponsor and consumer results in increased consumer participation in short surveys and polls. Brand entity users have the ability to frequently change their questions and receive additional and updated information about the consumer.

In one or more embodiments, the sweepstakes module 6344 provides brand entity users with the ability to offer consumer users product packaging incentive promotions. Through integrated identifiers, (for example, UPC's or unique codes), the module tracks the consumers from point-of-purchase to online and/or wireless redemption, and allows brand entity users to have direct interaction with the consumer. The module enables brand entity users to develop and promote targeted marketing campaigns that support traditional programs but are customized with a reward currency system that brings the consumer user in touch with the sponsor through personalized enhanced promotions.

In one or more embodiments, consumer users can participate in sweepstakes by simply purchasing the sponsor's product. Registered consumers can activate a code located inside a sponsor's product by entering the coded number onto the sponsors' racing and branded website. Instantly, consumers are displayed their winnings. This instant-win sweepstakes program allows for immediate interaction with sponsor-consumer-and team and provides an effective way to entice consumers to purchase sponsors' products.

In one or more embodiments, key features include comprehensive promotion layer cross-platform campaigns, flexible, real-time efficiency, permits stimulation of loyalty, gives consumers users valuable rewards, permits conducting of research, establishes cross-platform interaction with valuable consumers, scalable architecture, enables targeted interactive dialogues deployment, pulls from different promotion modules for optimization of campaigns, supports multidimensional wireless and traditional campaigns across all channels, and targets selected consumers based upon consumer audience and consumer intelligence collected (called fan information profiles) stored in database 6314.

Reporting manager 6336 is designed to make performance-driven NASCAR sponsorship more productive by aligning consumer/fan activities with the marketing strategies of brand entity users, permitting the trending of analysis and projection of it forward into new campaigns.

In one or more embodiments, analytical functionality is provided with insights into real-time dialogues across multiple platforms, as such term is defined herein. The module enables brand entity user to fine-tune and communicate their brand and promotion message and ensure marketing goals are reached. The analysis of consumer profiles allows brand entity users to measure, modify and manage dialogue campaigns in real-time. Reporting manager module 6336 enables prediction of consumer behavior. The module provides an intuitive drag-and-drop interface, to save time for brand entity users. The module specifically handles consumer intelligence captured in consumer dialogues. The fan information profiles are developed through consumer user comments and ideas, expressed in their own words during interaction in traditional and wireless marketing promotions.

In one or more embodiments, the module delivers the capabilities needed by brand managers to simply and comprehensively investigate consumer intelligence and use netting to group consumer comments into relevant categories. Brand entity users are enabled to create derived variables, custom databases and expressions. The module permits creation of dynamically created variables and redefinition of key target segments, to filter data on as many variables as necessary, and to profile the respondents who agreed with particular comments. In one or more embodiments, the reporting module 6336 provides analytics for rate of investment maximization, analytics for drawing from consumer intelligence from data sources, provide reports and analysis, and real-time information for sponsors.

### VIII. CONCLUSION

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A integrated marketing vehicle platform system for providing one or more brand entities using said system the ability to perform a marketing related transaction, comprising:
(i) a communications network;
(ii) one or more nodes having associated processors, said nodes being interconnected via said communications network; and
(iii) an integrated marketing vehicle platform device for enabling said brand entity using a first said node processor the ability to perform a marketing related transaction with a user using a second node processor, comprising:
(A) targeting said user using a first targeted vehicle platform; and
(B) targeting said user using a second targeted vehicle platform.

2. An integrated marketing vehicle platform system according to claim 1, wherein said enabled brand entities comprise any one of:
(i) an advertiser;
(ii) an ad agency;
(iii) a corporate sponsor;
(iv) a broadcaster;
(v) a promoter; and
(v) one or more sub-entities of said foregoing categories (i) through (iv).

3. An integrated marketing vehicle platform system according to claim 1, wherein said first targeted vehicle platform is a traditional media advertising platform, and said second targeted vehicle platform is a technology based informational content exchange platform.

4. A integrated marketing vehicle platform system according to claim 1, wherein said first targeted vehicle platform comprises informational content exchange on said first platform, and
said second targeted vehicle comprises informational content exchange on said second platform.

5. An integrated marketing vehicle platform system according to claim 4, wherein any one of said first information content and said second informational content relates to any one of:
(i) a creative; and
(ii) a plurality of creatives comprising a campaign.

6. A integrated marketing vehicle platform system according to claim 4, wherein
said first platform is a push platform, and
said second platform is a pull platform.

7. A integrated marketing vehicle platform system according to claim 4, wherein any one of: said first platform, and said second platform, comprises any one of:
(i) a print formatted content platform comprising newspapers, magazines, brochures, newsletters, press releases and billboards;
(ii) an event-related activities platform comprising sponsorships, seminars, point-of-sale programs, and promotional programs; and
(iii) a broadcast media platform comprising radio, television, cable television, Internet, and satellite cable television.

8. An integrated marketing vehicle platform system according to claim 4, wherein any one of: said targeting using said first targeted vehicle platform, and said targeting using said second targeted vehicle platform, comprises any one of:
(i) a short message service (SMS) message served to said user over said communications network, wherein said communications network is a wireless radio frequency network;
(ii) a multimedia message service (MMS) message served to said user over said communications network, wherein said communications network is a wireless radio frequency network; and
(iii) an e-mail
(A) received by said user on a post office protocol (POP) over said communications network, wherein said communications network is a transmission control protocol/internet protocol (TCP/IP) network; and
(B) received by said user on a simple mail transfer protocol (SMTP) over said communications network, wherein said communications network is a transmission control protocol/internet protocol (TCP/IP) network.

9. An integrated marketing vehicle platform system according to claim 4, wherein any one of: said informational content exchange on said first platform, and said informational content exchange on said second platform, comprises exchange of any one of:
(i) demographics informational content related to said user using said second node processor;
(ii) psychographics informational content related to said user using said second node processor;
(iii) informational content related to previous responses of said user using said second node processor; and
(iii) informational content specific to a brand entity related to said user using said second node processor.

10. An integrated marketing vehicle platform system according to claim 4, wherein said user is enabled to participate during said informational content exchange on said second platform because of an informational content received during said informational content exchange on said first platform.

11. An integrated marketing vehicle platform system according to claim 4, wherein said participation is based on any one of:
redemption of discount vehicles comprising online accessible coupons, point-of-sale accessible coupons and wireless device accessible coupons; and
redemption of auction vehicles comprising online accessible dollar bid based rewards, wireless device accessible dollar bid based rewards, online accessible points based bidding rewards and wireless device accessible points based bidding rewards.

12. An integrated marketing vehicle platform system according to claim 1, further comprising:
(i) receiving a responsive informational content responsive to any one of: said targeting using said first targeted vehicle platform, and said targeting using said second targeted vehicle platform, at said at said first node processor; and
(ii) processing said responsive informational content at said first node processor in response to one or more parameters.

13. An integrated marketing vehicle platform system according to claim 12, wherein said one or more parameters are marketing related parameters.

14. An integrated marketing vehicle platform system according to claim 12, wherein said one or more parameters are related to any one of:
(i) demographics informational content related to said user using said second node processor;
(ii) psychographics informational content related to said user using said second node processor;
(iii) informational content related to previous responses of said user using said second node processor; and
(iii) informational content specific to a brand entity related to said user using said second node processor.

15. An integrated marketing vehicle platform system according to claim 12, further comprising:
(i) receiving a result of said processing at said first node processor; and
(ii) displaying said result.

16. An integrated marketing vehicle platform system according to claim 1, permitting any party the ability to receive payments through use of the integrated marketing vehicle platform system from brand entities through any one of:
(i) a flat fee first usage payment structure based upon usage of the integrated marketing vehicle platform system;
(ii) a flat fee periodic payment fee structure based upon usage of the integrated marketing vehicle platform system;
(iii) an escalating fee structure based upon usage of the integrated marketing vehicle platform system;
(iv) a transactional fee structure based on transactions carried through the integrated marketing vehicle platform system;
(v) an advertising fee structure based upon advertisements featured on the integrated marketing vehicle platform system;
(vi) a sponsorship fee structure based upon sponsorship of the integrated marketing vehicle platform system;
(vii) a direct marketing fee structure whereupon user information is sold for payments; and
(viii) a hybrid model comprising a combination of any of (i) through (vii).

17. A method for permitting a brand entity using a first node of an integrated marketing vehicle platform system the ability to perform an advertising and marketing related transaction, said integrated marketing vehicle platform system comprising one or more nodes interconnected via a communications network, with each said node having an associated processor, the advertising and marketing related transactions, comprising:
(A) targeting a user using a first targeted vehicle platform; and
(B) targeting said user using a second targeted vehicle platform.

18. A method according to claim 17, wherein said first targeted vehicle platform is a traditional media advertising platform, and said second targeted vehicle platform is a technology based informational content exchange platform.

19. A method according to claim 17, wherein said first targeted vehicle platform comprises push informational content exchange on said first platform, and
said second targeted vehicle comprises pull informational content exchange on said second platform.

20. A method according to claim 19, wherein any one of said first information content and said second informational content relates to any one of:
(i) a creative; and
(ii) a plurality of creatives comprising a campaign.
